(19) United States
(12) Patent Application Publication
(10) Pub. No.: US 2025/0123465 A1
(43) Pub. Date: Apr. 17, 2025

(54) OPTICAL IMAGING LENS ASSEMBLY, IMAGE CAPTURING UNIT AND ELECTRONIC DEVICE

(71) Applicant: LARGAN PRECISION CO., LTD., Taichung City (TW)

(72) Inventors: Wei-Xiang FU, Taichung City (TW); Yu-Chun KE, Taichung City (TW); Cheng-Yu TSAI, Taichung City (TW)

(73) Assignee: LARGAN PRECISION CO., LTD., Taichung City (TW)

(21) Appl. No.: 18/515,954

(22) Filed: Nov. 21, 2023

(30) Foreign Application Priority Data
Oct. 13, 2023 (TW) 112139180

(51) Int. Cl. G02B 13/00; G02B 9/64

(52) U.S. Cl. CPC G02B 13/0045; G02B 9/64

(57) ABSTRACT

An optical imaging lens assembly includes nine lens elements which are, in order from an object side to an image side: a first lens element, a second lens element, a third lens element, a fourth lens element, a fifth lens element, a sixth lens element, a seventh lens element, an eighth lens element and a ninth lens element. The first lens element has negative refractive power. The second lens element with negative refractive power has an object-side surface being convex and an image-side surface being concave in a paraxial region thereof. The fourth lens element has an image-side surface being convex in a paraxial region thereof. The fifth lens element has positive refractive power. The sixth lens element has an image-side surface being concave in a paraxial region thereof. The eighth lens element with negative refractive power has an object-side surface being concave in a paraxial region thereof.

### RELATED APPLICATIONS

This application claims priority to Taiwan Application 112139180, filed on Oct. 13, 2023, which is incorporated by reference herein in its entirety.

### BACKGROUND

### Technical Field

The present disclosure relates to an optical imaging lens assembly, an image capturing unit and an electronic device, more particularly to an optical imaging lens assembly and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization and a desirable field of view.

### SUMMARY

According to one aspect of the present disclosure, an optical imaging lens assembly includes nine lens elements. The nine lens elements are, in order from an object side to an image side along an optical path, a first lens element, a second lens element, a third lens element, a fourth lens element, a fifth lens element, a sixth lens element, a seventh lens element, an eighth lens element and a ninth lens element. Each of the nine lens elements has an object-side surface facing toward the object side and an image-side surface facing toward the image side.

Preferably, the first lens element has negative refractive power. Preferably, the second lens element has negative refractive power. Preferably, the object-side surface of the second lens element is convex in a paraxial region thereof. Preferably, the image-side surface of the second lens element is concave in a paraxial region thereof. Preferably, the image-side surface of the fourth lens element is convex in a paraxial region thereof. Preferably, the fifth lens element has positive refractive power. Preferably, the image-side surface of the sixth lens element is concave in a paraxial region thereof. Preferably, the eighth lens element has negative refractive power. Preferably, the object-side surface of the eighth lens element is concave in a paraxial region thereof.

When a curvature radius of the object-side surface of the second lens element is R3, a curvature radius of the image-side surface of the second lens element is R4, a curvature radius of the object-side surface of the third lens element is R5, and a curvature radius of the image-side surface of the fourth lens element is R8, the following conditions are preferably satisfied:

$$0 < ( R 5 + R 8 ) / ( R 5 - R 8 ) < 10. ; and$$

$$1. < ( R 3 + R 4 ) / ( R 3 - R 4 ) < 10.00 .$$

According to another aspect of the present disclosure, an optical imaging lens assembly includes nine lens elements. The nine lens elements are, in order from an object side to an image side along an optical path, a first lens element, a second lens element, a third lens element, a fourth lens element, a fifth lens element, a sixth lens element, a seventh lens element, an eighth lens element and a ninth lens element. Each of the nine lens elements has an object-side surface facing toward the object side and an image-side surface facing toward the image side.

Preferably, the first lens element has negative refractive power. Preferably, the second lens element has negative refractive power. Preferably, the image-side surface of the second lens element is concave in a paraxial region thereof. Preferably, the image-side surface of the fourth lens element is convex in a paraxial region thereof. Preferably, the object-side surface of the fifth lens element is convex in a paraxial region thereof. Preferably, the image-side surface of the sixth lens element is concave in a paraxial region thereof. Preferably, the eighth lens element has negative refractive power. Preferably, the object-side surface of the eighth lens element is concave in a paraxial region thereof.

When an axial distance between the object-side surface of the first lens element and an image surface is TL, a focal length of the optical imaging lens assembly is f, a central thickness of the fifth lens element is CT5, a central thickness of the sixth lens element is CT6, an axial distance between the second lens element and the third lens element is T23, an axial distance between the third lens element and the fourth lens element is T34, an axial distance between the fourth lens element and the fifth lens element is T45, and an axial distance between the seventh lens element and the eighth lens element is T78, the following conditions are preferably satisfied:

$$6.5 < TL / f < 1 5. ;$$

$$0 < CT 6 / CT 5 < 0.45 ; and$$

$$0 < ( T 34 + T 45 + T 78 ) / T 23 < 2.00 .$$

According to another aspect of the present disclosure, an optical imaging lens assembly includes nine lens elements. The nine lens elements are, in order from an object side to an image side along an optical path, a first lens element, a second lens element, a third lens element, a fourth lens element, a fifth lens element, a sixth lens element, a seventh lens element, an eighth lens element and a ninth lens element. Each of the nine lens elements has an object-side surface facing toward the object side and an image-side surface facing toward the image side.

Preferably, the first lens element has negative refractive power. Preferably, the second lens element has negative refractive power. Preferably, the image-side surface of the second lens element is concave in a paraxial region thereof. Preferably, the image-side surface of the fourth lens element is convex in a paraxial region thereof. Preferably, the fifth lens element has positive refractive power. Preferably, the image-side surface of the sixth lens element is concave in a paraxial region thereof. Preferably, the eighth lens element has negative refractive power. Preferably, the object-side surface of the eighth lens element is concave in a paraxial region thereof.

When a curvature radius of the object-side surface of the third lens element is R5, a curvature radius of the image-side surface of the fourth lens element is R8, an axial distance between the second lens element and the third lens element is T23, a central thickness of the first lens element is CT1, and a central thickness of the second lens element is CT2, the following conditions are preferably satisfied:

$$0 < ( R 5 + R 8 ) / ( R 5 - R 8 ) < 10. ; and$$

$$0.6 < T 23 / ( CT 1 + C T 2 ) < 3.00 .$$

According to another aspect of the present disclosure, an image capturing unit includes one of the aforementioned optical imaging lens assemblies and an image sensor, wherein the image sensor is disposed on the image surface of the optical imaging lens assembly.

According to another aspect of the present disclosure, an electronic device includes the aforementioned image capturing unit.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit according to the 1st embodiment of the present disclosure;

FIG. 2 shows spherical aberration curves, astigmatic field curves and a distortion curve of the image capturing unit according to the 1st embodiment;

FIG. 3 is a schematic view of an image capturing unit according to the 2nd embodiment of the present disclosure;

FIG. 4 shows spherical aberration curves, astigmatic field curves and a distortion curve of the image capturing unit according to the 2nd embodiment;

FIG. 5 is a schematic view of an image capturing unit according to the 3rd embodiment of the present disclosure;

FIG. 6 shows spherical aberration curves, astigmatic field curves and a distortion curve of the image capturing unit according to the 3rd embodiment;

FIG. 7 is a schematic view of an image capturing unit according to the 4th embodiment of the present disclosure;

FIG. 8 shows spherical aberration curves, astigmatic field curves and a distortion curve of the image capturing unit according to the 4th embodiment;

FIG. 9 is a schematic view of an image capturing unit according to the 5th embodiment of the present disclosure;

FIG. 10 shows spherical aberration curves, astigmatic field curves and a distortion curve of the image capturing unit according to the 5th embodiment;

FIG. 11 is a schematic view of an image capturing unit according to the 6th embodiment of the present disclosure;

FIG. 12 shows spherical aberration curves, astigmatic field curves and a distortion curve of the image capturing unit according to the 6th embodiment;

FIG. 13 is a schematic view of an image capturing unit according to the 7th embodiment of the present disclosure;

FIG. 14 shows spherical aberration curves, astigmatic field curves and a distortion curve of the image capturing unit according to the 7th embodiment;

FIG. 15 is a schematic view of an image capturing unit according to the 8th embodiment of the present disclosure;

FIG. 16 shows spherical aberration curves, astigmatic field curves and a distortion curve of the image capturing unit according to the 8th embodiment;

FIG. 17 is a schematic view of an image capturing unit according to the 9th embodiment of the present disclosure;

FIG. 18 shows spherical aberration curves, astigmatic field curves and a distortion curve of the image capturing unit according to the 9th embodiment;

FIG. 19 is a schematic view of an image capturing unit according to the 10th embodiment of the present disclosure;

FIG. 20 shows spherical aberration curves, astigmatic field curves and a distortion curve of the image capturing unit according to the 10th embodiment;

FIG. 21 is a perspective view of an image capturing unit according to the 11th embodiment of the present disclosure;

FIG. 22 is one perspective view of an electronic device according to the 12th embodiment of the present disclosure;

FIG. 23 is another perspective view of the electronic device in FIG. 22;

FIG. 24 is a block diagram of the electronic device in FIG. 22;

FIG. 25 is one perspective view of an electronic device according to the 13th embodiment of the present disclosure;

FIG. 26 is another perspective view of the electronic device in FIG. 25;

FIG. 27 is one perspective view of an electronic device according to the 14th embodiment of the present disclosure;

FIG. 28 is a schematic view of an electronic device according to the 15th embodiment of the present disclosure;

FIG. 29 is a perspective of an electronic device according to the 16th embodiment of the present disclosure;

FIG. 30 is a side view of the electronic device in FIG. 29;

FIG. 31 is a top view of the electronic device in FIG. 29;

FIG. 32 is a schematic view of an electronic device according to the 17th embodiment of the present disclosure;

FIG. 33 shows a schematic view of inflection points on lens surfaces and critical points on lens surfaces according to the 1st embodiment of the present disclosure;

FIG. 34 shows a schematic view of Y9R2, Sag3R1 and ImgH according to the 1st embodiment of the present disclosure;

FIG. 35 shows a schematic view of a configuration of one light-folding element in an optical imaging lens assembly according to one embodiment of the present disclosure;

FIG. 36 shows a schematic view of another configuration of one light-folding element in an optical imaging lens assembly according to one embodiment of the present disclosure; and

FIG. 37 shows a schematic view of a configuration of two light-folding elements in an optical imaging lens assembly according to one embodiment of the present disclosure.

### DETAILED DESCRIPTION

An optical imaging lens assembly includes nine lens elements. The nine lens elements are, in order from an object side to an image side along an optical path, a first lens element, a second lens element, a third lens element, a fourth lens element, a fifth lens element, a sixth lens element, a seventh lens element, an eighth lens element and a ninth lens element. Each of the nine lens elements of the optical imaging lens assembly has an object-side surface facing toward the object side and an image-side surface facing toward the image side.

The first lens element has negative refractive power. Therefore, it is favorable for enlarging the field of view so as to capture image data of wider range.

The second lens element has negative refractive power. Therefore, it is favorable for effectively balancing the refractive power of the first lens element so as to prevent overly large curvature of the first lens element causing excessive aberrations. The object-side surface of the second lens element can be convex in a paraxial region thereof. Therefore, it is favorable for adjusting the surface shape and refractive power of the second lens element so as to improve image quality at the paraxial region. The image-side surface of the second lens element is concave in a paraxial region thereof. Therefore, it is favorable for adjusting the shape of the image-side surface of the second lens element so as to correct aberrations generated by large incident angle.

The image-side surface of the third lens element can be convex in a paraxial region thereof. Therefore, it is favorable for balancing spherical aberration and coma.

The object-side surface of the fourth lens element can be concave in a paraxial region thereof. Therefore, it is favorable for balancing the incident angle of light in the optical imaging lens assembly with a large view angle so as to prevent divergence of light rays. The image-side surface of the fourth lens element is convex in a paraxial region thereof. Therefore, it is favorable for the fourth lens element to have light converging capability so as to prevent insufficient refraction of light from the peripheral region which may cause ineffective light convergence.

The fifth lens element can have positive refractive power. Therefore, it is favorable for converging light so as to reduce the size of the optical imaging lens assembly. The object-side surface of the fifth lens element can be convex in a paraxial region thereof. Therefore, it is favorable for adjusting the surface shape and refractive power of the fifth lens element so as to reduce the size and correct aberrations.

The sixth lens element can have negative refractive power. Therefore, it is favorable for balancing the refractive power of the seventh lens element and reducing the back focal length. The image-side surface of the sixth lens element is concave in a paraxial region thereof. Therefore, it is favorable for adjusting the refraction direction of light rays from the sixth lens element so as to enlarge the image surface.

The object-side surface of the seventh lens element can be convex in a paraxial region thereof. Therefore, it is favorable for reducing the back focal length and correcting off-axis aberrations.

The eighth lens element has negative refractive power. Therefore, it is favorable for effectively controlling the back focal length of the optical imaging lens assembly so as to prevent excessive long total track length of the optical imaging lens assembly. The object-side surface of the eighth lens element is concave in a paraxial region thereof. Therefore, it is favorable for controlling the angle of light incident onto the object-side surface of the eighth lens element so as to prevent overly large incident angle which may cause divergence of light rays and low illuminance at the periphery region of the image.

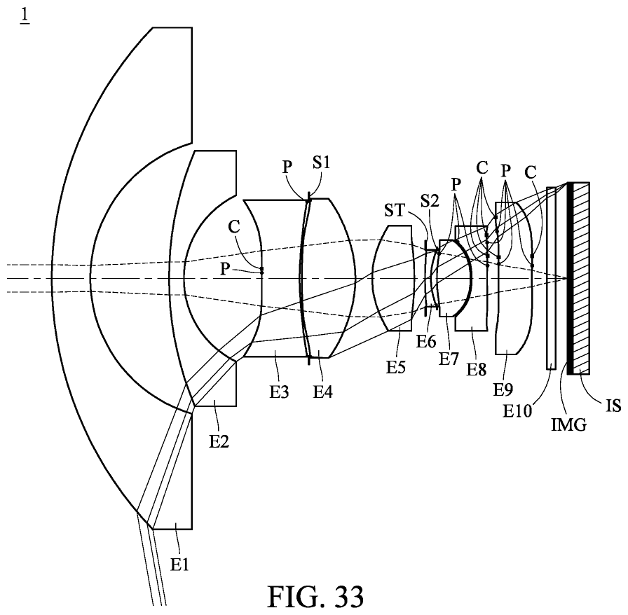

Among the nine lens elements of the optical imaging lens assembly, there can be at least one lens element having at least one inflection point. In detail, among the first lens element through the ninth lens element, there can be one or more lens elements each having at least one inflection point, and said one lens element having at least one inflection point refers to a lens element in which at least one of the object-side surface and the image-side surface has at least one inflection point. Therefore, it is favorable for increasing the optical design flexibility for manufacturing of lens elements and correcting aberrations. Moreover, at least one of the object-side surface and the image-side surface of the third lens element can have at least one inflection point. Therefore, it is favorable for adjusting the peripheral shape design of the third lens element so as to correct astigmatism. Moreover, the object-side surface of the third lens element can have at least one inflection point. Moreover, the image-side surface of the eighth lens element can have at least one inflection point. Therefore, it is favorable for adjusting the angle of light incident onto the image surface so as to control the angle of peripheral light rays, thereby preventing vignetting in the peripheral region of the image and reducing distortion. Moreover, at least one of the object-side surface and the image-side surface of the ninth lens element can have at least one inflection point. Therefore, it is favorable for enhancing the aberration correction capability of the ninth lens element at the peripheral region of images. Please refer to FIG. 33, which shows a schematic view of inflection points P of the third lens element E3, the seventh lens element E7, the eighth lens element E8 and the ninth lens element E9 according to the 1st embodiment of the present disclosure. In FIG. 33, the object-side surface and the image-side surface of the third lens element E3, the object-side surface of the seventh lens element E7, the object-side surface of the eighth lens element E8 and the image-side surface of the ninth lens element E9 each has one inflection point P, and the image-side surface of the eighth lens element E8 and the object-side surface of the ninth lens element E9 each has two inflection points P. The 1st embodiment of the present disclosure shown in FIG. 33 is only exemplary. Each of the lens elements in various embodiments of the present disclosure can have one or more inflection points.

When a curvature radius of the object-side surface of the third lens element is R5, and a curvature radius of the image-side surface of the fourth lens element is R8, the following condition can be satisfied: 0<(R5+R8)/(R5−R8)<10.00. Therefore, it is favorable for effectively balancing the curvature radius of the object-side surface of the third lens element and the curvature radius of the image-side surface of the fourth lens element. Adjusting the curvature radius of the object-side surface of the third lens element is favorable for balancing light rays of large angle of view into the optical imaging lens assembly, and adjusting the curvature radius of the image-side surface of the fourth lens element is favorable for further gathering light rays so as to reduce the size of the optical imaging lens assembly. Moreover, the following condition can also be satisfied: 0.30<(R5+R8)/(R5−R8)<8.00. Moreover, the following condition can also be satisfied: 0.50<(R5+R8)/(R5−R8)<5.00. Moreover, the following condition can also be satisfied: 0.82≤(R5+R8)/(R5−R8)≤3.00.

When a curvature radius of the object-side surface of the second lens element is R3, and a curvature radius of the image-side surface of the second lens element is R4, the following condition can be satisfied: 1.00<(R3+R4)/(R3−R4)<10.00. Therefore, it is favorable for effectively balancing the curvature radii of the object-side surface and the image-side surface of the second lens element so as to reduce aberrations caused by a large field of view. Moreover, the following condition can also be satisfied: 1.10<(R3+R4)/(R3−R4)<6.00. Moreover, the following condition can also be satisfied: 1.20<(R3+R4)/(R3−R4)<4.00. Moreover, the following condition can also be satisfied: 0.80≤(R3+R4)/(R3−R4)≤2.00.

When an axial distance between the object-side surface of the first lens element and an image surface is TL, and a focal length of the optical imaging lens assembly is f, the following condition can be satisfied: 6.50<TL/f<15.00. Therefore, it is favorable for obtaining a balance between the total track length and the field of view of the optical imaging lens assembly. Moreover, the following condition can also be satisfied: 7.00<TL/f<14.00. Moreover, the following condition can also be satisfied: 8.00<TL/f<13.00. Moreover, the following condition can also be satisfied: 8.84≤TL/f≤12.24.

When a central thickness of the fifth lens element is CT5, and a central thickness of the sixth lens element is CT6, the following condition can be satisfied: 0<CT6/CT5<0.45. Therefore, it is favorable for balancing the ratio between the central thickness of the fifth lens element and the central thickness of the sixth lens element and adjusting the central thickness of the fifth lens element so as to provide the fifth lens element with better light refractive capability. Moreover, the following condition can also be satisfied: 0.05<CT6/CT5<0.35. Moreover, the following condition can also be satisfied: 0.14≤CT6/CT5≤0.28.

When an axial distance between the second lens element and the third lens element is T23, an axial distance between the third lens element and the fourth lens element is T34, an axial distance between the fourth lens element and the fifth lens element is T45, and an axial distance between the seventh lens element and the eighth lens element is T78, the following condition can be satisfied: 0<(T34+T45+T78)/T23<2.00. Therefore, it is favorable for adjusting the ratio among the distance between the second lens element and the third lens element, the distance between the third lens element and the fourth lens element, the distance between the fourth lens element and the fifth lens element, and the distance between the seventh lens element and the eighth lens element so as to balance the space arrangement of lens elements, thereby reducing the sensitivity of the optical imaging lens assembly. Moreover, the following condition can also be satisfied: 0<(T34+T45+T78)/T23<1.00. Moreover, the following condition can also be satisfied: 0.01<(T34+T45+T78)/T23<0.75. Moreover, the following condition can also be satisfied: 0.05≤(T34+T45+T78)/T23≤0.45.

When the axial distance between the second lens element and the third lens element is T23, a central thickness of the first lens element is CT1, and a central thickness of the second lens element is CT2, the following condition can be satisfied: 0.60<T23/(CT1+CT2)<3.00. Therefore, it is favorable for balancing the central thickness of the first lens element, the central thickness of the second lens element and the distance between the second lens element and the third lens element so as to provide sufficient length for refracting light with large angle of view, thereby preventing total reflection. Moreover, the following condition can also be satisfied: 0.70<T23/(CT1+CT2)<2.50. Moreover, the following condition can also be satisfied: 0.80<T23/(CT1+CT2)<2.20. Moreover, the following condition can also be satisfied: 0.92≤T23/(CT1+CT2)≤1.95.

When the focal length of the optical imaging lens assembly is f, a focal length of the third lens element is f3, a focal length of the seventh lens element is f7, and a focal length of the ninth lens element is f9, the following condition can be satisfied: (|f/f3|+|f/f9|)/|f/f7|<0.80. Therefore, it is favorable for adjusting the refractive power of the third lens element, the seventh lens element and the ninth lens element so as to balance the convergence and divergence of light rays with large angle of view, thereby improving light converging quality across the entire field of view. Moreover, the following condition can also be satisfied: 0.05<(|f/f3|+|f/f9|)/|f/f7|<0.60.

When a central thickness of the fourth lens element is CT4, and the central thickness of the fifth lens element is CT5, the following condition can be satisfied: 0.40<CT4/CT5<2.50. Therefore, it is favorable for balancing the ratio of the central thickness of the fourth lens element to the central thickness of the fifth lens element so as to reduce manufacturing deviations. Moreover, the following condition can also be satisfied: 0.60<CT4/CT5<2.00.

When the focal length of the optical imaging lens assembly is f, and the focal length of the third lens element is f3, the following condition can be satisfied: |f/f3|<0.45. Therefore, it is favorable for adjusting the refractive power of the third lens element so as to balance the second lens element with negative refractive power and the fifth lens element with positive refractive power. Moreover, the following condition can also be satisfied: 0.01<|f/f3|<0.25.

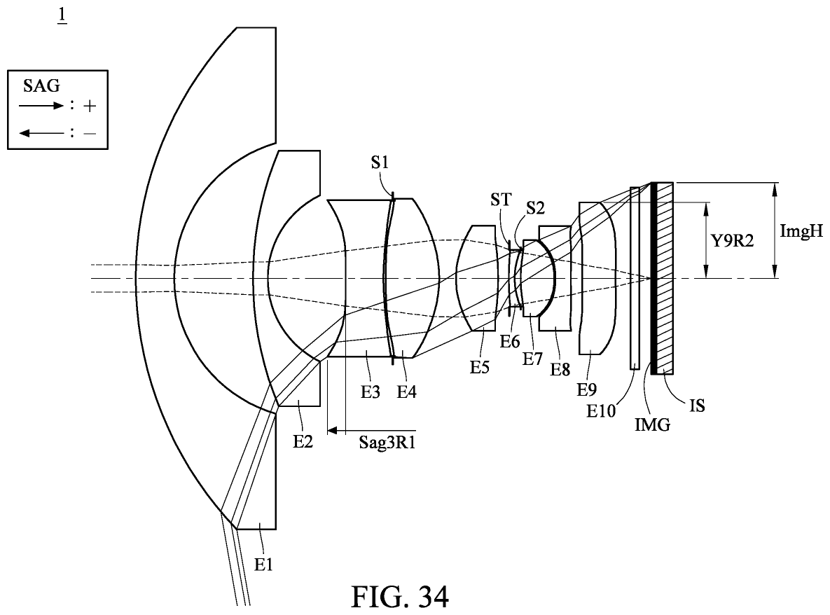

When the axial distance between the object-side surface of the first lens element and the image surface is TL, and a maximum image height of the optical imaging lens assembly (which can be half of a diagonal length of an effective photosensitive area of an image sensor) is ImgH, the following condition can be satisfied: 3.00<TL/ImgH<8.00. Therefore, it is favorable for effectively reducing the total track length while ensuring sufficient image size. Moreover, the following condition can also be satisfied: 4.00<TL/ImgH<7.00. Please refer to FIG. 34 which shows a schematic view of ImgH according to the 1st embodiment of the present disclosure.

When a maximum field of view of the optical imaging lens assembly is FOV, the following condition can be satisfied: 150.0 degrees<FOV<230.0 degrees. Therefore, it is favorable for the optical imaging lens assembly to have sufficient imaging range for satisfying the field of view requirements of applied devices. Moreover, the following condition can also be satisfied: 170.0 degrees<FOV<210.0 degrees.

When a curvature radius of the object-side surface of the sixth lens element is R11, and a curvature radius of the image-side surface of the sixth lens element is R12, the following condition can be satisfied: |R12/R11|<1.00. Therefore, it is favorable for adjusting the curvature radii of the object-side surface and the image-side surface of the sixth lens element so as to control the light path near the aperture stop and increase the field of view and image surface area. Moreover, the following condition can also be satisfied: 0.10<|R12/R11|<0.60.

When the axial distance between the third lens element and the fourth lens element is T34, and a central thickness of the third lens element is CT3, the following condition can be satisfied: 0.01<10×T34/CT3<5.00. Therefore, it is favorable for balancing the ratio between the distance from the third lens element to the fourth lens element and the central thickness of the third lens element so as to reduce the size of the optical imaging lens assembly. Moreover, the following condition can also be satisfied: 0.10<10×T34/CT3<2.50.

When an axial distance between the first lens element and the second lens element is T12, the axial distance between the second lens element and the third lens element is T23, and a sum of axial distances between each of all adjacent lens elements of the optical imaging lens assembly is ΣAT, the following condition can be satisfied: 0.60<(T12+T23)/ΣAT<1.00. Therefore, it is favorable for adjusting the arrangement of axial distances between lens elements so as to ensure larger axial distances between lens elements at the object side of the optical imaging lens assembly, thereby balancing light with large angle of view incident onto the image surface. Moreover, the following condition can also be satisfied: 0.65<(T12+T23)/ΣAT<0.90.

According to the present disclosure, the optical imaging lens assembly can further include an aperture stop. When an axial distance between the aperture stop and the image-side surface of the ninth lens element is SD, and an axial distance between the image-side surface of the ninth lens element and the image surface is BL, the following condition can be satisfied: 2.00<SD/BL<5.20. Therefore, it is favorable for adjusting the axial distance from the aperture stop to the image-side surface of the ninth lens element, and the axial distance from the image-side surface of the ninth lens element to the image surface so as to increase off-axis relative illuminance and reduce the back focal length. Moreover, the following condition can also be satisfied: 2.50<SD/BL<4.50.

When a displacement in parallel with an optical axis from an axial vertex of the object-side surface of the third lens element to a maximum effective radius position of the object-side surface of the third lens element is Sag3R1, and the central thickness of the second lens element is CT2, the following condition can be satisfied: −2.00<Sag3R1/CT2<−0.30. Therefore, it is favorable for balancing the curvature at the peripheral region of the object-side surface of the third lens element so as to increase the field of view and correct aberrations such as distortion. Moreover, the following condition can also be satisfied: −1.60<Sag3R1/CT2<−0.50. Please refer to FIG. 34, which shows a schematic view of Sag3R1 according to the 1st embodiment of the present disclosure. When the direction from the axial vertex of one surface to the maximum effective radius position of the same surface is facing towards the image side of the optical imaging lens assembly, the value of displacement is positive; when the direction from the axial vertex of the surface to the maximum effective radius position of the same surface is facing towards the object side of the optical imaging lens assembly, the value of displacement is negative.

When the maximum image height of the optical imaging lens assembly is ImgH, and a maximum effective radius of the image-side surface of the ninth lens element is Y9R2, the following condition can be satisfied: 1.05<ImgH/Y9R2<1.50. Therefore, it is favorable for adjusting the effective radius of the ninth lens element and the image height so as to increase image surface area and improve image quality. Moreover, the following condition can also be satisfied: 1.10<ImgH/Y9R2<1.40. Please refer to FIG. 34 which shows a schematic view of ImgH and Y9R2 according to the 1st embodiment of the present disclosure.

When the focal length of the optical imaging lens assembly is f, a focal length of the fourth lens element is f4, a focal length of the eighth lens element is f8, and a focal length of the ninth lens element is f9, the following condition can be satisfied: (|f/f4|+|f/f9|)/|f/f8|<1.00. Therefore, it is favorable for adjusting the refractive power of the fourth lens element, the eighth lens element and the ninth lens element so as to receive light with large angle of view and correct aberrations. Moreover, the following condition can also be satisfied: 0.10<(|f/f4|+|f/f9|)/|f/f8|<0.80.

When the focal length of the fourth lens element is f4, and the focal length of the eighth lens element is f8, the following condition can be satisfied: 0<|f8/f4|<0.70. Therefore, it is favorable for effectively balancing the refractive power of the fourth lens element and the eighth lens element so as to increase the field of view and correct off-axis aberrations. Moreover, the following condition can also be satisfied: 0.01<|f8/f4|<0.60.

When a curvature radius of the object-side surface of the fourth lens element is R7, and the curvature radius of the image-side surface of the fourth lens element is R8, the following condition can be satisfied: 0<|R8/R7|<2.00. Therefore, it is favorable for adjusting the curvature radii of the object-side surface and the image-side surface of the fourth lens element so as to effectively gather light rays with large angle of view. Moreover, the following condition can also be satisfied: 0.10<|R8/R7| <1.60.

When the maximum image height of the optical imaging lens assembly is ImgH, and the axial distance between the image-side surface of the ninth lens element and the image surface is BL, the following condition can be satisfied: 2.00<ImgH/BL<5.00. Therefore, it is favorable for reducing the back focal length and increase image surface area. Moreover, the following condition can also be satisfied: 2.05<ImgH/BL<4.00.

According to the present disclosure, the aperture can be disposed between the fifth lens element and the sixth lens element. Therefore, it is favorable for restricting the imaging range and the angle of light incident onto the image surface so as to achieve high brightness imaging results.

When the axial distance between the first lens element and the second lens element is T12, and an axial distance between the fifth lens element and the sixth lens element is T56, the following condition can be satisfied: 0<T56/T12<0.50. Therefore, it is favorable for balancing the distance from the first lens element to the second lens element, and the distance from the fifth lens element to the sixth lens element so as to decrease the angle of light incident onto the object-side surface of the sixth lens element, thereby preventing total reflection and the occurrence of stray light and balancing the space arrangement of lens elements. Moreover, the following condition can also be satisfied: 0.05<T56/T12<0.40.

When a refractive index of the fourth lens element is N4, the following condition can be satisfied: 1.400<N4<1.620. Therefore, it is favorable for adjusting the material arrangement of the fourth lens element so as to balance the light convergence of different wavelengths. Moreover, the following condition can also be satisfied: 1.500<N4<1.600.

When an Abbe number of the third lens element is V3, an Abbe number of the sixth lens element is V6, and an Abbe number of the eighth lens element is V8, the following condition can be satisfied: 30.0<V3+V6+V8<85.0. Therefore, it is favorable for adjusting the material arrangement of the third lens element, the sixth lens element and the eighth lens element so as to effectively correct chromatic aberration, prevent image overlapping and thus improve image quality. Moreover, the following condition can also be satisfied: 45.0<V3+V6+V8<80.0.

When the focal length of the optical imaging lens assembly is f, the curvature radius of the image-side surface of the fourth lens element is R8, and the curvature radius of the image-side surface of the sixth lens element is R12, the following condition can be satisfied: 0.40<|f/R8|+|f/R12|<1.80. Therefore, it is favorable for adjusting the ratio of the effective focal length to the curvature radius of the image-side surface of the fourth lens element, and the ratio of the effective focal length to the curvature radius of the image-side surface of the sixth lens element so as to ensure the two lens surfaces having relative curve surface shape, thereby effectively controlling the traveling direction of light and increasing image surface area. Moreover, the following condition can also be satisfied: 0.70<|f/R8|+|f/R12|<1.50. Among the nine lens elements of the optical imaging lens assembly, there can be at least four lens elements made of plastic material. Therefore, it is favorable for increasing design flexibility and reducing manufacturing costs. Moreover, among the nine lens elements of the optical imaging lens assembly, there can be at least five lens elements made of plastic material. Moreover, among the nine lens elements of the optical imaging lens assembly, there can be at least six lens elements made of plastic material.

When an Abbe number of the first lens element is V1, an Abbe number of the second lens element is V2, the Abbe number of the third lens element is V3, an Abbe number of the fourth lens element is V4, an Abbe number of the fifth lens element is V5, the Abbe number of the sixth lens element is V6, an Abbe number of the seventh lens element is V7, the Abbe number of the eighth lens element is V8, an Abbe number of the ninth lens element is V9, an Abbe number of the i-th lens element is Vi, a refractive index of the first lens element is N1, a refractive index of the second lens element is N2, a refractive index of the third lens element is N3, the refractive index of the fourth lens element is N4, a refractive index of the fifth lens element is N5, a refractive index of the sixth lens element is N6, a refractive index of the seventh lens element is N7, a refractive index of the eighth lens element is N8, a refractive index of the ninth lens element is N9, and a refractive index of the i-th lens element is Ni, at least two lens elements of the optical imaging lens assembly can satisfy the following condition: 8.0<Vi/Ni<16.0, wherein i=1, 2, 3, 4, 5, 6, 7, 8 or 9. Therefore, it is favorable for correcting chromatic aberration so as to improve image quality. Moreover, at least three lens elements of the optical imaging lens assembly can satisfy the following condition: 8.0<Vi/Ni<16.0, wherein i=1, 2, 3, 4, 5, 6, 7, 8 or 9.

According to the present disclosure, the aforementioned features and conditions can be utilized in numerous combinations so as to achieve corresponding effects.

According to the present disclosure, the lens elements of the optical imaging lens assembly can be made of either glass or plastic material. When the lens elements are made of glass material, the refractive power distribution of the optical imaging lens assembly may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the optical imaging lens assembly can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of refractive power or focus of a lens element is not defined, it indicates that the region of refractive power or focus of the lens element is in the paraxial region thereof.

According to the present disclosure, an inflection point is a point on the surface of the lens element at which the surface changes from concave to convex, or vice versa. A critical point is a non-axial point of the lens surface where its tangent is perpendicular to the optical axis. Please refer to FIG. 33, which shows a schematic view of critical points C of the third lens element E3, the eighth lens element E8 and the ninth lens element E9 according to the 1st embodiment of the present disclosure. In FIG. 33, the object-side surface of the third lens element E3 and the image-side surface of the ninth lens element E9 each has a critical point C in an off-axis region thereof, and the image-side surface of the eighth lens element E8 and the object-side surface of the ninth lens element E9 each has two critical points C in an off-axis region thereof. The 1st embodiment of the present disclosure shown in FIG. 33 is only exemplary. Each of the lens elements in various embodiments of the present disclosure can have one or more critical points in an off-axis region thereof.

According to the present disclosure, the image surface of the optical imaging lens assembly, based on the corresponding image sensor, can be flat or curved, especially a curved surface being concave facing towards the object side of the optical imaging lens assembly.

According to the present disclosure, an image correction unit, such as a field flattener, can be optionally disposed between the lens element closest to the image side of the optical imaging lens assembly along the optical path and the image surface for correction of aberrations such as field curvature. The optical characteristics of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

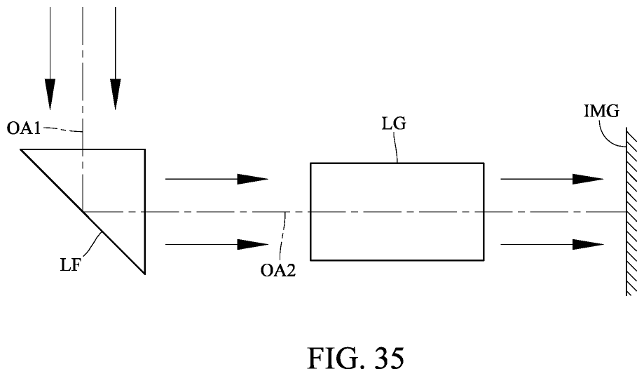

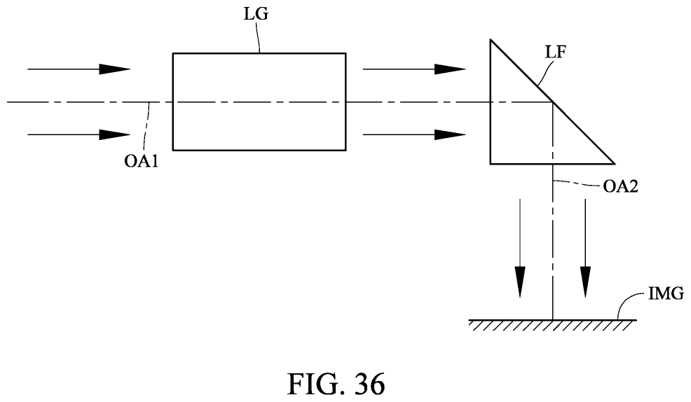

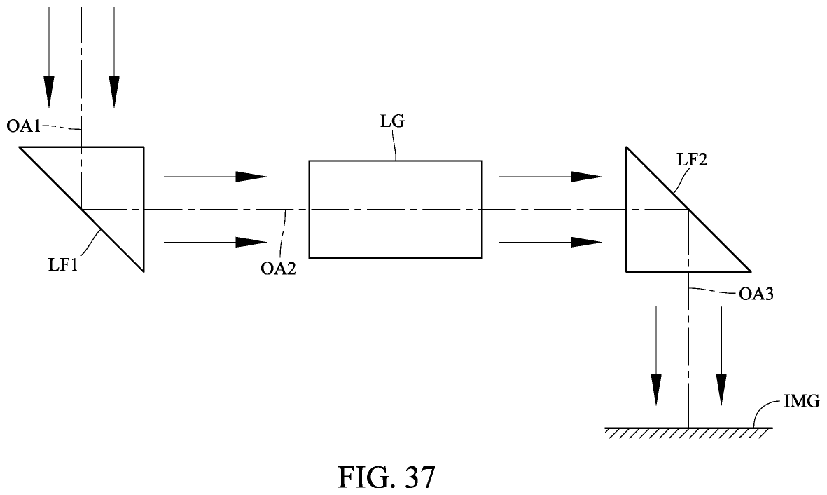

According to the present disclosure, at least one light-folding element, such as a prism or a mirror, can be optionally provided between an imaged object and the image surface on the imaging optical path, and the surface shape of the prism or mirror can be planar, spherical, aspheric or freeform surface, such that the optical imaging lens assembly can be more flexible in space arrangement, and therefore the dimensions of an electronic device is not restricted by the total track length of the optical imaging lens assembly. Specifically, please refer to FIG. 35 and FIG. 36. FIG. 35 shows a schematic view of a configuration of one light-folding element in an optical imaging lens assembly according to one embodiment of the present disclosure, and FIG. 36 shows a schematic view of another configuration of one light-folding element in an optical imaging lens assembly according to one embodiment of the present disclosure. In FIG. 35 and FIG. 36, the optical imaging lens assembly can have, in order from an imaged object (not shown in the figures) to an image surface IMG along an optical path, a first optical axis OA1, a light-folding element LF and a second optical axis OA2. The light-folding element LF can be disposed between the imaged object and a lens group LG of the optical imaging lens assembly as shown in FIG. 35, or disposed between a lens group LG and the image surface IMG of the optical imaging lens assembly as shown in FIG. 36. Furthermore, please refer to FIG. 37, which shows a schematic view of a configuration of two light-folding elements in an optical imaging lens assembly according to one embodiment of the present disclosure. In FIG. 37, the optical imaging lens assembly can have, in order from an imaged object (not shown in the figure) to an image surface IMG along an optical path, a first optical axis OA1, a first light-folding element LF1, a second optical axis OA2, a second light-folding element LF2 and a third optical axis OA3. The first light-folding element LF1 is disposed between the imaged object and a lens group LG of the optical imaging lens assembly, the second light-folding element LF2 is disposed between the lens group LG and the image surface IMG of the optical imaging lens assembly, and the travelling direction of light on the first optical axis OA1 can be the same direction as the travelling direction of light on the third optical axis OA3 as shown in FIG. 37. The optical imaging lens assembly can be optionally provided with three or more light-folding elements, and the present disclosure is not limited to the type, amount and position of the light-folding elements of the embodiments disclosed in the aforementioned figures.

According to the present disclosure, the optical imaging lens assembly can include at least one stop, such as an aperture stop, a glare stop or a field stop. Said glare stop or said field stop is set for eliminating the stray light and thereby improving image quality thereof.

According to the present disclosure, an aperture stop can be configured as a front stop or a middle stop. A front stop disposed between an imaged object and the first lens element can provide a longer distance between an exit pupil of the optical imaging lens assembly and the image surface to produce a telecentric effect, and thereby improves the image-sensing efficiency of an image sensor (for example, CCD or CMOS). A middle stop disposed between the first lens element and the image surface is favorable for enlarging the viewing angle of the optical imaging lens assembly and thereby provides a wider field of view for the same.

According to the present disclosure, the optical imaging lens assembly can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the optical imaging lens assembly can include one or more optical elements for limiting the form of light passing through the optical imaging lens assembly. Each optical element can be, but not limited to, a filter, a polarizer, etc., and each optical element can be, but not limited to, a single-piece element, a composite component, a thin film, etc. The optical element can be located at the object side or the image side of the optical imaging lens assembly or between any two adjacent lens elements so as to allow light in a specific form to pass through, thereby meeting application requirements.

According to the present disclosure, the optical imaging lens assembly can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a light-blocking element, an annular spacer, a barrel element, a cover glass, a blue glass, a filter, a color filter, an optical path folding element (e.g., a reflective element), a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the object side and image side are defined in accordance with the direction of the optical axis, and the axial optical data are calculated along the optical axis. Furthermore, if the optical axis is deflected by a light-folding element, the axial optical data are also calculated along the deflected optical axis.

According to the above description of the present disclosure, the following specific embodiments are provided for further explanation.

### 1st Embodiment

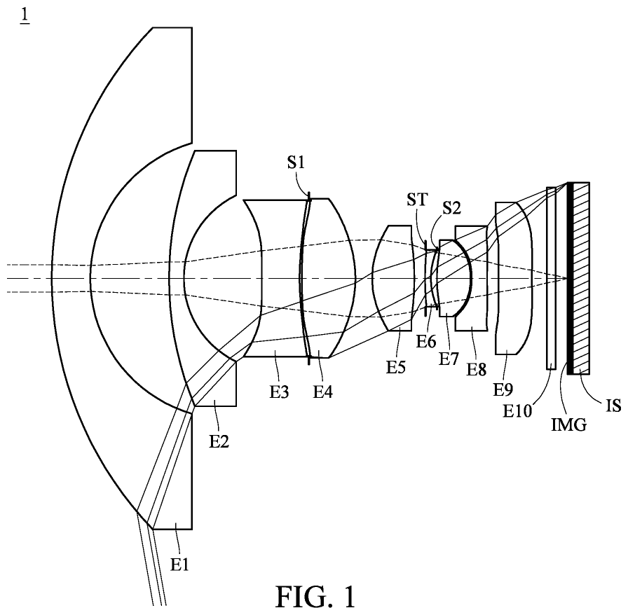

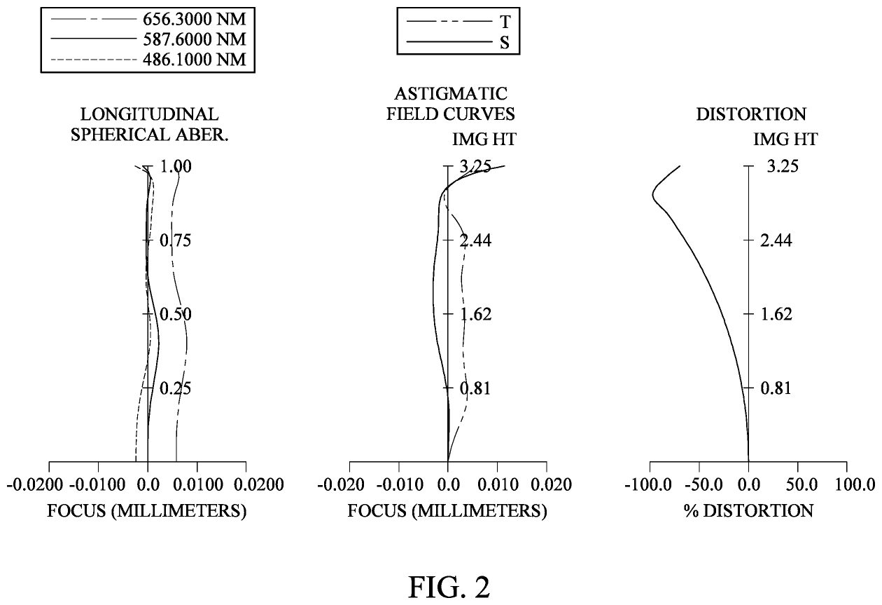

FIG. 1 is a schematic view of an image capturing unit according to the 1st embodiment of the present disclosure. FIG. 2 shows, in order from left to right, spherical aberration curves, astigmatic field curves and a distortion curve of the image capturing unit according to the 1st embodiment. In FIG. 1, the image capturing unit 1 includes the optical imaging lens assembly (its reference numeral is omitted) of the present disclosure and an image sensor IS. The optical imaging lens assembly includes, in order from an object side to an image side along an optical axis, a first lens element E1, a second lens element E2, a third lens element E3, a stop S1, a fourth lens element E4, a fifth lens element E5, an aperture stop ST, a sixth lens element E6, a stop S2, a seventh lens element E7, an eighth lens element E8, a ninth lens element E9, a filter E10 and an image surface IMG. The optical imaging lens assembly includes nine lens elements (E1, E2, E3, E4, E5, E6, E7, E8 and E9) with no additional lens element disposed between each of the adjacent nine lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of glass material and has the object-side surface and the image-side surface being both spherical.

The third lens element E3 with negative refractive power has an object-side surface being convex in a paraxial region thereof and an image-side surface being concave in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The object-side surface of the third lens element E3 has one critical point in an off-axis region thereof.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point.

The fifth lens element E5 with positive refractive power has an object-side surface being convex in a paraxial region thereof and an image-side surface being convex in a paraxial region thereof. The fifth lens element E5 is made of glass material and has the object-side surface and the image-side surface being both aspheric.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The object-side surface of the seventh lens element E7 has one inflection point.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The object-side surface of the eighth lens element E8 has one inflection point. The image-side surface of the eighth lens element E8 has two inflection points. The image-side surface of the eighth lens element E8 has two critical points in an off-axis region thereof.

The ninth lens element E9 with negative refractive power has an object-side surface being convex in a paraxial region thereof and an image-side surface being concave in a paraxial region thereof. The ninth lens element E9 is made of plastic material and has the object-side surface and the image-side surface being both aspheric. The object-side surface of the ninth lens element E9 has two inflection points. The image-side surface of the ninth lens element E9 has one inflection point. The object-side surface of the ninth lens element E9 has two critical points in an off-axis region thereof. The image-side surface of the ninth lens element E9 has one critical point in an off-axis region thereof.

The filter E10 is made of glass material and located between the ninth lens element E9 and the image surface IMG, and will not affect the focal length of the optical imaging lens assembly. The image sensor IS is disposed on or near the image surface IMG of the optical imaging lens assembly.

The equation of the aspheric surface profiles of the aforementioned lens elements of the 1st embodiment is expressed as follows:

$$X ( Y ) = ( {Y}^{2} / R ) / ( 1 + sqrt ( 1 - ( 1 + k ) \times {( Y / R )}^{2} ) ) + {\sum }_{i} ( Ai ) \times ( {Y}^{i} ) ,$$

where,
X is the displacement in parallel with the optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12, 14, 16, 18, 20, and 22.

In the optical imaging lens assembly of the image capturing unit 1 according to the 1st embodiment, when a focal length of the optical imaging lens assembly is f, an f-number of the optical imaging lens assembly is Fno, and half of a maximum field of view of the optical imaging lens assembly is HFOV, these parameters have the following values: f=1.88 millimeters (mm), Fno=2.04, and HFOV=100.0 degrees (deg.).

When the maximum field of view of the optical imaging lens assembly is FOV, the following condition is satisfied: FOV=200.0 degrees.

When an axial distance between the object-side surface of the first lens element E1 and the image surface IMG is TL, and the focal length of the optical imaging lens assembly is f, the following condition is satisfied: TL/f=9.28.

When the axial distance between the object-side surface of the first lens element E1 and the image surface IMG is TL, and a maximum image height of the optical imaging lens assembly is ImgH, the following condition is satisfied: TL/ImgH=5.38.

When the maximum image height of the optical imaging lens assembly is ImgH, and an axial distance between the image-side surface of the ninth lens element E9 and the image surface IMG is BL, the following condition is satisfied: ImgH/BL=2.70.

When an axial distance between the aperture stop ST and the image-side surface of the ninth lens element E9 is SD, and the axial distance between the image-side surface of the ninth lens element E9 and the image surface IMG is BL, the following condition is satisfied: SD/BL=2.99.

When the focal length of the optical imaging lens assembly is f, and a focal length of the third lens element E3 is f3, the following condition is satisfied: |f/f3|=0.14.

When a focal length of the fourth lens element E4 is f4, and a focal length of the eighth lens element E8 is f8, the following condition is satisfied: |f8/f4|=0.56.

When the focal length of the optical imaging lens assembly is f, the focal length of the third lens element E3 is f3, a focal length of the seventh lens element E7 is f7, and a focal length of the ninth lens element E9 is f9, the following condition is satisfied: (|f/f3|+|f/f9|)/|f/f7|=0.24.

When the focal length of the optical imaging lens assembly is f, the focal length of the fourth lens element E4 is f4, a focal length of the eighth lens element E8 is f8, and the focal length of the ninth lens element E9 is f9, the following condition is satisfied: (|f/f4|+|f/f9|)/|f/f8|=0.60.

When the focal length of the optical imaging lens assembly is f, a curvature radius of the image-side surface of the fourth lens element E4 is R8, and a curvature radius of the image-side surface of the sixth lens element E6 is R12, the following condition is satisfied: |f/R8|+|f/R12|=1.32.

When a curvature radius of the object-side surface of the second lens element E2 is R3, and a curvature radius of the image-side surface of the second lens element E2 is R4, the following condition is satisfied: (R3+R4)/(R3−R4)=1.78.

When a curvature radius of the object-side surface of the third lens element E3 is R5, and the curvature radius of the image-side surface of the fourth lens element E4 is R8, the following condition is satisfied: (R5+R8)/(R5−R8)=0.93.

When a curvature radius of the object-side surface of the fourth lens element E4 is R7, and the curvature radius of the image-side surface of the fourth lens element E4 is R8, the following condition is satisfied: |R8/R7|=0.14.

When a curvature radius of the object-side surface of the sixth lens element E6 is R11, and the curvature radius of the image-side surface of the sixth lens element E6 is R12, the following condition is satisfied: |R12/R11|=0.27.

When a central thickness of the fourth lens element E4 is CT4, and a central thickness of the fifth lens element E5 is CT5, the following condition is satisfied: CT4/CT5=1.27.

When the central thickness of the fifth lens element E5 is CT5, and a central thickness of the sixth lens element E6 is CT6, the following condition is satisfied: CT6/CT5=0.14.

When an axial distance between the first lens element E1 and the second lens element E2 is T12, an axial distance between the second lens element E2 and the third lens element E3 is T23, and a sum of axial distances between each of all adjacent lens elements of the optical imaging lens assembly is CAT, the following condition is satisfied: (T12+T23)/ΣAT=0.76. In this embodiment, an axial distance between two adjacent lens elements is a distance in a paraxial region between two adjacent lens surfaces of the two adjacent lens elements. In this embodiment, EAT is the sum of the axial distances between each of all adjacent lens elements among the first lens element E1, the second lens element E2, the third lens element E3, the fourth lens element E4, the fifth lens element E5, the sixth lens element E6, the seventh lens element E7, the eighth lens element E8 and the ninth lens element E9.

When the axial distance between the second lens element E2 and the third lens element E3 is T23, a central thickness of the first lens element E1 is CT1, and a central thickness of the second lens element E2 is CT2, the following condition is satisfied: T23/(CT1+CT2)=1.46.

When an axial distance between the third lens element E3 and the fourth lens element E4 is T34, and a central thickness of the third lens element E3 is CT3, the following condition is satisfied: 10×T34/CT3=0.62.

When the axial distance between the second lens element E2 and the third lens element E3 is T23, the axial distance between the third lens element E3 and the fourth lens element E4 is T34, an axial distance between the fourth lens element E4 and the fifth lens element E5 is T45, and an axial distance between the seventh lens element E7 and the eighth lens element E8 is T78, the following condition is satisfied: (T34+T45+T78)/T23=0.26.

When the axial distance between the first lens element E1 and the second lens element E2 is T12, and an axial distance between the fifth lens element E5 and the sixth lens element E6 is T56, the following condition is satisfied: T56/T12=0.14.

When a refractive index of the fourth lens element E4 is N4, the following condition is satisfied: N4=1.587.

When an Abbe number of the third lens element E3 is V3, an Abbe number of the sixth lens element E6 is V6, and an Abbe number of the eighth lens element E8 is V8, the following condition is satisfied: V3+V6+V8=66.4.

When an Abbe number of the first lens element E1 is V1, and a refractive index of the first lens element E1 is N1, the following condition is satisfied: V1/N1=25.83.

When an Abbe number of the second lens element E2 is V2, and a refractive index of the second lens element E2 is N2, the following condition is satisfied: V2/N2=29.19.

When the Abbe number of the third lens element E3 is V3, and a refractive index of the third lens element E3 is N3, the following condition is satisfied: V3/N3=12.29.

When an Abbe number of the fourth lens element E4 is V4, and the refractive index of the fourth lens element E4 is N4, the following condition is satisfied: V4/N4=17.83.

When an Abbe number of the fifth lens element E5 is V5, and a refractive index of the fifth lens element E5 is N5, the following condition is satisfied: V5/N5=35.86.

When the Abbe number of the sixth lens element E6 is V6, and a refractive index of the sixth lens element E6 is N6, the following condition is satisfied: V6/N6=14.34.

When an Abbe number of the seventh lens element E7 is V7, and a refractive index of the seventh lens element E7 is N7, the following condition is satisfied: V7/N7=36.27.

When the Abbe number of the eighth lens element E8 is V8, and a refractive index of the eighth lens element E8 is N8, the following condition is satisfied: V8/N8=13.70.

When an Abbe number of the ninth lens element E9 is V9, and a refractive index of the ninth lens element E9 is N9, the following condition is satisfied: V9/N9=36.27.

When a displacement in parallel with the optical axis from an axial vertex of the object-side surface of the third lens element E3 to a maximum effective radius position of the object-side surface of the third lens element E3 is Sag3R1, and the central thickness of the second lens element E2 is CT2, the following condition is satisfied: Sag3R1/CT2=−1.24. In this embodiment, the direction of Sag3R1 faces towards the object side of the optical imaging lens assembly, and the value of Sag3R1 is negative.

When the maximum image height of the optical imaging lens assembly is ImgH, and a maximum effective radius of the image-side surface of the ninth lens element E9 is Y9R2, the following condition is satisfied: ImgH/Y9R2=1.26.

The detailed optical data of the 1st embodiment are shown in Table 1A and the aspheric surface data are shown in Table 1B below.

TABLE 1A
1st Embodiment
f = 1.88 mm, Fno = 2.04, HFOV = 100.0 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 12.3002 | (SPH) | 1.307 | Glass | 1.804 | 46.6 | −10.55 |
| 2 | | 4.7816 | (SPH) | 2.672 | | | | |
| 3 | Lens 2 | 11.2017 | (SPH) | 0.500 | Glass | 1.747 | 51.0 | −5.98 |
| 4 | | 3.1325 | (SPH) | 2.646 | | | | |
| 5 | Lens 3 | 109.4235 | (ASP) | 1.284 | Plastic | 1.660 | 20.4 | −13.23 |
| 6 | | 8.0488 | (ASP) | 0.311 | | | | |
| 7 | Stop | Plano | | −0.231 | | | | |
| 8 | Lens 4 | 28.0113 | (ASP) | 1.814 | Plastic | 1.587 | 28.3 | 5.90 |
| 9 | | −3.8611 | (ASP) | 0.571 | | | | |
| 10 | Lens 5 | 2.9777 | (ASP) | 1.425 | Glass | 1.623 | 58.2 | 3.80 |
| 11 | | −9.4126 | (ASP) | 0.390 | | | | |
| 12 | Ape. Stop | Plano | | −0.024 | | | | |
| 13 | Lens 6 | 8.5027 | (ASP) | 0.200 | Plastic | 1.639 | 23.5 | −4.89 |
| 14 | | 2.2638 | (ASP) | 0.206 | | | | |
| 15 | Stop | Plano | | 0.000 | | | | |
| 16 | Lens 7 | 4.6084 | (ASP) | 1.145 | Plastic | 1.544 | 56.0 | 2.71 |
| 17 | | −1.9779 | (ASP) | 0.033 | | | | |
| 18 | Lens 8 | −2.5876 | (ASP) | 0.524 | Plastic | 1.642 | 22.5 | −3.28 |
| 19 | | 12.0977 | (ASP) | 0.390 | | | | |
| 20 | Lens 9 | 104.5436 | (ASP) | 1.132 | Plastic | 1.544 | 56.0 | −75.44 |
| 21 | | 29.3587 | (ASP) | 0.500 | | | | |

| | | | | | | | |
|---|---|---|---|---|---|---|---|
| 22 | Filter | Plano | 0.300 | Glass | 1.517 | 64.2 | — |
| 23 | | Plano | 0.404 | | | | |
| 24 | Image | Plano | — | | | | |

Note:
Reference wavelength is 587.6 nm (d-line).
An effective radius of the stop S1 (Surface 7) is 2.648 mm.
An effective radius of the stop S2 (Surface 15) is 0.954 mm.

TABLE 1B
Aspheric Coefficients

| Surface # | 5 | 6 | 8 | 9 | 10 |
|---|---|---|---|---|---|
| k= | −9.900000E+01 | −5.606390E+00 | 2.593060E+01 | −1.752350E+00 | −1.846100E+00 |
| A4= | −2.048458E−02 | −1.198238E−02 | 7.138122E−03 | 2.578541E−03 | 7.728989E−03 |
| A6= | −1.914141E−04 | −1.930060E−03 | −3.812034E−03 | −8.086570E−04 | −8.479487E−04 |
| A8= | 4.671645E−04 | 5.229086E−03 | 5.303207E−03 | 1.711229E−04 | −1.869609E−04 |
| A10= | −1.531426E−04 | −2.780502E−03 | −2.890208E−03 | −4.679392E−05 | 1.286670E−04 |
| A12= | 7.670726E−05 | 7.936515E−04 | 8.230594E−04 | 1.074373E−05 | −3.842529E−05 |
| A14= | −2.615904E−05 | −1.390328E−04 | −1.390925E−04 | −1.966653E−06 | 4.130261E−06 |
| A16= | 5.203425E−06 | 1.539387E−05 | 1.416693E−05 | 2.491610E−07 | — |
| A18= | −6.061257E−07 | −1.045254E−06 | −8.082876E−07 | −1.835600E−08 | — |
| A20= | 3.872052E−08 | 3.905462E−08 | 1.986231E−08 | 5.659140E−10 | — |
| A22= | −1.051342E−09 | −5.919953E−10 | — | — | — |
| Surface # | 11 | 13 | 14 | 16 | 17 |
| k= | 1.476390E+01 | 3.163750E+01 | 9.826200E−01 | −1.526240E+01 | −3.548650E−01 |
| A4= | 5.475862E−03 | −3.011613E−02 | −6.028850E−02 | 2.432537E−03 | 5.267161E−02 |
| A6= | −1.071548E−03 | 6.010177E−02 | 1.067612E−01 | 1.616788E−02 | −3.663572E−01 |
| A8= | 1.748694E−05 | −1.007554E−01 | −2.915777E−01 | −7.725856E−02 | 8.765429E−01 |
| A10= | 9.975743E−05 | 1.216732E−01 | 6.762159E−01 | 2.151410E−01 | −1.353682E+00 |
| A12= | −2.417494E−05 | −9.967918E−02 | −1.083353E+00 | −3.967218E−01 | 1.342019E+00 |
| A14= | 2.645166E−06 | 4.751117E−02 | 1.060917E+00 | 4.247361E−01 | −8.589223E−01 |
| A16= | — | −9.939487E−03 | −5.691785E−01 | −2.479162E−01 | 3.436159E−01 |
| A18= | — | — | 1.282751E−01 | 5.988977E−02 | −7.876099E−02 |
| A20= | — | — | — | — | 8.002425E−03 |

| Surface # | 18 | 19 | 20 | 21 | — |
|---|---|---|---|---|---|
| k= | 6.962040E−01 | −7.297960E−01 | −9.900000E+01 | 2.534360E+01 | — |
| A4= | −3.939220E−04 | −2.586291E−02 | 4.002898E−03 | −1.619807E−02 | — |
| A6= | −3.329454E−01 | −4.017684E−02 | −1.204218E−02 | 2.226510E−03 | — |
| A8= | 7.470560E−01 | 6.622294E−02 | −2.804353E−03 | −1.236921E−03 | — |
| A10= | −9.945220E−01 | −5.591394E−02 | 1.043565E−02 | 4.508531E−04 | — |
| A12= | 7.831427E−01 | 3.053739E−02 | −9.047418E−03 | −1.071096E−04 | — |
| A14= | −3.226031E−01 | −1.039321E−02 | 4.357513E−03 | 9.691032E−06 | — |
| A16= | 3.331914E−02 | 2.123743E−03 | −1.238499E−03 | 1.906021E−06 | — |
| A18= | 2.096383E−02 | −2.404242E−04 | 2.057667E−04 | −6.028467E−07 | — |
| A20= | −5.624531E−03 | 1.163902E−05 | −1.852424E−05 | 5.929193E−08 | — |
| A22= | — | — | 6.996013E−07 | −2.078586E−09 | — |

In Table 1A, the curvature radius, the thickness and the focal length are shown in millimeters (mm). Surface numbers 0-24 represent the surfaces sequentially arranged from the object side to the image side along the optical axis. In Table 1B, k represents the conic coefficient of the equation of the aspheric surface profiles. A4-A22 represent the aspheric coefficients ranging from the 4th order to the 22nd order. The tables presented below for each embodiment are the corresponding schematic parameter and aberration curves, and the definitions of the tables are the same as Table 1A and Table 1B of the 1st embodiment. Therefore, an explanation in this regard will not be provided again.

### 2nd Embodiment

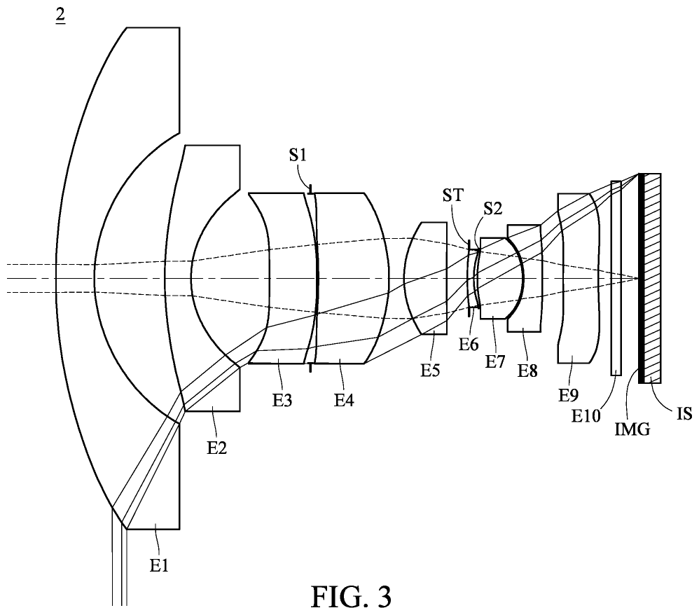

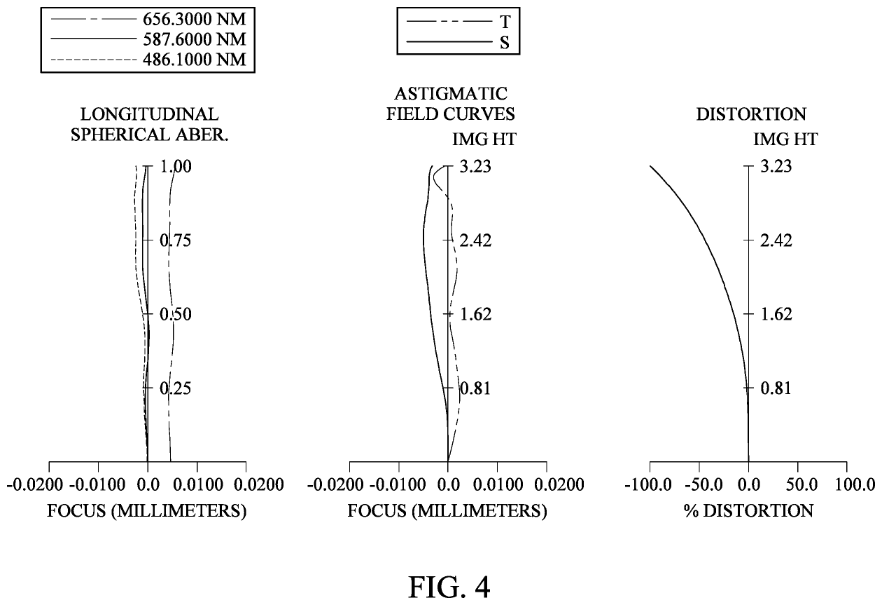

FIG. 3 is a schematic view of an image capturing unit 2 according to the 2nd embodiment of the present disclosure. FIG. 4 shows, in order from left to right, spherical aberration curves, astigmatic field curves and a distortion curve of the image capturing unit according to the 2nd embodiment. In FIG. 3, the image capturing unit 2 includes the optical imaging lens assembly (its reference numeral is omitted) of the present disclosure and an image sensor IS. The optical imaging lens assembly includes, in order from an object side to an image side along an optical axis, a first lens element E1, a second lens element E2, a third lens element E3, a stop S1, a fourth lens element E4, a fifth lens element E5, an aperture stop ST, a sixth lens element E6, a stop S2, a seventh lens element E7, an eighth lens element E8, a ninth lens element E9, a filter E10 and an image surface IMG. The optical imaging lens assembly includes nine lens elements (E1, E2, E3, E4, E5, E6, E7, E8 and E9) with no additional lens element disposed between each of the adjacent nine lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of glass material and has the object-side surface and the image-side surface being both aspheric. The object-side surface of the second lens element E2 has one inflection point. The image-side surface of the second lens element E2 has one inflection point.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The object-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points.

The fifth lens element E5 with positive refractive power has an object-side surface being convex in a paraxial region thereof and an image-side surface being concave in a paraxial region thereof. The fifth lens element E5 is made of glass material and has the object-side surface and the image-side surface being both aspheric. The image-side surface of the fifth lens element E5 has one inflection point. The image-side surface of the fifth lens element E5 has one critical point in an off-axis region thereof.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The object-side surface of the seventh lens element E7 has one inflection point.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The image-side surface of the eighth lens element E8 has two inflection points. The image-side surface of the eighth lens element E8 has two critical points in an off-axis region thereof.

The ninth lens element E9 with negative refractive power has an object-side surface being convex in a paraxial region thereof and an image-side surface being concave in a paraxial region thereof. The ninth lens element E9 is made of plastic material and has the object-side surface and the image-side surface being both aspheric. The object-side surface of the ninth lens element E9 has two inflection points. The image-side surface of the ninth lens element E9 has one inflection point. The object-side surface of the ninth lens element E9 has one critical point in an off-axis region thereof. The image-side surface of the ninth lens element E9 has one critical point in an off-axis region thereof.

The filter E10 is made of glass material and located between the ninth lens element E9 and the image surface IMG, and will not affect the focal length of the optical imaging lens assembly. The image sensor IS is disposed on or near the image surface IMG of the optical imaging lens assembly.

The detailed optical data of the 2nd embodiment are shown in Table 2A and the aspheric surface data are shown in Table 2B below.

TABLE 2A
2nd Embodiment
f = 2.04 mm, Fno = 2.34, HFOV = 90.0 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 16.3851 | (ASP) | 1.186 | Glass | 1.804 | 46.6 | −8.73 |
| 2 | | 4.7565 | (ASP) | 2.175 | | | | |
| 3 | Lens 2 | 11.1900 | (ASP) | 0.810 | Glass | 1.729 | 54.7 | −6.12 |
| 4 | | 3.0916 | (ASP) | 2.418 | | | | |
| 5 | Lens 3 | 100.3644 | (ASP) | 1.470 | Plastic | 1.587 | 28.3 | 23.16 |
| 6 | | −15.6466 | (ASP) | −0.200 | | | | |
| 7 | Stop | Plano | | 0.247 | | | | |
| 8 | Lens 4 | −12.2161 | (ASP) | 2.181 | Plastic | 1.544 | 56.0 | 12.35 |
| 9 | | −4.6075 | (ASP) | 0.463 | | | | |
| 10 | Lens 5 | 3.0065 | (ASP) | 1.313 | Glass | 1.589 | 61.2 | 5.17 |
| 11 | | 200.0000 | (ASP) | 0.691 | | | | |
| 12 | Ape. Stop | Plano | | −0.052 | | | | |
| 13 | Lens 6 | 6.8371 | (ASP) | 0.200 | Plastic | 1.639 | 23.5 | −5.96 |
| 14 | | 2.4169 | (ASP) | 0.153 | | | | |
| 15 | Stop | Plano | | −0.040 | | | | |
| 16 | Lens 7 | 3.8341 | (ASP) | 1.398 | Plastic | 1.544 | 56.0 | 2.61 |
| 17 | | −1.9689 | (ASP) | 0.030 | | | | |
| 18 | Lens 8 | −2.3058 | (ASP) | 0.574 | Plastic | 1.614 | 25.6 | −3.45 |
| 19 | | 28.0223 | (ASP) | 0.643 | | | | |
| 20 | Lens 9 | 19.3381 | (ASP) | 1.088 | Plastic | 1.544 | 56.0 | −386.86 |
| 21 | | 17.3597 | (ASP) | 0.400 | | | | |

| | | | | | | | |
|---|---|---|---|---|---|---|---|
| 22 | Filter | Plano | 0.300 | Glass | 1.517 | 64.2 | — |
| 23 | | Plano | 0.549 | | | | |
| 24 | Image | Plano | — | | | | |

Note:
Reference wavelength is 587.6 nm (d-line).
An effective radius of the stop S1 (Surface 7) is 2.614 mm.
An effective radius of the stop S2 (Surface 15) is 0.832 mm.

TABLE 2B
Aspheric Coefficients

| Surface # | 1 | 2 | 3 | 4 | 5 |
|---|---|---|---|---|---|
| k= | 9.608370E−01 | −1.732600E−01 | −2.524690E+00 | −2.039550E−01 | 9.786400E+01 |
| A4= | 2.289344E−04 | −1.732720E−03 | 6.354994E−04 | 5.786074E−03 | −1.563826E−02 |
| A6= | −1.136880E−05 | 2.013695E−04 | −3.740213E−04 | −2.291409E−03 | −1.838438E−03 |
| A8= | 1.718904E−07 | −1.448494E−05 | 5.838795E−05 | 4.012877E−04 | 4.428988E−04 |
| A10= | 1.496032E−10 | 7.138254E−07 | −4.058332E−06 | −5.148105E−05 | −1.286471E−04 |
| A12= | −2.256902E−11 | −2.785940E−08 | 1.245474E−07 | 6.380574E−06 | 6.841057E−05 |
| A14= | 1.554782E−13 | 5.687882E−10 | −1.354956E−09 | −4.125115E−07 | −1.797591E−05 |
| A16= | — | — | — | — | 2.399126E−06 |
| A18= | — | — | — | — | −1.620810E−07 |
| A20= | — | — | — | — | 4.431893E−09 |
| Surface # | 6 | 8 | 9 | 10 | 11 |
| k= | 2.403220E+01 | −1.079810E−01 | −1.567500E+00 | −1.382240E+00 | −9.900000E+01 |
| A4= | −1.670655E−02 | −1.367380E−03 | 4.489218E−03 | 8.648811E−03 | 3.106990E−03 |
| A6= | 1.034871E−02 | 1.105295E−02 | −1.554238E−03 | −1.073327E−03 | −1.477729E−03 |
| A8= | −5.337189E−03 | −6.221503E−03 | 3.269486E−04 | 3.630025E−04 | 1.860744E−03 |
| A10= | 1.836471E−03 | 2.064104E−03 | −8.911532E−05 | −1.184529E−04 | −3.264844E−03 |
| A12= | −4.133302E−04 | −4.601912E−04 | 1.761976E−05 | 1.448135E−05 | 2.975622E−03 |
| A14= | 6.101646E−05 | 6.801886E−05 | −2.219990E−06 | −1.727726E−06 | −1.795851E−03 |
| A16= | −5.702534E−06 | −6.398218E−06 | 1.703673E−07 | — | 7.368590E−04 |
| A18= | 3.071938E−07 | 3.487885E−07 | −7.242585E−09 | — | −2.013107E−04 |
| A20= | −7.234109E−09 | −8.421262E−09 | 1.266880E−10 | — | 3.490641E−05 |
| A22= | — | — | — | — | −3.471040E−06 |
| A24= | — | — | — | — | 1.506914E−07 |
| Surface # | 13 | 14 | 16 | 17 | 18 |
| k= | 2.469680E+01 | 1.425220E+00 | −9.553030E+00 | −3.541450E−01 | −3.284610E−01 |
| A4= | −2.277961E−02 | −4.230362E−02 | 5.936301E−03 | −4.001118E−02 | −9.272323E−02 |
| A6= | 2.731526E−02 | 5.469807E−02 | −1.224133E−02 | 1.231687E−01 | 1.591268E−01 |
| A8= | −4.793085E−02 | −1.277893E−01 | 9.485828E−02 | −2.595817E−01 | −2.819029E−01 |
| A10= | 5.369225E−02 | 2.762556E−01 | −3.669483E−01 | 1.260064E−01 | 1.608020E−01 |
| A12= | −4.148663E−02 | −4.361170E−01 | 7.628682E−01 | 1.978791E−01 | 1.348550E−01 |
| A14= | 1.950421E−02 | 4.332736E−01 | −9.205848E−01 | −3.669106E−01 | −2.865301E−01 |
| A16= | −4.115799E−03 | −2.374426E−01 | 5.847213E−01 | 2.650083E−01 | 2.091358E−01 |
| A18= | — | 5.576188E−02 | −1.418119E−01 | −9.496188E−02 | −7.507232E−02 |
| A20= | — | — | −8.455006E−03 | 1.381889E−02 | 1.101580E−02 |

| Surface # | 19 | 20 | 21 | — | — |
|---|---|---|---|---|---|
| k= | 9.900000E+01 | −7.371080E+01 | 3.432470E+01 | — | — |
| A4= | −5.932923E−02 | −1.886866E−02 | 6.163371E−03 | — | — |
| A6= | 4.329017E−02 | −4.777202E−03 | −1.856554E−02 | — | — |
| A8= | −3.358908E−02 | 9.669494E−03 | 1.239577E−02 | — | — |
| A10= | 1.936729E−02 | −8.458765E−03 | −5.468146E−03 | — | — |
| A12= | −5.694597E−03 | 4.415014E−03 | 1.663962E−03 | — | — |
| A14= | 2.150829E−04 | −1.527189E−03 | −3.572074E−04 | — | — |
| A16= | 4.345396E−04 | 3.658157E−04 | 5.325784E−05 | — | — |
| A18= | −1.372642E−04 | −5.783221E−05 | −5.242997E−06 | — | — |
| A20= | 1.371750E−05 | 5.322988E−06 | 3.057123E−07 | — | — |
| A22= | — | −2.136669E−07 | −7.978389E−09 | — | — |

In the 2nd embodiment, the equation of the aspheric surface profiles of the aforementioned lens elements is the same as the equation of the 1st embodiment. Also, the definitions of these parameters shown in Table 2C below are the same as those stated in the 1st embodiment with corresponding values for the 2nd embodiment, so an explanation in this regard will not be provided again.

Moreover, these parameters can be calculated from Table 2A and Table 2B as the following values and satisfy the following conditions:

TABLE 2C
Values of Conditional Expressions

| | | | |
|---|---|---|---|
| f[mm] | 2.04 | (T12 + T23)/ΣAT | 0.70 |
| Fno | 2.34 | T23/(CT1 + CT2) | 1.21 |
| HFOV [deg.] | 90.0 | 10 × T34/CT3 | 0.32 |
| FOV [deg.] | 180.0 | (T34 + T45 + T78)/T23 | 0.22 |
| TL/f | 8.84 | T56/T12 | 0.29 |
| TL/ImgH | 5.57 | N4 | 1.544 |
| ImgH/BL | 2.59 | V3 + V6 + V8 | 77.4 |
| SD/BL | 3.20 | V1/N1 | 25.83 |
| \|f/f3\| | 0.09 | V2/N2 | 31.64 |
| \|f8/f4\| | 0.28 | V3/N3 | 17.83 |
| (\|f/f3\| + \|f/f9\|)/\|f/f7\| | 0.12 | V4/N4 | 36.27 |
| (\|f/f4\| + \|f/f9\|)/\|f/f8\| | 0.29 | V5/N5 | 38.51 |
| \|f/R8\| + \|f/R12\| | 1.28 | V6/N6 | 14.34 |
| (R3 + R4)/(R3 − R4) | 1.76 | V7/N7 | 36.27 |
| (R5 + R8)/(R5 − R8) | 0.91 | V8/N8 | 15.86 |
| \|R8/R7\| | 0.38 | V9/N9 | 36.27 |
| \|R12/R11\| | 0.35 | Sag3R1/CT2 | −0.79 |
| CT4/CT5 | 1.66 | ImgH/Y9R2 | 1.23 |
| CT6/CT5 | 0.15 | — | — |

### 3rd Embodiment

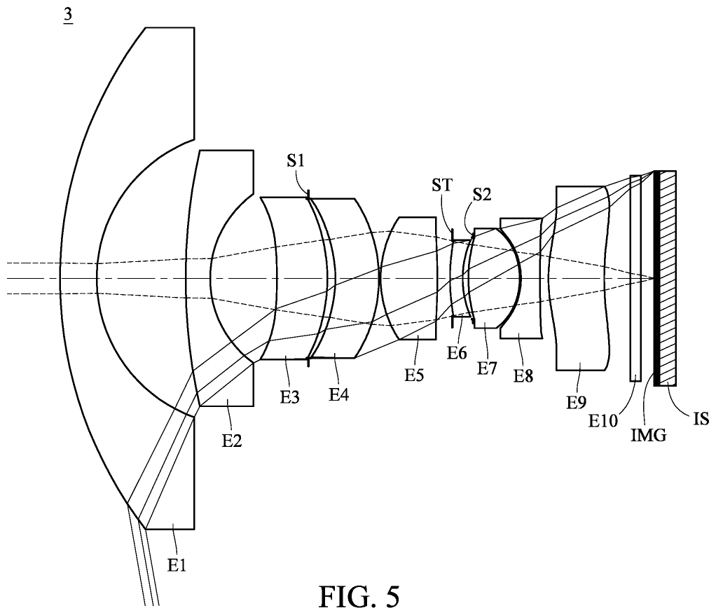

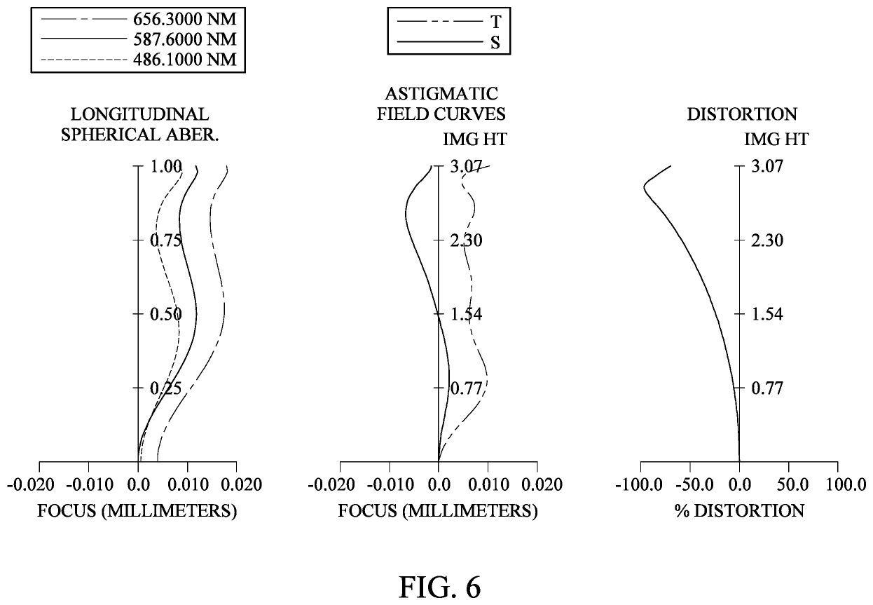

FIG. 5 is a schematic view of an image capturing unit 3 according to the 3rd embodiment of the present disclosure. FIG. 6 shows, in order from left to right, spherical aberration curves, astigmatic field curves and a distortion curve of the image capturing unit according to the 3rd embodiment. In FIG. 5, the image capturing unit 3 includes the optical imaging lens assembly (its reference numeral is omitted) of the present disclosure and an image sensor IS. The optical imaging lens assembly includes, in order from an object side to an image side along an optical axis, a first lens element E1, a second lens element E2, a third lens element E3, a stop S1, a fourth lens element E4, a fifth lens element E5, an aperture stop ST, a sixth lens element E6, a stop S2, a seventh lens element E7, an eighth lens element E8, a ninth lens element E9, a filter E10 and an image surface IMG. The optical imaging lens assembly includes nine lens elements (E1, E2, E3, E4, E5, E6, E7, E8 and E9) with no additional lens element disposed between each of the adjacent nine lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of glass material and has the object-side surface and the image-side surface being both spherical.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The image-side surface of the third lens element E3 has one inflection point.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric.

The fifth lens element E5 with positive refractive power has an object-side surface being convex in a paraxial region thereof and an image-side surface being convex in a paraxial region thereof. The fifth lens element E5 is made of glass material and has the object-side surface and the image-side surface being both aspheric. The image-side surface of the fifth lens element E5 has two inflection points.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The object-side surface of the seventh lens element E7 has two inflection points.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The object-side surface of the eighth lens element E8 has one inflection point. The image-side surface of the eighth lens element E8 has two inflection points.

The ninth lens element E9 with positive refractive power has an object-side surface being convex in a paraxial region thereof and an image-side surface being concave in a paraxial region thereof. The ninth lens element E9 is made of plastic material and has the object-side surface and the image-side surface being both aspheric. The object-side surface of the ninth lens element E9 has one inflection point. The image-side surface of the ninth lens element E9 has one inflection point. The object-side surface of the ninth lens element E9 has one critical point in an off-axis region thereof. The image-side surface of the ninth lens element E9 has one critical point in an off-axis region thereof.

The filter E10 is made of glass material and located between the ninth lens element E9 and the image surface IMG, and will not affect the focal length of the optical imaging lens assembly. The image sensor IS is disposed on or near the image surface IMG of the optical imaging lens assembly.

The detailed optical data of the 3rd embodiment are shown in Table 3A and the aspheric surface data are shown in Table 3B below.

TABLE 3A
3rd Embodiment
f = 1.78 mm, Fno = 2.02, HFOV = 100.0 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 11.7353 | (SPH) | 1.050 | Glass | 1.835 | 42.7 | −8.45 |
| 2 | | 4.2252 | (SPH) | 2.543 | | | | |
| 3 | Lens 2 | 16.7733 | (SPH) | 0.700 | Glass | 1.755 | 52.3 | −4.91 |
| 4 | | 2.9791 | (SPH) | 1.910 | | | | |
| 5 | Lens 3 | −14.0210 | (ASP) | 1.443 | Plastic | 1.639 | 23.5 | 10.75 |
| 6 | | −4.7924 | (ASP) | −0.540 | | | | |
| 7 | Stop | Plano | | 0.771 | | | | |
| 8 | Lens 4 | −3.4033 | (ASP) | 1.244 | Plastic | 1.544 | 56.0 | −42.98 |
| 9 | | −4.4960 | (ASP) | 0.050 | | | | |
| 10 | Lens 5 | 2.9452 | (ASP) | 1.623 | Glass | 1.589 | 61.2 | 4.19 |
| 11 | | −12.1453 | (ASP) | 0.431 | | | | |
| 12 | Ape. Stop | Plano | | −0.068 | | | | |
| 13 | Lens 6 | 6.6271 | (ASP) | 0.360 | Plastic | 1.639 | 23.5 | −6.89 |
| 14 | | 2.5894 | (ASP) | 0.300 | | | | |
| 15 | Stop | Plano | | −0.137 | | | | |
| 16 | Lens 7 | 3.6401 | (ASP) | 1.469 | Plastic | 1.544 | 56.0 | 2.57 |
| 17 | | −1.9524 | (ASP) | 0.035 | | | | |
| 18 | Lens 8 | −1.9718 | (ASP) | 0.544 | Plastic | 1.639 | 23.5 | −2.76 |
| 19 | | 18.3483 | (ASP) | 0.240 | | | | |
| 20 | Lens 9 | 3.6471 | (ASP) | 1.598 | Plastic | 1.544 | 56.0 | 11.23 |
| 21 | | 7.6492 | (ASP) | 0.750 | | | | |

| | | | | | | | |
|---|---|---|---|---|---|---|---|
| 22 | Filter | Plano | 0.300 | Glass | 1.517 | 64.2 | — |
| 23 | | Plano | 0.378 | | | | |
| 24 | Image | Plano | — | | | | |

Note:
Reference wavelength is 587.6nm (d-line).
An effective radius of the stop S1 (Surface 7) is 2.280 mm.
An effective radius of the stop S2 (Surface 15) is 1.165 mm.

TABLE 3B
Aspheric Coefficients

| Surface # | 5 | 6 | 8 | 9 | 10 |
|---|---|---|---|---|---|
| k= | 0.000000E+00 | −1.958930E+00 | −5.237440E−01 | −1.051340E−01 | −2.101340E+00 |
| A4= | −9.600556E−03 | 7.920654E−03 | 2.796171E−02 | −1.671559E−02 | −9.974725E−03 |
| A6= | −1.329347E−03 | −1.099181E−02 | −2.545348E−02 | 1.017814E−02 | 1.314031E−02 |
| A8= | 5.061737E−04 | 5.298552E−03 | 1.557692E−02 | −4.025567E−03 | −5.396792E−03 |
| A10= | −1.132734E−04 | −1.083871E−03 | −5.837956E−03 | 1.150671E−03 | 1.435202E−03 |
| A12= | 3.919742E−05 | −3.665974E−05 | 1.366230E−03 | −2.459281E−04 | −2.047871E−04 |
| A14= | −1.366816E−05 | 6.307479E−05 | −2.058140E−04 | 3.775855E−05 | 9.786998E−06 |
| A16= | 2.870912E−06 | −1.286566E−05 | 1.984816E−05 | −3.891048E−06 | — |
| A18= | −3.045066E−07 | 1.172916E−06 | −1.136250E−06 | 2.379662E−07 | — |
| A20= | 1.275380E−08 | −4.242434E−08 | 2.944185E−08 | −6.472466E−09 | — |
| Surface # | 11 | 13 | 14 | 16 | 17 |
| k= | 6.202790E+00 | 5.687990E+00 | 2.138760E+00 | −1.678940E+01 | −1.224430E+00 |
| A4= | 2.799969E−02 | 1.970529E−02 | −3.467126E−02 | 1.757924E−02 | 6.527206E−02 |
| A6= | −2.087442E−02 | −2.810194E−02 | −1.255111E−02 | −1.152759E−02 | −3.572591E−01 |
| A8= | 1.274122E−02 | 2.060598E−02 | 3.870351E−02 | 2.828670E−02 | 7.950118E−01 |
| A10= | −4.918684E−03 | −3.823535E−03 | −6.082710E−02 | −6.483151E−02 | −1.110075E+00 |
| A12= | 9.356339E−04 | −6.484525E−03 | 8.315669E−02 | 1.029274E−01 | 9.569577E−01 |
| A14= | −6.949384E−05 | 3.959378E−03 | −8.551944E−02 | −9.321094E−02 | −5.122998E−01 |
| A16= | — | −6.309453E−04 | 4.718481E−02 | 4.119279E−02 | 1.663494E−01 |
| A18= | — | — | −1.018388E−02 | −6.895216E−03 | −3.010036E−02 |
| A20= | — | — | — | — | 2.340573E−03 |

| Surface # | 18 | 19 | 20 | 21 | — |
|---|---|---|---|---|---|
| k= | 0.000000E+00 | 8.167970E+01 | 0.000000E+00 | 0.000000E+00 | — |
| A4= | 7.776951E−02 | −2.442760E−02 | −4.818736E−02 | −4.941040E−03 | — |
| A6= | −3.242182E−01 | −8.129432E−03 | 1.898145E−02 | −3.573775E−03 | — |
| A8= | 7.377098E−01 | 4.863299E−02 | −7.604276E−03 | 2.469151E−03 | — |
| A10= | −1.026167E+00 | −6.119620E−02 | 2.874698E−03 | −1.021789E−03 | — |
| A12= | 8.746018E−01 | 4.298281E−02 | −1.200551E−03 | 2.769962E−04 | — |
| A14= | −4.588851E−01 | −1.859459E−02 | 4.283645E−04 | −5.038270E−05 | — |
| A16= | 1.447571E−01 | 4.953682E−03 | −1.001535E−04 | 5.842492E−06 | — |
| A18= | −2.501007E−02 | −7.491372E−04 | 1.298275E−05 | −3.894533E−07 | — |
| A20= | 1.801349E−03 | 4.934755E−05 | −7.127925E−07 | 1.125409E−08 | — |

In the 3rd embodiment, the equation of the aspheric surface profiles of the aforementioned lens elements is the same as the equation of the 1st embodiment. Also, the definitions of these parameters shown in Table 3C below are the same as those stated in the 1st embodiment with corresponding values for the 3rd embodiment, so an explanation in this regard will not be provided again.

Moreover, these parameters can be calculated from Table 3A and Table 3B as the following values and satisfy the following conditions:

TABLE 3C
Values of Conditional Expressions

| | | | |
|---|---|---|---|
| f [mm] | 1.78 | (T12 + T23)/ΣAT | 0.80 |
| Fno | 2.02 | T23/(CT1 + CT2) | 1.09 |
| HFOV [deg.] | 100.0 | 10 × T34/CT3 | 1.60 |
| FOV [deg.] | 200.0 | (T34 + T45 + T78)/T23 | 0.17 |
| TL/f | 9.52 | T56/T12 | 0.14 |
| TL/ImgH | 5.53 | N4 | 1.544 |
| ImgH/BL | 2.15 | V3 + V6 + V8 | 70.5 |
| SD/BL | 3.04 | V1/N1 | 23.27 |
| \|f/f3\| | 0.17 | V2/N2 | 29.80 |
| \|f8/f4\| | 0.06 | V3/N3 | 14.34 |
| (\|f/f3\| + \|f/f9\|)/\|f/f7\| | 0.47 | V4/N4 | 36.27 |
| (\|f/f4\| + \|f/f9\|)/\|f/f8\| | 0.31 | V5/N5 | 38.51 |
| \|f/R8\| + \|f/R12\| | 1.09 | V6/N6 | 14.34 |
| (R3 + R4)/(R3 − R4) | 1.43 | V7/N7 | 36.27 |
| (R5 + R8)/(R5 − R8) | 1.94 | V8/N8 | 14.34 |
| \|R8/R7\| | 1.32 | V9/N9 | 36.27 |
| \|R12/R11\| | 0.39 | Sag3R1/CT2 | −0.68 |
| CT4/CT5 | 0.77 | ImgH/Y9R2 | 1.17 |
| CT6/CT5 | 0.22 | — | — |

### 4th Embodiment

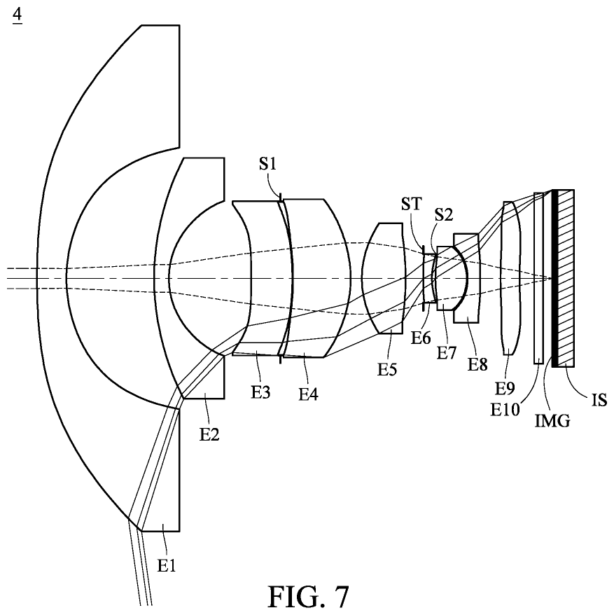

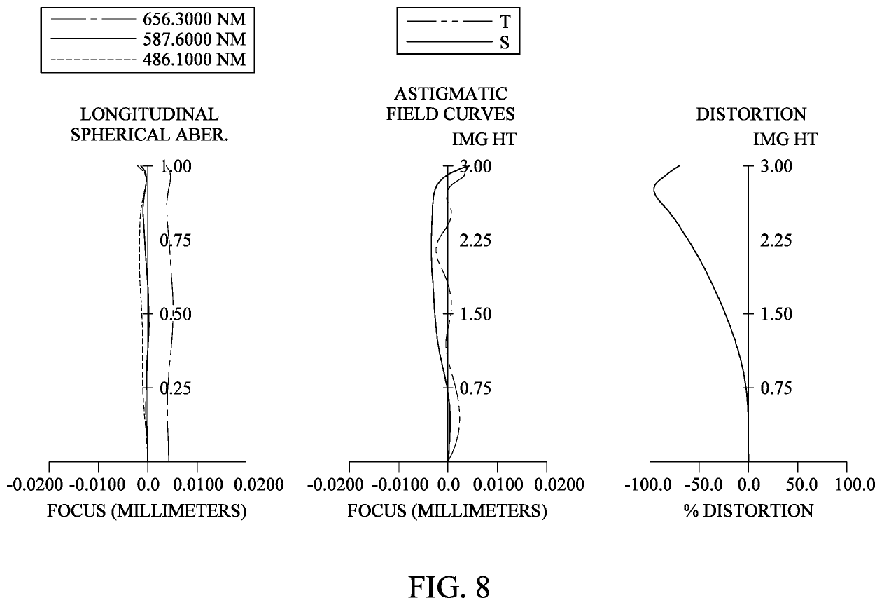

FIG. 7 is a schematic view of an image capturing unit 4 according to the 4th embodiment of the present disclosure. FIG. 8 shows, in order from left to right, spherical aberration curves, astigmatic field curves and a distortion curve of the image capturing unit according to the 4th embodiment. In FIG. 7, the image capturing unit 4 includes the optical imaging lens assembly (its reference numeral is omitted) of the present disclosure and an image sensor IS. The optical imaging lens assembly includes, in order from an object side to an image side along an optical axis, a first lens element E1, a second lens element E2, a third lens element E3, a stop S1, a fourth lens element E4, a fifth lens element E5, an aperture stop ST, a sixth lens element E6, a stop S2, a seventh lens element E7, an eighth lens element E8, a ninth lens element E9, a filter E10 and an image surface IMG. The optical imaging lens assembly includes nine lens elements (E1, E2, E3, E4, E5, E6, E7, E8 and E9) with no additional lens element disposed between each of the adjacent nine lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of glass material and has the object-side surface and the image-side surface being both aspheric. The object-side surface of the second lens element E2 has one inflection point.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points.

The fifth lens element E5 with positive refractive power has an object-side surface being convex in a paraxial region thereof and an image-side surface being convex in a paraxial region thereof. The fifth lens element E5 is made of glass material and has the object-side surface and the image-side surface being both aspheric.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The object-side surface of the seventh lens element E7 has one inflection point.

The eighth lens element E8 with negative refractive power has an object-side surface being concave in a paraxial region thereof and an image-side surface being convex in a paraxial region thereof. The eighth lens element E8 is made of plastic material and has the object-side surface and the image-side surface being both aspheric. The object-side surface of the eighth lens element E8 has one inflection point. The image-side surface of the eighth lens element E8 has one inflection point. The image-side surface of the eighth lens element E8 has one critical point in an off-axis region thereof.

The ninth lens element E9 with positive refractive power has an object-side surface being convex in a paraxial region thereof and an image-side surface being concave in a paraxial region thereof. The ninth lens element E9 is made of plastic material and has the object-side surface and the image-side surface being both aspheric. The object-side surface of the ninth lens element E9 has three inflection points. The image-side surface of the ninth lens element E9 has one inflection point. The object-side surface of the ninth lens element E9 has two critical points in an off-axis region thereof. The image-side surface of the ninth lens element E9 has one critical point in an off-axis region thereof.

The filter E10 is made of glass material and located between the ninth lens element E9 and the image surface IMG, and will not affect the focal length of the optical imaging lens assembly. The image sensor IS is disposed on or near the image surface IMG of the optical imaging lens assembly.

The detailed optical data of the 4th embodiment are shown in Table 4A and the aspheric surface data are shown in Table 4B below.

TABLE 4A
4th Embodiment
f = 1.43 mm, Fno = 2.10, HFOV = 98.0 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 22.1830 | (ASP) | 1.000 | Glass | 1.804 | 46.6 | −7.55 |
| 2 | | 4.6724 | (ASP) | 2.983 | | | | |
| 3 | Lens 2 | 8.8870 | (ASP) | 0.500 | Glass | 1.804 | 46.6 | −5.19 |
| 4 | | 2.7699 | (ASP) | 2.791 | | | | |
| 5 | Lens 3 | −100.0000 | (ASP) | 1.397 | Plastic | 1.660 | 20.4 | 21.51 |
| 6 | | −12.5019 | (ASP) | −0.400 | | | | |
| 7 | Stop | Plano | | 0.430 | | | | |
| 8 | Lens 4 | −7.6450 | (ASP) | 1.956 | Plastic | 1.544 | 56.0 | 12.09 |
| 9 | | −3.8538 | (ASP) | 0.379 | | | | |
| 10 | Lens 5 | 3.1350 | (ASP) | 1.486 | Glass | 1.589 | 61.2 | 4.21 |
| 11 | | −9.7913 | (ASP) | 0.605 | | | | |
| 12 | Ape. Stop | Plano | | −0.007 | | | | |
| 13 | Lens 6 | 8.6468 | (ASP) | 0.300 | Plastic | 1.669 | 19.5 | −4.91 |
| 14 | | 2.3489 | (ASP) | 0.143 | | | | |
| 15 | Stop | Plano | | −0.025 | | | | |
| 16 | Lens 7 | 4.8621 | (ASP) | 1.061 | Plastic | 1.544 | 56.0 | 2.32 |
| 17 | | −1.5713 | (ASP) | 0.030 | | | | |
| 18 | Lens 8 | −1.7613 | (ASP) | 0.430 | Plastic | 1.614 | 25.6 | −3.01 |
| 19 | | −41.6667 | (ASP) | 0.688 | | | | |
| 20 | Lens 9 | 10.3195 | (ASP) | 0.646 | Plastic | 1.544 | 56.0 | 62.03 |
| 21 | | 14.5370 | (ASP) | 0.500 | | | | |

| | | | | | | | |
|---|---|---|---|---|---|---|---|
| 22 | Filter | Plano | 0.300 | Glass | 1.517 | 64.2 | — |
| 23 | | Plano | 0.309 | | | | |
| 24 | Image | Plano | — | | | | |

Note: Reference wavelength is 587.6 nm (d-line).
An effective radius of the stop S1 (Surface 7) is 2.606 mm.
An effective radius of the stop S2 (Surface 15) is 0.742 mm.

TABLE 4B
Aspheric Coefficients

| Surface # | 1 | 2 | 3 | 4 | 5 |
|---|---|---|---|---|---|
| k= | 3.428030E+00 | 1.427890E−02 | −7.101450E−02 | −1.604760E−01 | −9.900000E+01 |
| A4= | 3.654065E−04 | −2.566262E−03 | 1.233904E−03 | 7.988987E−03 | −1.602645E−02 |
| A6= | 2.878732E−05 | 2.887007E−04 | −2.252419E−04 | −1.838995E−03 | −1.141517E−03 |
| A8= | −1.870492E−06 | −4.800993E−06 | 9.255638E−06 | 2.041953E−04 | −4.011331E−04 |
| A10= | 5.122173E−08 | −1.022353E−06 | 3.818581E−07 | −2.834861E−05 | 7.799432E−04 |
| A12= | −7.432716E−10 | 1.469230E−07 | −1.651220E−08 | 1.151726E−05 | −4.888765E−04 |
| A14= | 5.508887E−12 | −8.870918E−09 | −6.686342E−10 | −2.372088E−06 | 1.801244E−04 |
| A16= | −1.632157E−14 | 2.089289E−10 | 1.686536E−11 | 1.804678E−07 | −4.168235E−05 |
| A18= | — | — | — | — | 6.242453E−06 |
| A20= | — | — | — | — | −5.993575E−07 |
| A22= | — | — | — | — | 3.408876E−08 |
| A24= | — | — | — | — | −8.811493E−10 |
| Surface # | 6 | 8 | 9 | 10 | 11 |
| k= | 1.809850E+01 | 1.005240E+00 | −1.653140E+00 | −1.767060E+00 | 1.551200E+01 |
| A4= | −1.628340E−02 | −1.290159E−03 | 7.047361E−03 | 9.714750E−03 | 1.196581E−03 |
| A6= | 1.093501E−02 | 1.319124E−02 | −4.312217E−03 | −4.257589E−03 | 2.052478E−03 |
| A8= | −6.686528E−03 | −9.630997E−03 | 1.730047E−03 | 2.048610E−03 | −1.264407E−03 |
| A10= | 2.790270E−03 | 4.224232E−03 | −5.075577E−04 | −6.233175E−04 | 5.211920E−04 |
| A12= | −7.613080E−04 | −1.203229E−03 | 9.729002E−05 | 8.244400E−05 | −1.224201E−04 |
| A14= | 1.339604E−04 | 2.187838E−04 | −1.199978E−05 | 5.445731E−06 | 1.769198E−05 |
| A16= | −1.453572E−05 | −2.447972E−05 | 9.185961E−07 | −2.654096E−06 | −1.580084E−06 |
| A18= | 8.801034E−07 | 1.535669E−06 | −3.960568E−08 | 2.036370E−07 | 8.288892E−08 |
| A20= | −2.255160E−08 | −4.126916E−08 | 7.303225E−10 | — | — |
| Surface # | 13 | 14 | 16 | 17 | 18 |
| k= | 3.330340E+01 | 1.489810E+00 | −1.628460E+01 | 3.674050E−02 | 1.807370E−01 |
| A4= | −2.836835E−02 | −5.595501E−02 | −3.407455E−03 | 5.112157E−02 | −7.331710E−03 |
| A6= | 5.089319E−02 | 1.161873E−01 | 1.772499E−02 | −1.613926E−01 | −1.183303E−01 |
| A8= | −9.290322E−02 | −3.638783E−01 | −5.599521E−03 | −2.131896E−01 | −2.372185E−01 |
| A10= | 1.524750E−01 | 1.089675E+00 | −1.598182E−01 | 1.317012E+00 | 1.305920E+00 |
| A12= | −1.817460E−01 | −2.239944E+00 | 4.725309E−01 | −2.765443E+00 | −2.642568E+00 |
| A14= | 1.241926E−01 | 2.797266E+00 | −6.742615E−01 | 3.421438E+00 | 3.227129E+00 |
| A16= | −3.566619E−02 | −1.897600E+00 | 4.002481E−01 | −2.583068E+00 | −2.405581E+00 |
| A18= | — | 5.474891E−01 | −6.025902E−02 | 1.079645E+00 | 9.817106E−01 |
| A20= | — | — | — | −1.909817E−01 | −1.645598E−01 |

| Surface # | 19 | 20 | 21 | — | — |
|---|---|---|---|---|---|
| k= | −9.900000E+01 | 1.060920E+01 | 2.216670E+01 | — | — |
| A4= | −4.840773E−02 | −1.725933E−02 | 1.306396E−02 | — | — |
| A6= | 2.506245E−02 | −8.756594E−03 | −4.260592E−02 | — | — |
| A8= | −1.518435E−02 | 1.563845E−02 | 3.625762E−02 | — | — |
| A10= | 2.206674E−02 | −1.251549E−02 | −1.905941E−02 | — | — |
| A12= | −1.933598E−02 | 5.948008E−03 | 6.574568E−03 | — | — |
| A14= | 1.130959E−02 | −1.737856E−03 | −1.526669E−03 | — | — |
| A16= | −4.538364E−03 | 3.178970E−04 | 2.379826E−04 | — | — |
| A18= | 1.072909E−03 | −3.575899E−05 | −2.393408E−05 | — | — |
| A20= | −1.081603E−04 | 2.274674E−06 | 1.403257E−06 | — | — |
| A22= | — | −6.293948E−08 | −3.644551E−08 | — | — |

In the 4th embodiment, the equation of the aspheric surface profiles of the aforementioned lens elements is the same as the equation of the 1st embodiment. Also, the definitions of these parameters shown in Table 4C below are the same as those stated in the 1st embodiment with corresponding values for the 4th embodiment, so an explanation in this regard will not be provided again.

Moreover, these parameters can be calculated from Table 4A and Table 4B as the following values and satisfy the following conditions:

TABLE 4C
Values of Conditional Expressions

| | | | |
|---|---|---|---|
| f [mm] | 1.43 | (T12 + T23)/ΣAT | 0.76 |
| Fno | 2.10 | T23/(CT1 + CT2) | 1.86 |
| HFOV [deg.] | 98.0 | 10 × T34/CT3 | 0.21 |
| FOV [deg.] | 196.0 | (T34 + T45 + T78)/T23 | 0.16 |
| TL/f | 12.24 | T56/T12 | 0.20 |
| TL/ImgH | 5.83 | N4 | 1.544 |
| ImgH/BL | 2.71 | V3 + V6 + V8 | 65.5 |
| SD/BL | 2.95 | V1/N1 | 25.83 |
| \|f/f3\| | 0.07 | V2/N2 | 25.83 |
| \|f8/f4\| | 0.25 | V3/N3 | 12.29 |
| (\|f/f3\| + \|f/f9\|)/\|f/f7\| | 0.15 | V4/N4 | 36.27 |
| (\|f/f4\| + \|f/f9\|)/\|f/f8\| | 0.30 | V5/N5 | 38.51 |
| \|f/R8\| + \|f/R12\| | 0.98 | V6/N6 | 11.68 |
| (R3 + R4)/(R3 − R4) | 1.91 | V7/N7 | 36.27 |
| (R5 + R8)/(R5 − R8) | 1.08 | V8/N8 | 15.86 |
| \|R8/R7\| | 0.50 | V9/N9 | 36.27 |
| \|R12/R11\| | 0.27 | Sag3R1/CT2 | −1.26 |
| CT4/CT5 | 1.32 | ImgH/Y9R2 | 1.16 |
| CT6/CT5 | 0.20 | — | — |

### 5th Embodiment

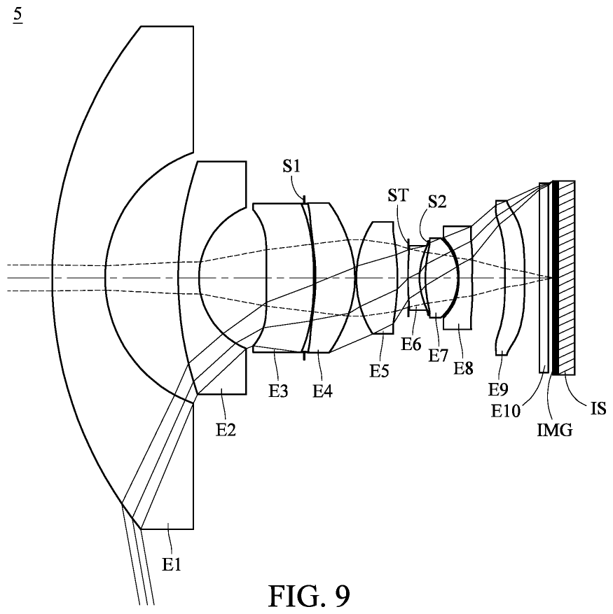

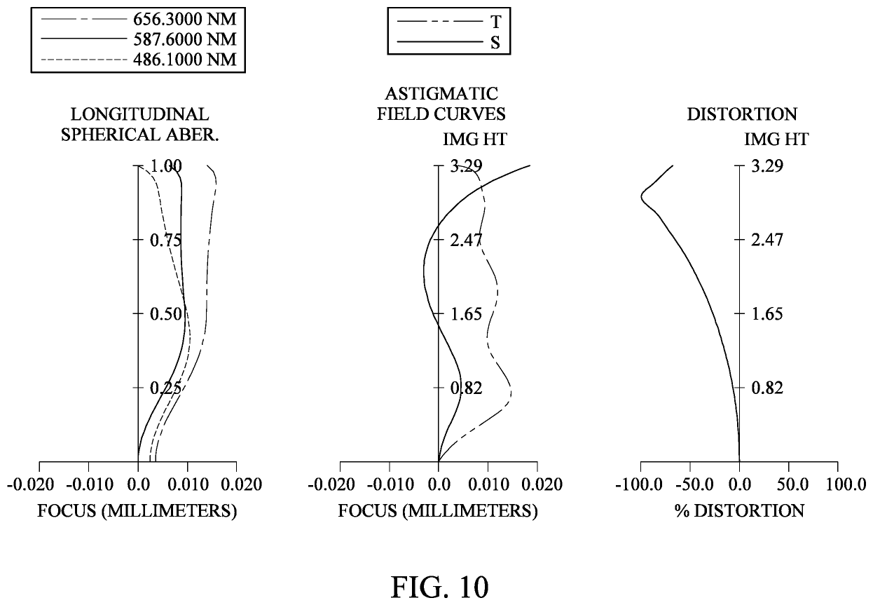

FIG. 9 is a schematic view of an image capturing unit 5 according to the 5th embodiment of the present disclosure. FIG. 10 shows, in order from left to right, spherical aberration curves, astigmatic field curves and a distortion curve of the image capturing unit according to the 5th embodiment. In FIG. 9, the image capturing unit 5 includes the optical imaging lens assembly (its reference numeral is omitted) of the present disclosure and an image sensor IS. The optical imaging lens assembly includes, in order from an object side to an image side along an optical axis, a first lens element E1, a second lens element E2, a third lens element E3, a stop S1, a fourth lens element E4, a fifth lens element E5, an aperture stop ST, a sixth lens element E6, a stop S2, a seventh lens element E7, an eighth lens element E8, a ninth lens element E9, a filter E10 and an image surface IMG. The optical imaging lens assembly includes nine lens elements (E1, E2, E3, E4, E5, E6, E7, E8 and E9) with no additional lens element disposed between each of the adjacent nine lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of glass material and has the object-side surface and the image-side surface being both spherical.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has one inflection point. The object-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points.

The fifth lens element E5 with positive refractive power has an object-side surface being convex in a paraxial region thereof and an image-side surface being convex in a paraxial region thereof. The fifth lens element E5 is made of glass material and has the object-side surface and the image-side surface being both aspheric.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has one inflection point.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The object-side surface of the eighth lens element E8 has one inflection point. The image-side surface of the eighth lens element E8 has three inflection points. The image-side surface of the eighth lens element E8 has two critical points in an off-axis region thereof.

The ninth lens element E9 with negative refractive power has an object-side surface being concave in a paraxial region thereof and an image-side surface being convex in a paraxial region thereof. The ninth lens element E9 is made of plastic material and has the object-side surface and the image-side surface being both aspheric. The object-side surface of the ninth lens element E9 has one inflection point. The image-side surface of the ninth lens element E9 has two inflection points. The object-side surface of the ninth lens element E9 has one critical point in an off-axis region thereof.

The filter E10 is made of glass material and located between the ninth lens element E9 and the image surface IMG, and will not affect the focal length of the optical imaging lens assembly. The image sensor IS is disposed on or near the image surface IMG of the optical imaging lens assembly.

The detailed optical data of the 5th embodiment are shown in Table 5A and the aspheric surface data are shown in Table 5B below.

TABLE 5A
5th Embodiment
f = 1.79 mm, Fno = 2.04, HFOV = 100.0 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 13.6067 | (SPH) | 1.800 | Glass | 1.835 | 42.7 | −8.94 |
| 2 | | 4.5307 | (SPH) | 2.480 | | | | |
| 3 | Lens 2 | 12.1718 | (SPH) | 0.700 | Glass | 1.755 | 52.3 | −4.50 |
| 4 | | 2.5921 | (SPH) | 2.297 | | | | |
| 5 | Lens 3 | 35.3145 | (ASP) | 1.610 | Plastic | 1.639 | 23.5 | 15.23 |
| 6 | | −13.1882 | (ASP) | −0.329 | | | | |
| 7 | Stop | Plano | | 0.386 | | | | |
| 8 | Lens 4 | −7.3900 | (ASP) | 1.334 | Plastic | 1.544 | 56.0 | 10.44 |
| 9 | | −3.4165 | (ASP) | 0.050 | | | | |
| 10 | Lens 5 | 3.6106 | (ASP) | 1.399 | Glass | 1.589 | 61.2 | 4.10 |
| 11 | | −6.2669 | (ASP) | 0.366 | | | | |
| 12 | Ape. Stop | Plano | | −0.011 | | | | |
| 13 | Lens 6 | 9.5257 | (ASP) | 0.390 | Plastic | 1.639 | 23.5 | −4.01 |
| 14 | | 1.9845 | (ASP) | 0.298 | | | | |
| 15 | Stop | Plano | | −0.100 | | | | |
| 16 | Lens 7 | 3.9083 | (ASP) | 1.107 | Plastic | 1.544 | 56.0 | 2.63 |
| 17 | | −2.0346 | (ASP) | 0.030 | | | | |
| 18 | Lens 8 | −3.2658 | (ASP) | 0.455 | Plastic | 1.639 | 23.5 | −4.02 |
| 19 | | 12.7226 | (ASP) | 1.114 | | | | |
| 20 | Lens 9 | −33.7574 | (ASP) | 0.668 | Plastic | 1.544 | 56.0 | −1298.03 |
| 21 | | −35.6993 | (ASP) | 0.500 | | | | |

| | | | | | | | |
|---|---|---|---|---|---|---|---|
| 22 | Filter | Plano | 0.300 | Glass | 1.517 | 64.2 | — |
| 23 | | Plano | 0.155 | | | | |
| 24 | Image | Plano | — | | | | |

Note:
Reference wavelength is 587.6 nm (d-line).
An effective radius of the stop S1 (Surface 7) is 2.520 mm.
An effective radius of the stop S2 (Surface 15) is 1.138 mm.

TABLE 5B
Aspheric Coefficients

| Surface # | 5 | 6 | 8 | 9 | 10 |
|---|---|---|---|---|---|
| k= | 0.000000E+00 | 1.994720E+01 | −1.218360E+00 | −1.711070E+00 | −1.456920E+00 |
| A4= | −1.504298E−02 | −1.823414E−02 | −1.007643E−02 | 3.667630E−03 | 6.254783E−03 |
| A6= | 3.349116E−05 | 1.318785E−02 | 1.666939E−02 | −2.648981E−03 | −2.433642E−03 |
| A8= | −1.068585E−03 | −7.180720E−03 | −9.681155E−03 | 1.459620E−03 | 1.394889E−03 |
| A10= | 5.884410E−04 | 2.803195E−03 | 3.900740E−03 | −5.873552E−04 | −3.632658E−04 |
| A12= | −2.218476E−04 | −7.249549E−04 | −1.040277E−03 | 1.709379E−04 | 5.864309E−05 |
| A14= | 5.810200E−05 | 1.159471E−04 | 1.715018E−04 | −3.453751E−05 | −5.084020E−06 |
| A16= | −9.418535E−06 | −1.068569E−05 | −1.655606E−05 | 4.393372E−06 | — |
| A18= | 8.633784E−07 | 5.011084E−07 | 8.433500E−07 | −3.116276E−07 | — |
| A20= | −3.504364E−08 | −8.588978E−09 | −1.700447E−08 | 9.386430E−09 | — |
| Surface # | 11 | 13 | 14 | 16 | 17 |
| k= | 9.206140E−01 | 3.598820E+01 | −1.886990E−02 | −8.904700E+00 | −9.678460E−01 |
| A4= | 1.508465E−02 | −3.258810E−02 | −8.057324E−02 | 1.652232E−03 | −1.387406E−01 |
| A6= | −4.843202E−03 | 3.589549E−02 | 7.151896E−02 | 1.241127E−02 | 5.773839E−01 |
| A8= | 2.014713E−03 | −5.000645E−02 | −1.140137E−01 | −2.703132E−02 | −1.358695E+00 |
| A10= | −5.531205E−04 | 5.717884E−02 | 1.872128E−01 | 2.979992E−02 | 1.966178E+00 |
| A12= | 7.209932E−05 | −4.633566E−02 | −2.404681E−01 | −2.657771E−02 | −1.923832E+00 |
| A14= | −3.867109E−06 | 2.110614E−02 | 1.977728E−01 | 1.332501E−02 | 1.256485E+00 |
| A16= | — | −4.053281E−03 | −8.960261E−02 | −4.152625E−03 | −5.170612E−01 |
| A18= | — | — | 1.691046E−02 | 9.941773E−04 | 1.196713E−01 |
| A20= | — | — | — | — | −1.170744E−02 |

| Surface # | 18 | 19 | 20 | 21 | — |
|---|---|---|---|---|---|
| k= | 0.000000E+00 | −3.002250E+01 | 0.000000E+00 | 0.000000E+00 | — |
| A4= | −2.353983E−01 | −1.034013E−01 | −3.412712E−02 | −2.891225E−02 | — |
| A6= | 6.350906E−01 | 1.148446E−01 | 2.008672E−02 | 1.006024E−02 | — |
| A8= | −1.378353E+00 | −1.176782E−01 | −1.110122E−02 | −6.662717E−04 | — |
| A10= | 1.976647E+00 | 9.437944E−02 | 4.113056E−03 | −2.092345E−03 | — |
| A12= | −1.957702E+00 | −5.312666E−02 | −8.914070E−04 | 1.355975E−03 | — |
| A14= | 1.311327E+00 | 2.061989E−02 | 3.704091E−05 | −4.548671E−04 | — |
| A16= | −5.569041E−01 | −5.207330E−03 | 3.525970E−05 | 9.343796E−05 | — |
| A18= | 1.340382E−01 | 7.561260E−04 | −9.235262E−06 | −1.179264E−05 | — |
| A20= | −1.386313E−02 | −4.732487E−05 | 9.493824E−07 | 8.444732E−07 | — |
| A22= | — | — | −3.657088E−08 | −2.631430E−08 | — |

In the 5th embodiment, the equation of the aspheric surface profiles of the aforementioned lens elements is the same as the equation of the 1st embodiment. Also, the definitions of these parameters shown in Table 5C below are the same as those stated in the 1st embodiment with corresponding values for the 5th embodiment, so an explanation in this regard will not be provided again.

Moreover, these parameters can be calculated from Table 5A and Table 5B as the following values and satisfy the following conditions:

TABLE 5C
Values of Conditional Expressions

| | | | |
|---|---|---|---|
| f [mm] | 1.79 | (T12 + T23)/ΣAT | 0.73 |
| Fno | 2.04 | T23/(CT1 + CT2) | 0.92 |
| HFOV [deg.] | 100.0 | 10 × T34/CT3 | 0.35 |
| FOV [deg.] | 200.0 | (T34 + T45 + T78)/T23 | 0.06 |
| TL/f | 9.47 | T56/T12 | 0.14 |
| TL/ImgH | 5.16 | N4 | 1.544 |
| ImgH/BL | 3.45 | V3 + V6 + V8 | 70.5 |
| SD/BL | 4.14 | V1/N1 | 23.27 |
| \|f/f3\| | 0.12 | V2/N2 | 29.80 |
| \|f8/f4\| | 0.39 | V3/N3 | 14.34 |
| (\|f/f3\| + \|f/f9\|)/\|f/f7\| | 0.17 | V4/N4 | 36.27 |
| (\|f/f4\| + \|f/f9\|)/\|f/f8\| | 0.39 | V5/N5 | 38.51 |
| \|f/R8\| + \|f/R12\| | 1.43 | V6/N6 | 14.34 |
| (R3 + R4)/(R3 − R4) | 1.54 | V7/N7 | 36.27 |
| (R5 + R8)/(R5 − R8) | 0.82 | V8/N8 | 14.34 |
| \|R8/R7\| | 0.46 | V9/N9 | 36.27 |
| \|R12/R11\| | 0.21 | Sag3R1/CT2 | −0.64 |
| CT4/CT5 | 0.95 | ImgH/Y9R2 | 1.26 |
| CT6/CT5 | 0.28 | — | — |

### 6th Embodiment

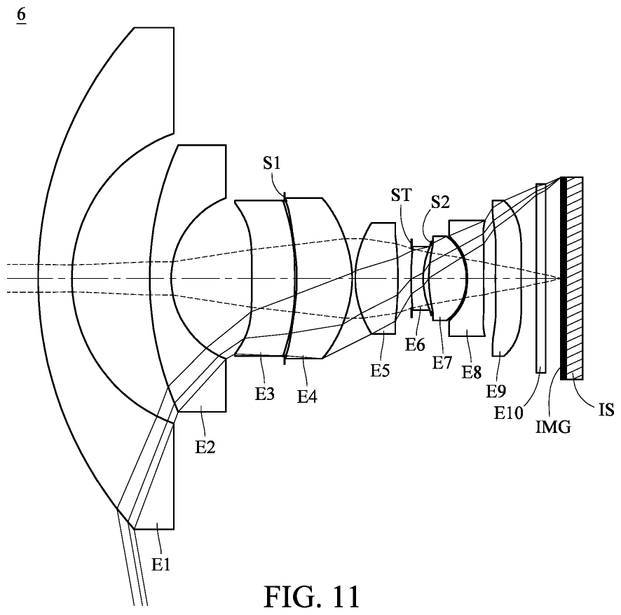

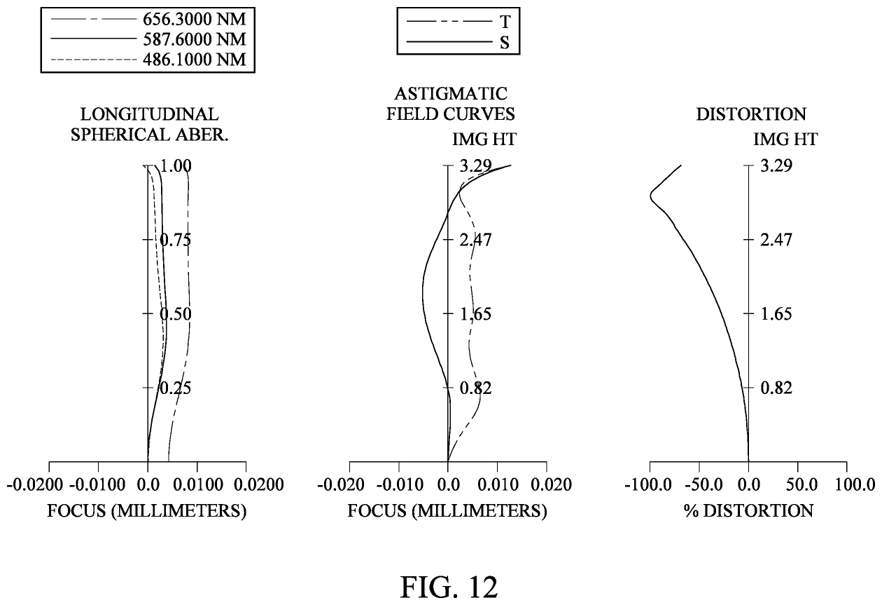

FIG. 11 is a schematic view of an image capturing unit 6 according to the 6th embodiment of the present disclosure. FIG. 12 shows, in order from left to right, spherical aberration curves, astigmatic field curves and a distortion curve of the image capturing unit according to the 6th embodiment. In FIG. 11, the image capturing unit 6 includes the optical imaging lens assembly (its reference numeral is omitted) of the present disclosure and an image sensor IS. The optical imaging lens assembly includes, in order from an object side to an image side along an optical axis, a first lens element E1, a second lens element E2, a third lens element E3, a stop S1, a fourth lens element E4, a fifth lens element E5, an aperture stop ST, a sixth lens element E6, a stop S2, a seventh lens element E7, an eighth lens element E8, a ninth lens element E9, a filter E10 and an image surface IMG. The optical imaging lens assembly includes nine lens elements (E1, E2, E3, E4, E5, E6, E7, E8 and E9) with no additional lens element disposed between each of the adjacent nine lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of glass material and has the object-side surface and the image-side surface being both spherical.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The object-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric.

The fifth lens element E5 with positive refractive power has an object-side surface being convex in a paraxial region thereof and an image-side surface being convex in a paraxial region thereof. The fifth lens element E5 is made of glass material and has the object-side surface and the image-side surface being both aspheric.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The object-side surface of the seventh lens element E7 has one inflection point.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The object-side surface of the eighth lens element E8 has one inflection point. The image-side surface of the eighth lens element E8 has two inflection points. The image-side surface of the eighth lens element E8 has two critical points in an off-axis region thereof.

The ninth lens element E9 with positive refractive power has an object-side surface being convex in a paraxial region thereof and an image-side surface being concave in a paraxial region thereof. The ninth lens element E9 is made of plastic material and has the object-side surface and the image-side surface being both aspheric. The object-side surface of the ninth lens element E9 has two inflection points. The image-side surface of the ninth lens element E9 has one inflection point. The object-side surface of the ninth lens element E9 has two critical points in an off-axis region thereof. The image-side surface of the ninth lens element E9 has one critical point in an off-axis region thereof.

The filter E10 is made of glass material and located between the ninth lens element E9 and the image surface IMG, and will not affect the focal length of the optical imaging lens assembly. The image sensor IS is disposed on or near the image surface IMG of the optical imaging lens assembly.

The detailed optical data of the 6th embodiment are shown in Table 6A and the aspheric surface data are shown in Table 6B below.

TABLE 6A
6th Embodiment
f = 1.85 mm, Fno = 2.04, HFOV = 100.0 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 12.2178 | (SPH) | 1.100 | Glass | 1.835 | 42.7 | −10.97 |
| 2 | | 5.0195 | (SPH) | 2.528 | | | | |
| 3 | Lens 2 | 10.5653 | (SPH) | 0.700 | Glass | 1.755 | 52.3 | −5.30 |
| 4 | | 2.8191 | (SPH) | 2.622 | | | | |
| 5 | Lens 3 | 90.1235 | (ASP) | 1.399 | Plastic | 1.639 | 23.5 | 21.61 |
| 6 | | −16.1978 | (ASP) | −0.335 | | | | |
| 7 | Stop | Plano | | 0.401 | | | | |
| 8 | Lens 4 | −6.5185 | (ASP) | 1.799 | Plastic | 1.544 | 56.0 | 10.75 |
| 9 | | −3.3826 | (ASP) | 0.101 | | | | |
| 10 | Lens 5 | 3.2733 | (ASP) | 1.392 | Glass | 1.589 | 61.2 | 4.39 |
| 11 | | −10.3770 | (ASP) | 0.445 | | | | |
| 12 | Ape. Stop | Plano | | −0.016 | | | | |
| 13 | Lens 6 | 10.0500 | (ASP) | 0.390 | Plastic | 1.639 | 23.5 | −4.87 |
| 14 | | 2.3384 | (ASP) | 0.265 | | | | |
| 15 | Stop | Plano | | −0.080 | | | | |
| 16 | Lens 7 | 4.0050 | (ASP) | 1.222 | Plastic | 1.544 | 56.0 | 2.59 |
| 17 | | −1.9405 | (ASP) | 0.030 | | | | |
| 18 | Lens 8 | −2.5460 | (ASP) | 0.528 | Plastic | 1.639 | 23.5 | −3.22 |
| 19 | | 11.6388 | (ASP) | 0.384 | | | | |
| 20 | Lens 9 | 16.0456 | (ASP) | 0.833 | Plastic | 1.544 | 56.0 | 185.52 |
| 21 | | 18.7297 | (ASP) | 0.500 | | | | |

| | | | | | | | |
|---|---|---|---|---|---|---|---|
| 22 | Filter | Plano | 0.300 | Glass | 1.517 | 64.2 | — |
| 23 | | Plano | 0.491 | | | | |
| 24 | Image | Plano | — | | | | |

Note:
Reference wavelength is 587.6 nm (d-line).
An effective radius of the stop S1 (Surface 7) is 2.521 mm.
An effective radius of the stop S2 (Surface 15) is 1.090 mm.

TABLE 6B
Aspheric Coefficients

| Surface # | 5 | 6 | 8 | 9 | 10 |
|---|---|---|---|---|---|
| k= | 0.000000E+00 | 2.832540E+01 | 3.844220E−01 | −1.626890E+00 | −1.663580E+00 |
| A4= | −1.689576E−02 | −1.527378E−02 | −4.024051E−04 | 4.799436E−03 | 6.165698E−03 |
| A6= | −1.613569E−04 | 6.735823E−03 | 6.990979E−03 | −2.190769E−03 | −1.375319E−03 |
| A8= | −4.010642E−04 | −1.778686E−03 | −2.309627E−03 | 8.596343E−04 | 8.640098E−04 |
| A10= | 1.914047E−04 | 1.912986E−05 | 1.444864E−04 | −2.990906E−04 | −2.752965E−04 |
| A12= | −4.834933E−05 | 1.312446E−04 | 1.028951E−04 | 6.802420E−05 | 4.262961E−05 |
| A14= | 1.170479E−05 | −3.875661E−05 | −3.431513E−05 | −1.018478E−05 | −2.435752E−06 |
| A16= | −1.962940E−06 | 5.293885E−06 | 4.809864E−06 | 9.747099E−07 | — |
| A18= | 1.725503E−07 | −3.579125E−07 | −3.207321E−07 | −5.389115E−08 | — |
| A20= | −6.048723E−09 | 9.484196E−09 | 8.012061E−09 | 1.296725E−09 | — |
| Surface # | 11 | 13 | 14 | 16 | 17 |
| k= | 1.515480E+01 | 4.396290E+01 | 9.393850E−01 | −9.845900E+00 | −8.695210E−01 |
| A4= | 1.806203E−04 | −1.768672E−02 | −4.621348E−02 | 2.672311E−03 | −3.311685E−03 |
| A6= | 4.255058E−03 | 2.838886E−02 | 4.393834E−02 | 9.464632E−03 | −5.083875E−02 |
| A8= | −2.130593E−03 | −4.513272E−02 | −8.718079E−02 | −2.246120E−02 | 3.030576E−02 |
| A10= | 5.821558E−04 | 5.083028E−02 | 1.527016E−01 | 2.266144E−02 | 1.274499E−02 |
| A12= | −8.238097E−05 | −4.009163E−02 | −2.118064E−01 | −1.552042E−02 | −6.684731E−02 |
| A14= | 4.939727E−06 | 1.790456E−02 | 1.885961E−01 | −1.638894E−04 | 8.591841E−02 |
| A16= | — | −3.377854E−03 | −9.277883E−02 | 5.383095E−03 | −5.546332E−02 |
| A18= | — | — | 1.886852E−02 | −2.140864E−03 | 1.793526E−02 |
| A20= | — | — | — | — | −2.309297E−03 |

| Surface # | 18 | 19 | 20 | 21 | — |
|---|---|---|---|---|---|
| k= | 0.000000E+00 | 6.525260E+00 | 0.000000E+00 | 0.000000E+00 | — |
| A4= | −5.754632E−02 | −5.108836E−02 | −2.295607E−02 | −2.405050E−02 | — |
| A6= | −2.270418E−02 | 2.285110E−02 | 1.515179E−02 | 6.705354E−03 | — |
| A8= | 4.868604E−03 | −1.484125E−02 | −1.797265E−02 | −2.489437E−03 | — |
| A10= | 4.628863E−02 | 1.114102E−02 | 1.343890E−02 | 4.250706E−04 | — |
| A12= | −9.639529E−02 | −5.651711E−03 | −7.051897E−03 | 8.233941E−07 | — |
| A14= | 1.076930E−01 | 2.114000E−03 | 2.563116E−03 | −2.038182E−05 | — |
| A16= | −6.645529E−02 | −5.449378E−04 | −6.034859E−04 | 5.425331E−06 | — |
| A18= | 2.111790E−02 | 8.004998E−05 | 8.665283E−05 | −6.805243E−07 | — |
| A20= | −2.691141E−03 | −4.888800E−06 | −6.886286E−06 | 3.911645E−08 | — |
| A22= | — | — | 2.324678E−07 | −6.825497E−10 | — |

In the 6th embodiment, the equation of the aspheric surface profiles of the aforementioned lens elements is the same as the equation of the 1st embodiment. Also, the definitions of these parameters shown in Table 6C below are the same as those stated in the 1st embodiment with corresponding values for the 6th embodiment, so an explanation in this regard will not be provided again.

Moreover, these parameters can be calculated from Table 6A and Table 6B as the following values and satisfy the following conditions:

TABLE 6C
Values of Conditional Expressions

| | | | |
|---|---|---|---|
| f [mm] | 1.85 | (T12 + T23)/ΣAT | 0.81 |
| Fno | 2.04 | T23/(CT1 + CT2) | 1.46 |
| HFOV [deg.] | 100.0 | 10 × T34/CT3 | 0.47 |
| FOV [deg.] | 200.0 | (T34 + T45 + T78)/T23 | 0.08 |
| TL/f | 9.19 | T56/T12 | 0.17 |
| TL/ImgH | 5.16 | N4 | 1.544 |
| ImgH/BL | 2.55 | V3 + V6 + V8 | 70.5 |
| SD/BL | 2.75 | V1/N1 | 23.27 |
| \|f/f3\| | 0.09 | V2/N2 | 29.80 |
| \|f8/f4\| | 0.30 | V3/N3 | 14.34 |
| (\|f/f3\| + \|f/f9\|)/\|f/f7\| | 0.13 | V4/N4 | 36.27 |
| (\|f/f4\| + \|f/f9\|)/\|f/f8\| | 0.32 | V5/N5 | 38.51 |
| \|f/R8\| + \|f/R12\| | 1.34 | V6/N6 | 14.34 |
| (R3 + R4)/(R3 − R4) | 1.73 | V7/N7 | 36.27 |
| (R5 + R8)/(R5 − R8) | 0.93 | V8/N8 | 14.34 |
| \|R8/R7\| | 0.52 | V9/N9 | 36.27 |
| \|R12/R11\| | 0.23 | Sag3R1/CT2 | −0.78 |
| CT4/CT5 | 1.29 | ImgH/Y9R2 | 1.30 |
| CT6/CT5 | 0.28 | — | — |

### 7th Embodiment

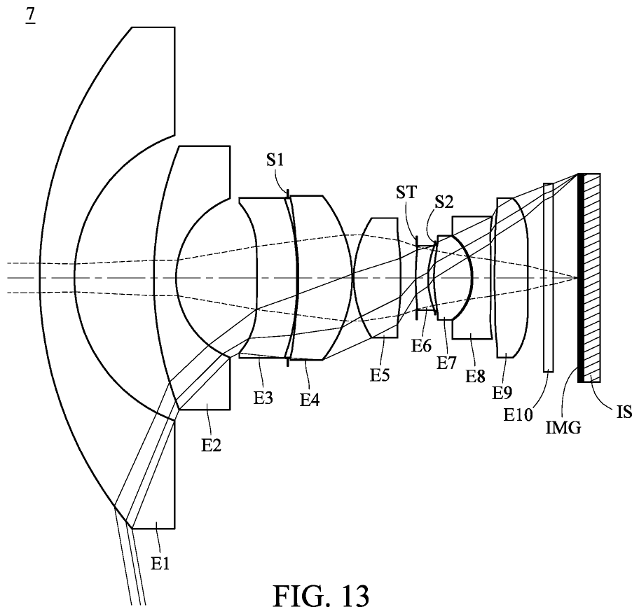

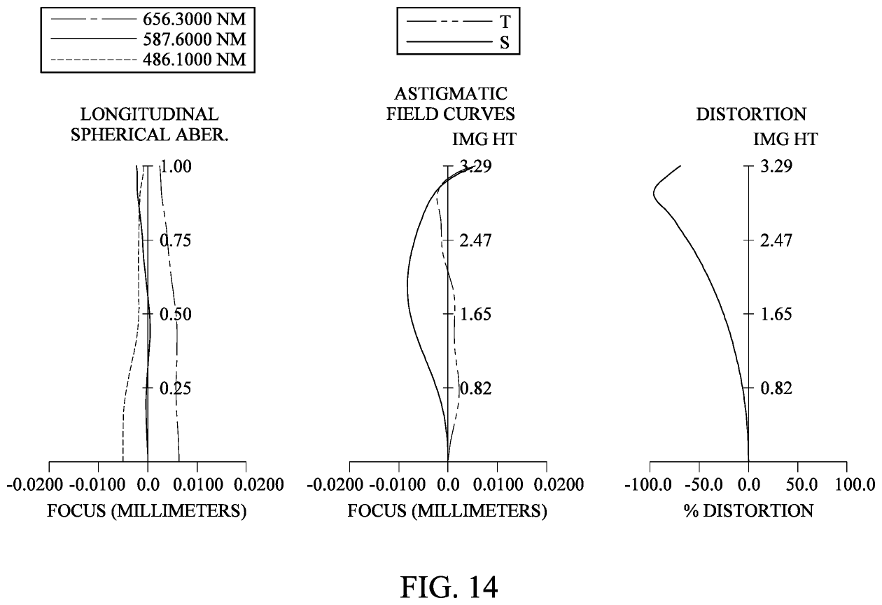

FIG. 13 is a schematic view of an image capturing unit 7 according to the 7th embodiment of the present disclosure. FIG. 14 shows, in order from left to right, spherical aberration curves, astigmatic field curves and a distortion curve of the image capturing unit according to the 7th embodiment. In FIG. 13, the image capturing unit 7 includes the optical imaging lens assembly (its reference numeral is omitted) of the present disclosure and an image sensor IS. The optical imaging lens assembly includes, in order from an object side to an image side along an optical axis, a first lens element E1, a second lens element E2, a third lens element E3, a stop S1, a fourth lens element E4, a fifth lens element E5, an aperture stop ST, a sixth lens element E6, a stop S2, a seventh lens element E7, an eighth lens element E8, a ninth lens element E9, a filter E10 and an image surface IMG. The optical imaging lens assembly includes nine lens elements (E1, E2, E3, E4, E5, E6, E7, E8 and E9) with no additional lens element disposed between each of the adjacent nine lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both spherical.

The second lens element E2 with negative refractive power has an object-side surface being convex in a paraxial region thereof and an image-side surface being concave in a paraxial region thereof. The second lens element E2 is made of glass material and has the object-side surface and the image-side surface being both spherical.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The object-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has two inflection points.

The fifth lens element E5 with positive refractive power has an object-side surface being convex in a paraxial region thereof and an image-side surface being convex in a paraxial region thereof. The fifth lens element E5 is made of glass material and has the object-side surface and the image-side surface being both aspheric.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The object-side surface of the seventh lens element E7 has one inflection point. The image-side surface of the seventh lens element E7 has one inflection point.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The image-side surface of the eighth lens element E8 has two inflection points. The image-side surface of the eighth lens element E8 has two critical points in an off-axis region thereof. The object-side surface of the eighth lens element E8 and the image-side surface of the seventh lens element E7 are cemented to each other.

The ninth lens element E9 with positive refractive power has an object-side surface being convex in a paraxial region thereof and an image-side surface being concave in a paraxial region thereof. The ninth lens element E9 is made of plastic material and has the object-side surface and the image-side surface being both aspheric. The object-side surface of the ninth lens element E9 has three inflection points. The image-side surface of the ninth lens element E9 has one inflection point. The object-side surface of the ninth lens element E9 has two critical points in an off-axis region thereof. The image-side surface of the ninth lens element E9 has one critical point in an off-axis region thereof.

The filter E10 is made of glass material and located between the ninth lens element E9 and the image surface IMG, and will not affect the focal length of the optical imaging lens assembly. The image sensor IS is disposed on or near the image surface IMG of the optical imaging lens assembly.

The detailed optical data of the 7th embodiment are shown in Table 7A and the aspheric surface data are shown in Table 7B below.

TABLE 7A
7th Embodiment
f = 1.89 mm, Fno = 2.04, HFOV = 100.0 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 12.1865 | (SPH) | 1.100 | Glass | 1.835 | 42.7 | −10.15 |
| 2 | | 4.7918 | (SPH) | 2.505 | | | | |
| 3 | Lens 2 | 11.1402 | (SPH) | 0.700 | Glass | 1.755 | 52.3 | −4.91 |
| 4 | | 2.7058 | (SPH) | 2.556 | | | | |
| 5 | Lens 3 | 173.4617 | (ASP) | 1.264 | Plastic | 1.642 | 22.5 | 22.77 |
| 6 | | −15.9067 | (ASP) | −0.290 | | | | |
| 7 | Stop | Plano | | 0.340 | | | | |
| 8 | Lens 4 | −7.3446 | (ASP) | 1.693 | Plastic | 1.544 | 56.0 | 10.99 |
| 9 | | −3.5636 | (ASP) | 0.050 | | | | |
| 10 | Lens 5 | 3.3039 | (ASP) | 1.483 | Glass | 1.589 | 61.2 | 4.35 |
| 11 | | −9.5415 | (ASP) | 0.500 | | | | |
| 12 | Ape. Stop | Plano | | −0.027 | | | | |
| 13 | Lens 6 | 10.1060 | (ASP) | 0.390 | Plastic | 1.639 | 23.5 | −5.52 |
| 14 | | 2.5751 | (ASP) | 0.225 | | | | |
| 15 | Stop | Plano | | −0.037 | | | | |
| 16 | Lens 7 | 4.6288 | (ASP) | 1.183 | Plastic | 1.544 | 56.0 | 3.04 |
| 17 | | −2.3365 | (ASP) | 0.030 | Cement | 1.485 | 53.2 | — |
| 18 | Lens 8 | −2.4002 | (ASP) | 0.570 | Plastic | 1.639 | 23.5 | −3.34 |
| 19 | | 21.2084 | (ASP) | 0.117 | | | | |
| 20 | Lens 9 | 7.4721 | (ASP) | 1.056 | Plastic | 1.544 | 56.0 | 17.04 |
| 21 | | 36.6323 | (ASP) | 0.500 | | | | |

| | | | | | | | |
|---|---|---|---|---|---|---|---|
| 22 | Filter | Plano | 0.300 | Glass | 1.517 | 64.2 | — |
| 23 | | Plano | 0.792 | | | | |
| 24 | Image | Plano | — | | | | |

Note:
Reference wavelength is 587.6 nm (d-line).
An effective radius of the stop S1 (Surface 7) is 2.523 mm.
An effective radius of the stop S2 (Surface 15) is 1.045 mm.

TABLE 7B
Aspheric Coefficients

| Surface # | 5 | 6 | 8 | 9 | 10 |
|---|---|---|---|---|---|
| k= | 4.638090E+01 | 2.858190E+01 | −8.961090E−01 | −1.458730E+00 | −1.946360E+00 |
| A4= | −1.816767E−02 | −1.389585E−02 | 2.684249E−03 | 2.909396E−03 | 4.849331E−03 |
| A6= | −4.490785E−04 | 5.200515E−03 | 5.107482E−03 | −1.703254E−03 | −1.179321E−03 |
| A8= | −4.520291E−04 | −1.153495E−03 | −1.635964E−03 | 7.337575E−04 | 7.713468E−04 |
| A10= | 2.595899E−04 | −6.745634E−05 | 4.728391E−05 | −2.569646E−04 | −2.171635E−04 |
| A12= | −6.017336E−05 | 1.109000E−04 | 7.664234E−05 | 5.740476E−05 | 3.318467E−05 |
| A14= | 9.863198E−06 | −2.903958E−05 | −2.074209E−05 | −8.294633E−06 | −2.236480E−06 |
| A16= | −1.090488E−06 | 3.844754E−06 | 2.592450E−06 | 7.543875E−07 | — |
| A18= | 6.141814E−08 | −2.694941E−07 | −1.656605E−07 | −3.932855E−08 | — |
| A20= | −1.107290E−09 | 7.995486E−09 | 4.408551E−09 | 9.026493E−10 | — |
| Surface # | 11 | 13 | 14 | 16 | 17 |
| k= | 1.444380E+01 | 5.774370E+01 | 1.549270E+00 | −1.264640E+01 | −3.527300E−03 |
| A4= | 1.319725E−03 | −1.028276E−02 | −4.125037E−02 | −8.098785E−03 | −4.543159E−01 |
| A6= | 2.883357E−03 | 2.269303E−02 | 6.232591E−02 | 2.002389E−02 | 1.825567E+00 |
| A8= | −1.274318E−03 | −3.373348E−02 | −1.732461E−01 | −4.972498E−02 | −4.601905E+00 |
| A10= | 3.427062E−04 | 3.392186E−02 | 3.984819E−01 | 9.848766E−02 | 7.226116E+00 |
| A12= | −5.025295E−05 | −2.608624E−02 | −6.122207E−01 | −1.309984E−01 | −7.203746E+00 |
| A14= | 3.272920E−06 | 1.181774E−02 | 5.638158E−01 | 1.028854E−01 | 4.552897E+00 |
| A16= | — | −2.447881E−03 | −2.805205E−01 | −4.184920E−02 | −1.765893E+00 |
| A18= | — | — | 5.768124E−02 | 6.637091E−03 | 3.812458E−01 |
| A20= | — | — | — | — | −3.466803E−02 |

| Surface # | 18 | 19 | 20 | 21 | — |
|---|---|---|---|---|---|
| k= | 5.327200E−01 | 5.931380E+01 | 7.068550E+00 | 9.900000E+01 | — |
| A4= | −2.472608E−01 | −4.500968E−02 | −4.571635E−02 | −8.984318E−03 | — |
| A6= | 6.646926E−01 | 2.457226E−02 | 1.142059E−02 | −4.555198E−03 | — |
| A8= | −1.438215E+00 | −1.112798E−02 | −1.634625E−03 | 3.372874E−03 | — |
| A10= | 1.940541E+00 | 6.149778E−03 | −1.431835E−03 | −1.821539E−03 | — |
| A12= | −1.527840E+00 | −1.637120E−03 | 2.497316E−03 | 6.502106E−04 | — |
| A14= | 6.273080E−01 | −7.620532E−05 | −1.461451E−03 | −1.450711E−04 | — |
| A16= | −6.820619E−02 | 1.233567E−04 | 4.388211E−04 | 1.880991E−05 | — |
| A18= | −3.756212E−02 | −2.203910E−05 | −7.365382E−05 | −1.138012E−06 | — |
| A20= | 1.028658E−02 | 1.234468E−06 | 6.622825E−06 | −2.902163E−09 | — |
| A22= | — | — | −2.501138E−07 | 2.560142E−09 | — |

In the 7th embodiment, the equation of the aspheric surface profiles of the aforementioned lens elements is the same as the equation of the 1st embodiment. Also, the definitions of these parameters shown in Table 7C below are the same as those stated in the 1st embodiment with corresponding values for the 7th embodiment, so an explanation in this regard will not be provided again.

Moreover, these parameters can be calculated from Table 7A and Table 7B as the following values and satisfy the following conditions:

TABLE 7C
Values of Conditional Expressions

| | | | |
|---|---|---|---|
| f [mm] | 1.89 | (T12 + T23)/ΣAT | 0.85 |
| Fno | 2.04 | T23/(CT1 + CT2) | 1.42 |
| HFOV [deg.] | 100.0 | 10 × T34/CT3 | 0.40 |
| FOV [deg.] | 200.0 | (T34 + T45 + T78)/T23 | 0.05 |
| TL/f | 9.00 | T56/T12 | 0.19 |
| TL/ImgH | 5.17 | N4 | 1.544 |
| ImgH/BL | 2.07 | V3 + V6 + V8 | 69.5 |
| SD/BL | 2.20 | V1/N1 | 23.27 |
| \|f/f3\| | 0.08 | V2/N2 | 29.80 |
| \|f8/f4\| | 0.30 | V3/N3 | 13.70 |
| (\|f/f3\| + \|f/f9\|)/\|f/f7\| | 0.31 | V4/N4 | 36.27 |
| (\|f/f4\| + \|f/f9\|)/\|f/f8\| | 0.50 | V5/N5 | 38.51 |
| \|f/R8\| + \|f/R12\| | 1.26 | V6/N6 | 14.34 |
| (R3 + R4)/(R3 − R4) | 1.64 | V7/N7 | 36.27 |
| (R5 + R8)/(R5 − R8) | 0.96 | V8/N8 | 14.34 |
| \|R8/R7\| | 0.49 | V9/N9 | 36.27 |
| \|R12/R11\| | 0.25 | Sag3R1/CT2 | −0.80 |
| CT4/CT5 | 1.14 | ImgH/Y9R2 | 1.31 |
| CT6/CT5 | 0.26 | — | — |

### 8th Embodiment

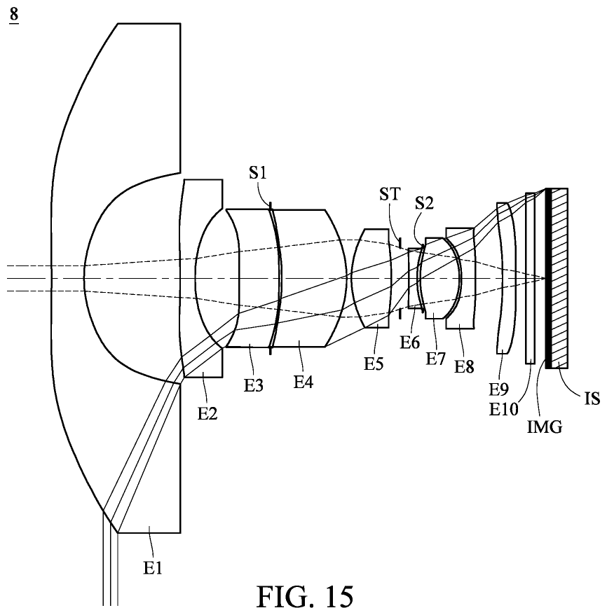

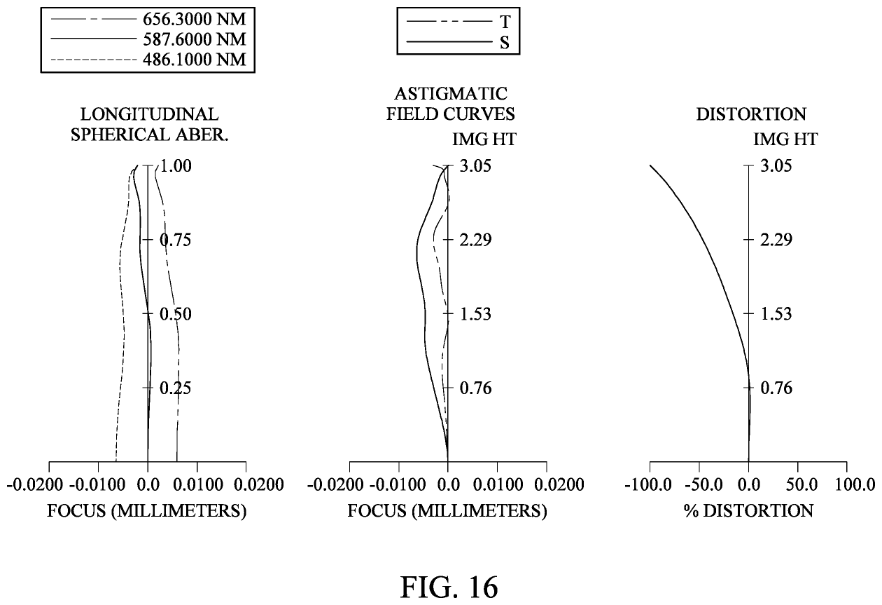

FIG. 15 is a schematic view of an image capturing unit 8 according to the 8th embodiment of the present disclosure. FIG. 16 shows, in order from left to right, spherical aberration curves, astigmatic field curves and a distortion curve of the image capturing unit according to the 8th embodiment. In FIG. 15, the image capturing unit 8 includes the optical imaging lens assembly (its reference numeral is omitted) of the present disclosure and an image sensor IS. The optical imaging lens assembly includes, in order from an object side to an image side along an optical axis, a first lens element E1, a second lens element E2, a third lens element E3, a stop S1, a fourth lens element E4, a fifth lens element E5, an aperture stop ST, a sixth lens element E6, a stop S2, a seventh lens element E7, an eighth lens element E8, a ninth lens element E9, a filter E10 and an image surface IMG. The optical imaging lens assembly includes nine lens elements (E1, E2, E3, E4, E5, E6, E7, E8 and E9) with no additional lens element disposed between each of the adjacent nine lens elements.

The first lens element E1 with negative refractive power has an object-side surface being concave in a paraxial region thereof and an image-side surface being concave in a paraxial region thereof. The first lens element E1 is made of plastic material and has the object-side surface and the image-side surface being both aspheric. The object-side surface of the first lens element E1 has one inflection point. The object-side surface of the first lens element E1 has one critical point in an off-axis region thereof.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric. The object-side surface of the second lens element E2 has two inflection points. The object-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The object-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric.

The fifth lens element E5 with positive refractive power has an object-side surface being convex in a paraxial region thereof and an image-side surface being convex in a paraxial region thereof. The fifth lens element E5 is made of plastic material and has the object-side surface and the image-side surface being both aspheric.

The sixth lens element E6 with negative refractive power has an object-side surface being concave in a paraxial region thereof and an image-side surface being concave in a paraxial region thereof. The sixth lens element E6 is made of plastic material and has the object-side surface and the image-side surface being both aspheric.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The object-side surface of the seventh lens element E7 has one inflection point.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The image-side surface of the eighth lens element E8 has two inflection points. The image-side surface of the eighth lens element E8 has two critical points in an off-axis region thereof.

The ninth lens element E9 with negative refractive power has an object-side surface being concave in a paraxial region thereof and an image-side surface being convex in a paraxial region thereof. The ninth lens element E9 is made of plastic material and has the object-side surface and the image-side surface being both aspheric. The object-side surface of the ninth lens element E9 has two inflection points. The image-side surface of the ninth lens element E9 has two inflection points. The image-side surface of the ninth lens element E9 has two critical points in an off-axis region thereof.

The filter E10 is made of glass material and located between the ninth lens element E9 and the image surface IMG, and will not affect the focal length of the optical imaging lens assembly. The image sensor IS is disposed on or near the image surface IMG of the optical imaging lens assembly.

The detailed optical data of the 8th embodiment are shown in Table 8A and the aspheric surface data are shown in Table 8B below.

TABLE 8A
8th Embodiment
f = 1.67 mm, Fno = 1.95, HFOV = 90.0 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | −66.6667 | (ASP) | 1.100 | Plastic | 1.566 | 37.4 | −6.27 |
| 2 | | 3.7686 | (ASP) | 3.258 | | | | |
| 3 | Lens 2 | −43.4783 | (ASP) | 0.509 | Plastic | 1.544 | 56.0 | −8.11 |
| 4 | | 4.9331 | (ASP) | 1.500 | | | | |
| 5 | Lens 3 | 74.8691 | (ASP) | 1.352 | Plastic | 1.680 | 18.2 | 18.65 |
| 6 | | −15.1533 | (ASP) | −0.295 | | | | |
| 7 | Stop | Plano | | 0.385 | | | | |
| 8 | Lens 4 | −6.2666 | (ASP) | 2.201 | Plastic | 1.544 | 56.0 | 10.96 |
| 9 | | −3.4328 | (ASP) | 0.164 | | | | |
| 10 | Lens 5 | 3.2041 | (ASP) | 1.351 | Plastic | 1.544 | 56.0 | 4.55 |
| 11 | | −9.2391 | (ASP) | 0.299 | | | | |
| 12 | Ape. Stop | Plano | | 0.294 | | | | |
| 13 | Lens 6 | −27.6072 | (ASP) | 0.280 | Plastic | 1.639 | 23.5 | −4.16 |
| 14 | | 2.9494 | (ASP) | 0.191 | | | | |
| 15 | Stop | Plano | | −0.080 | | | | |
| 16 | Lens 7 | 3.3970 | (ASP) | 1.323 | Plastic | 1.544 | 56.0 | 2.82 |
| 17 | | −2.4153 | (ASP) | 0.070 | | | | |
| 18 | Lens 8 | −3.7479 | (ASP) | 0.477 | Plastic | 1.660 | 20.4 | −5.36 |
| 19 | | 67.0709 | (ASP) | 0.916 | | | | |
| 20 | Lens 9 | −36.9068 | (ASP) | 0.450 | Plastic | 1.697 | 16.3 | −62.38 |
| 21 | | −244.9322 | (ASP) | 0.350 | | | | |

| | | | | | | | |
|---|---|---|---|---|---|---|---|
| 22 | Filter | Plano | 0.300 | Glass | 1.517 | 64.2 | — |
| 23 | | Plano | 0.375 | | | | |
| 24 | Image | Plano | — | | | | |

Note:
Reference wavelength is 587.6 nm (d-line).
An effective radius of the stop S1 (Surface 7) is 2.333 mm.
An effective radius of the stop S2 (Surface 15) is 1.042 mm.

TABLE 8B
Aspheric Coefficients

| Surface # | 1 | 2 | 3 | 4 | 5 |
|---|---|---|---|---|---|
| k= | −9.900000E+01 | −4.777700E−01 | 1.918260E+01 | 1.659140E+00 | −9.900000E+01 |
| A4= | 1.007429E−03 | −6.016829E−03 | −6.624862E−03 | 4.568315E−03 | −1.124301E−02 |
| A6= | 1.120595E−05 | 1.192331E−03 | 5.584634E−03 | −5.041347E−05 | −6.811917E−03 |
| A8= | −9.838527E−07 | −1.253842E−04 | −1.492132E−03 | 7.460929E−04 | 3.182665E−03 |
| A10= | 1.902689E−08 | 1.601347E−05 | 2.365133E−04 | −5.156078E−04 | −1.186496E−03 |
| A12= | −1.622699E−10 | −1.072184E−06 | −2.373393E−05 | 1.633438E−04 | 3.603128E−04 |
| A14= | 5.358708E−13 | 4.146012E−08 | 1.453359E−06 | −2.848572E−05 | −7.028443E−05 |
| A16= | — | — | −4.898565E−08 | 2.855586E−06 | 7.561604E−06 |
| A18= | — | — | 6.867364E−10 | −1.279356E−07 | −3.526543E−07 |
| A20= | — | — | — | — | 1.930712E−09 |
| Surface # | 6 | 8 | 9 | 10 | 11 |
| k= | 2.211400E+01 | 5.249240E−01 | −1.598790E+00 | −1.851050E+00 | 1.464430E+01 |
| A4= | −4.191146E−03 | 8.967940E−03 | 6.696491E−03 | 9.564872E−03 | −1.810300E−03 |
| A6= | −9.676108E−03 | −6.925700E−03 | −3.948197E−03 | −3.610943E−03 | 2.735811E−03 |
| A8= | 1.019387E−02 | 8.607957E−03 | 1.547140E−03 | 9.499845E−04 | −8.795575E−04 |
| A10= | −5.514247E−03 | −5.209435E−03 | −5.152443E−04 | −1.151323E−04 | 3.633244E−04 |
| A12= | 1.821808E−03 | 1.781908E−03 | 1.294123E−04 | 1.904234E−05 | −9.884523E−05 |
| A14= | −3.801785E−04 | −3.747697E−04 | −2.245218E−05 | −3.508702E−06 | 9.822814E−06 |
| A16= | 4.942343E−05 | 4.889187E−05 | 2.465008E−06 | — | — |
| A18= | −3.683279E−06 | −3.687897E−06 | −1.535710E−07 | — | — |
| A20= | 1.208645E−07 | 1.240157E−07 | 4.153969E−09 | — | — |
| Surface # | 13 | 14 | 16 | 17 | 18 |
| k= | −3.769390E+01 | 1.919870E+00 | −5.852600E+00 | −7.341240E−01 | 2.567940E+00 |
| A4= | −1.025631E−02 | −4.367264E−02 | −4.415994E−04 | −3.481932E−02 | −9.320317E−02 |
| A6= | 2.419036E−02 | 4.884681E−02 | 1.774181E−02 | 1.208589E−01 | 1.543149E−01 |
| A8= | −1.624465E−02 | −6.125303E−02 | −2.393386E−02 | −3.342442E−01 | −3.291821E−01 |
| A10= | −9.080706E−03 | 5.602999E−02 | 2.273913E−02 | 4.094941E−01 | 3.496281E−01 |
| A12= | 2.368341E−02 | −4.161553E−02 | −2.017678E−02 | −2.976301E−01 | −2.295671E−01 |
| A14= | −1.503981E−02 | 2.476134E−02 | 1.342321E−02 | 1.391840E−01 | 1.134943E−01 |
| A16= | 2.906796E−03 | −9.579007E−03 | −5.458633E−03 | −4.306231E−02 | −4.558159E−02 |
| A18= | — | 1.598118E−03 | 8.727488E−04 | 8.393137E−03 | 1.240736E−02 |
| A20= | — | — | — | −8.028748E−04 | −1.519635E−03 |

| Surface # | 19 | 20 | 21 | — | — |
|---|---|---|---|---|---|
| k= | −9.900000E+01 | −9.900000E+01 | 9.900000E+01 | — | — |
| A4= | −6.148945E−02 | −3.196023E−03 | 5.859320E−02 | — | — |
| A6= | 6.356665E−02 | −6.841548E−02 | −1.196023E−01 | — | — |
| A8= | −6.103755E−02 | 9.113228E−02 | 9.826947E−02 | — | — |
| A10= | 4.012648E−02 | −5.893371E−02 | −4.732084E−02 | — | — |
| A12= | −1.536835E−02 | 2.309729E−02 | 1.480597E−02 | — | — |
| A14= | 3.580217E−03 | −5.865018E−03 | −3.135884E−03 | — | — |
| A16= | −5.747187E−04 | 9.790485E−04 | 4.506330E−04 | — | — |
| A18= | 7.300449E−05 | −1.045223E−04 | −4.232642E−05 | — | — |
| A20= | −5.577928E−06 | 6.509022E−06 | 2.348868E−06 | — | — |
| A22= | — | −1.806392E−07 | −5.840261E−08 | — | — |

In the 8th embodiment, the equation of the aspheric surface profiles of the aforementioned lens elements is the same as the equation of the 1st embodiment. Also, the definitions of these parameters shown in Table 8C below are the same as those stated in the 1st embodiment with corresponding values for the 8th embodiment, so an explanation in this regard will not be provided again.

Moreover, these parameters can be calculated from Table 8A and Table 8B as the following values and satisfy the following conditions:

TABLE 8C
Values of Conditional Expressions

| | | | |
|---|---|---|---|
| f [mm] | 1.67 | (T12 + T23)/ΣAT | 0.71 |
| Fno | 1.95 | T23/(CT1 + CT2) | 0.93 |
| HFOV [deg.] | 90.0 | 10 × T34/CT3 | 0.67 |
| FOV [deg.] | 180.0 | (T34 + T45 + T78)/T23 | 0.22 |
| TL/f | 10.07 | T56/T12 | 0.18 |
| TL/ImgH | 5.50 | N4 | 1.544 |
| ImgH/BL | 2.98 | V3 + V6 + V8 | 62.1 |
| SD/BL | 3.83 | V1/N1 | 23.88 |
| \|f/f3\| | 0.09 | V2/N2 | 36.27 |
| \|f8/f4\| | 0.49 | V3/N3 | 10.83 |
| (\|f/f3\| + \|f/f9\|)/\|f/f7\| | 0.20 | V4/N4 | 36.27 |
| (\|f/f4\| + \|f/f9\|)/\|f/f8\| | 0.58 | V5/N5 | 36.27 |
| \|f/R8\| + \|f/R12\| | 1.05 | V6/N6 | 14.34 |
| (R3 + R4)/(R3 − R4) | 0.80 | V7/N7 | 36.27 |
| (R5 + R8)/(R5 − R8) | 0.91 | V8/N8 | 12.29 |
| \|R8/R7\| | 0.55 | V9/N9 | 9.61 |
| \|R12/R11\| | 0.11 | Sag3R1/CT2 | −0.86 |
| CT4/CT5 | 1.63 | ImgH/Y9R2 | 1.19 |
| CT6/CT5 | 0.21 | — | — |

### 9th Embodiment

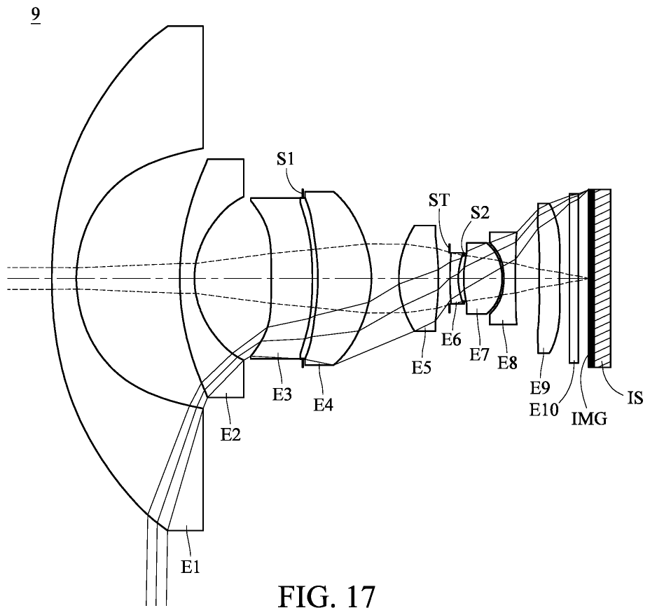

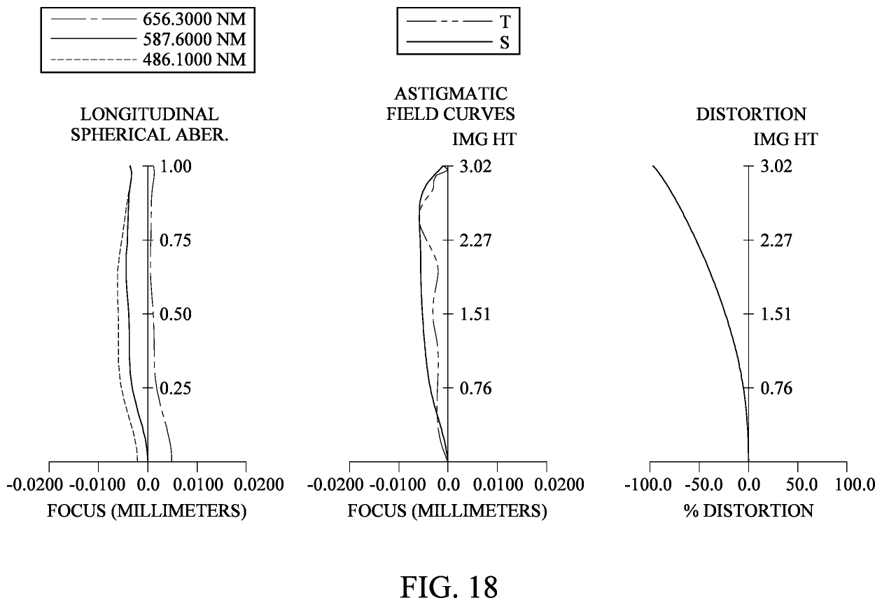

FIG. 17 is a schematic view of an image capturing unit 9 according to the 9th embodiment of the present disclosure. FIG. 18 shows, in order from left to right, spherical aberration curves, astigmatic field curves and a distortion curve of the image capturing unit according to the 9th embodiment. In FIG. 17, the image capturing unit 9 includes the optical imaging lens assembly (its reference numeral is omitted) of the present disclosure and an image sensor IS. The optical imaging lens assembly includes, in order from an object side to an image side along an optical axis, a first lens element E1, a second lens element E2, a third lens element E3, a stop S1, a fourth lens element E4, a fifth lens element E5, an aperture stop ST, a sixth lens element E6, a stop S2, a seventh lens element E7, an eighth lens element E8, a ninth lens element E9, a filter E10 and an image surface IMG. The optical imaging lens assembly includes nine lens elements (E1, E2, E3, E4, E5, E6, E7, E8 and E9) with no additional lens element disposed between each of the adjacent nine lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of glass material and has the object-side surface and the image-side surface being both aspheric. The object-side surface of the second lens element E2 has one inflection point.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has one inflection point. The image-side surface of the third lens element E3 has one inflection point. The object-side surface of the third lens element E3 has one critical point in an off-axis region thereof. The image-side surface of the third lens element E3 has one critical point in an off-axis region thereof.

The fourth lens element E4 with positive refractive power has an object-side surface being concave in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point.

The fifth lens element E5 with positive refractive power has an object-side surface being convex in a paraxial region thereof and an image-side surface being convex in a paraxial region thereof. The fifth lens element E5 is made of glass material and has the object-side surface and the image-side surface being both aspheric.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The object-side surface of the seventh lens element E7 has one inflection point.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The object-side surface of the eighth lens element E8 has one inflection point. The image-side surface of the eighth lens element E8 has two inflection points.

The ninth lens element E9 with negative refractive power has an object-side surface being convex in a paraxial region thereof and an image-side surface being concave in a paraxial region thereof. The ninth lens element E9 is made of plastic material and has the object-side surface and the image-side surface being both aspheric. The object-side surface of the ninth lens element E9 has three inflection points. The image-side surface of the ninth lens element E9 has one inflection point. The object-side surface of the ninth lens element E9 has two critical points in an off-axis region thereof. The image-side surface of the ninth lens element E9 has one critical point in an off-axis region thereof.

The filter E10 is made of glass material and located between the ninth lens element E9 and the image surface IMG, and will not affect the focal length of the optical imaging lens assembly. The image sensor IS is disposed on or near the image surface IMG of the optical imaging lens assembly.

The detailed optical data of the 9th embodiment are shown in Table 9A and the aspheric surface data are shown in Table 9B below.

TABLE 9A
9th Embodiment
f = 1.65 mm, Fno = 2.23, HFOV = 89.0 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 14.5554 | (ASP) | 0.836 | Glass | 1.804 | 46.6 | −8.82 |
| 2 | | 4.6469 | (ASP) | 3.508 | | | | |
| 3 | Lens 2 | 8.7631 | (ASP) | 0.500 | Glass | 1.755 | 52.3 | −6.03 |
| 4 | | 2.9210 | (ASP) | 2.606 | | | | |
| 5 | Lens 3 | 233.7867 | (ASP) | 1.397 | Plastic | 1.639 | 23.5 | 22.16 |
| 6 | | −15.0264 | (ASP) | −0.327 | | | | |
| 7 | Stop | Plano | | 0.518 | | | | |
| 8 | Lens 4 | −6.6030 | (ASP) | 1.812 | Plastic | 1.544 | 56.0 | 11.25 |
| 9 | | −3.4836 | (ASP) | 0.933 | | | | |
| 10 | Lens 5 | 3.1990 | (ASP) | 1.342 | Glass | 1.589 | 61.2 | 4.27 |
| 11 | | −9.9905 | (ASP) | 0.376 | | | | |
| 12 | Ape. Stop | Plano | | 0.022 | | | | |
| 13 | Lens 6 | 9.6267 | (ASP) | 0.282 | Plastic | 1.614 | 25.6 | −4.78 |
| 14 | | 2.2238 | (ASP) | 0.183 | | | | |
| 15 | Stop | Plano | | 0.000 | | | | |
| 16 | Lens 7 | 3.7231 | (ASP) | 1.304 | Plastic | 1.544 | 56.0 | 2.44 |
| 17 | | −1.8132 | (ASP) | 0.058 | | | | |
| 18 | Lens 8 | −2.3343 | (ASP) | 0.387 | Plastic | 1.639 | 23.5 | −2.94 |
| 19 | | 10.2512 | (ASP) | 0.816 | | | | |
| 20 | Lens 9 | 25.3413 | (ASP) | 0.686 | Plastic | 1.566 | 37.4 | −204.22 |
| 21 | | 20.5815 | (ASP) | 0.340 | | | | |

| | | | | | | | |
|---|---|---|---|---|---|---|---|
| 22 | Filter | Plano | 0.300 | Glass | 1.517 | 64.2 | — |
| 23 | | Plano | 0.354 | | | | |
| 24 | Image | Plano | — | | | | |

Note:
Reference wavelength is 587.6 nm (d-line).
An effective radius of the stop S1 (Surface 7) is 2.735 mm.
An effective radius of the stop S2 (Surface 15) is 0.782 mm.

TABLE 9B
Aspheric Coefficients

| Surface # | 1 | 2 | 3 | 4 | 5 |
|---|---|---|---|---|---|
| k= | 1.311280E+00 | −3.230300E−02 | −7.844930E−02 | −1.365560E−01 | 9.900000E+01 |
| A4= | 1.351318E−04 | 1.033786E−04 | −3.739092E−04 | −2.579705E−03 | −1.822655E−02 |
| A6= | 1.043474E−05 | 9.303546E−05 | 4.316267E−04 | 6.793662E−04 | 7.152495E−04 |
| A8= | −5.000067E−07 | −8.162452E−06 | −1.095782E−04 | −1.857428E−04 | −3.127351E−04 |
| A10= | 9.328048E−09 | 1.208329E−06 | 1.170825E−05 | 6.635334E−07 | −1.029010E−04 |
| A12= | −8.916057E−11 | −6.959688E−08 | −5.713205E−07 | 2.184430E−06 | 1.020813E−04 |
| A14= | 3.649543E−13 | 1.937392E−09 | 1.036522E−08 | −6.389958E−08 | −2.746701E−05 |
| A16= | — | — | — | — | 3.690847E−06 |
| A18= | — | — | — | — | −2.542483E−07 |
| A20= | — | — | — | — | 7.113801E−09 |
| Surface # | 6 | 8 | 9 | 10 | 11 |
| k= | 2.496060E+01 | 4.233650E−01 | −1.635570E+00 | −1.673870E+00 | 1.661470E+01 |
| A4= | −1.428435E−02 | 2.766962E−03 | 5.162564E−03 | 8.719091E−03 | 3.972423E−03 |
| A6= | 8.006984E−03 | 6.424849E−03 | −1.881084E−03 | −2.044308E−03 | −4.144705E−04 |
| A8= | −4.619621E−03 | −4.499737E−03 | 3.319302E−04 | 3.430407E−04 | −3.165939E−05 |
| A10= | 1.837463E−03 | 1.833761E−03 | −3.384746E−05 | 5.617453E−06 | 6.206168E−05 |
| A12= | −4.620509E−04 | −4.770489E−04 | −4.066641E−06 | −1.751768E−05 | −5.291413E−06 |
| A14= | 7.327096E−05 | 7.723544E−05 | 1.797273E−06 | 2.998214E−06 | 4.466436E−07 |
| A16= | −7.119135E−06 | −7.569787E−06 | −2.465714E−07 | — | — |
| A18= | 3.885931E−07 | 4.131213E−07 | 1.617939E−08 | — | — |
| A20= | −9.036118E−09 | −9.597939E−09 | −4.294117E−10 | — | — |
| Surface # | 13 | 14 | 16 | 17 | 18 |
| k= | 3.459460E+01 | 1.225780E+00 | −7.285760E+00 | −4.668410E−01 | 1.796680E−01 |
| A4= | −2.384344E−02 | −5.223646E−02 | 5.186456E−03 | 5.397909E−03 | −5.530971E−02 |
| A6= | 3.516565E−02 | 9.958050E−02 | −1.799531E−04 | −6.173435E−02 | −2.714883E−02 |
| A8= | −4.474797E−02 | −3.355242E−01 | 5.344984E−02 | 4.868730E−02 | 8.783655E−02 |
| A10= | 4.111415E−02 | 1.008857E+00 | −2.398558E−01 | −1.837160E−01 | −3.782283E−01 |
| A12= | −3.174633E−02 | −2.039765E+00 | 5.296581E−01 | 5.225828E−01 | 9.033038E−01 |
| A14= | 1.706927E−02 | 2.472032E+00 | −6.825421E−01 | −7.580048E−01 | −1.168709E+00 |
| A16= | −4.236215E−03 | −1.614873E+00 | 4.654445E−01 | 5.960335E−01 | 8.541345E−01 |
| A18= | — | 4.363230E−01 | −1.297881E−01 | −2.472486E−01 | −3.360770E−01 |
| A20= | — | — | — | 4.264880E−02 | 5.577145E−02 |

| Surface # | 19 | 20 | 21 | — | — |
|---|---|---|---|---|---|
| k= | 2.933580E+01 | 9.680330E+01 | 5.997700E+01 | — | — |
| A4= | −6.189021E−02 | −1.946228E−02 | −5.297567E−03 | — | — |
| A6= | 4.629824E−02 | −6.735368E−03 | −2.261193E−02 | — | — |
| A8= | −3.765649E−02 | 1.485946E−02 | 2.176261E−02 | — | — |
| A10= | 2.969824E−02 | −1.184553E−02 | −1.235321E−02 | — | — |
| A12= | −1.428972E−02 | 5.572507E−03 | 4.596799E−03 | — | — |
| A14= | 2.900463E−03 | −1.630112E−03 | −1.161562E−03 | — | — |
| A16= | 4.140635E−04 | 3.020746E−04 | 1.995562E−04 | — | — |
| A18= | −3.159388E−04 | −3.482942E−05 | −2.243500E−05 | — | — |
| A20= | 4.441884E−05 | 2.302009E−06 | 1.491032E−06 | — | — |
| A22= | — | −6.739450E−08 | −4.444460E−08 | — | — |

In the 9th embodiment, the equation of the aspheric surface profiles of the aforementioned lens elements is the same as the equation of the 1st embodiment. Also, the definitions of these parameters shown in Table 9C below are the same as those stated in the 1st embodiment with corresponding values for the 9th embodiment, so an explanation in this regard will not be provided again.

Moreover, these parameters can be calculated from Table 9A and Table 9B as the following values and satisfy the following conditions:

TABLE 9C
Values of Conditional Expressions

| | | | |
|---|---|---|---|
| f [mm] | 1.65 | (T12 + T23)/ΣAT | 0.70 |
| Fno | 2.23 | T23/(CT1 + CT2) | 1.95 |
| HFOV [deg.] | 89.0 | 10 × T34/CT3 | 1.37 |
| FOV [deg.] | 178.0 | (T34 + T45 + T78)/T23 | 0.45 |
| TL/f | 11.07 | T56/T12 | 0.11 |
| TL/ImgH | 6.04 | N4 | 1.544 |
| ImgH/BL | 3.04 | V3 + V6 + V8 | 72.6 |
| SD/BL | 3.76 | V1/N1 | 25.83 |
| \|f/f3\| | 0.07 | V2/N2 | 29.80 |
| \|f8/f4\| | 0.26 | V3/N3 | 14.34 |
| (\|f/f3\| + \|f/f9\|)/\|f/f7\| | 0.12 | V4/N4 | 36.27 |
| (\|f/f4\| + \|f/f9\|)/\|f/f8\| | 0.28 | V5/N5 | 38.51 |
| \|f/R8\| + \|f/R12\| | 1.21 | V6/N6 | 15.86 |
| (R3 + R4)/(R3 − R4) | 2.00 | V7/N7 | 36.27 |
| (R5 + R8)/(R5 − R8) | 0.97 | V8/N8 | 14.34 |
| \|R8/R7\| | 0.53 | V9/N9 | 23.88 |
| \|R12/R11\| | 0.23 | Sag3R1/CT2 | −1.39 |
| CT4/CT5 | 1.35 | ImgH/Y9R2 | 1.19 |
| CT6/CT5 | 0.21 | — | — |

### 10th Embodiment

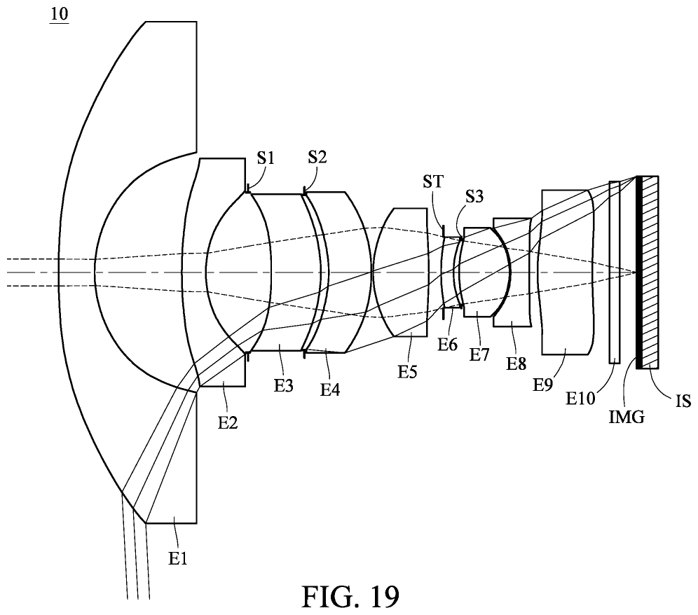

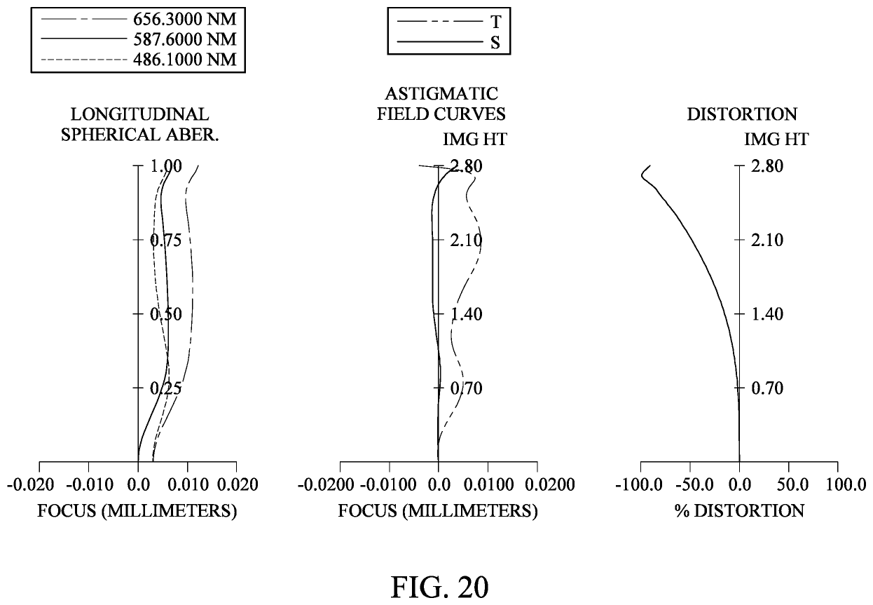

FIG. 19 is a schematic view of an image capturing unit 10 according to the 10th embodiment of the present disclosure. FIG. 20 shows, in order from left to right, spherical aberration curves, astigmatic field curves and a distortion curve of the image capturing unit according to the 10th embodiment. In FIG. 19, the image capturing unit 10 includes the optical imaging lens assembly (its reference numeral is omitted) of the present disclosure and an image sensor IS. The optical imaging lens assembly includes, in order from an object side to an image side along an optical axis, a first lens element E1, a second lens element E2, a stop S1, a third lens element E3, a stop S2, a fourth lens element E4, a fifth lens element E5, an aperture stop ST, a sixth lens element E6, a stop S3, a seventh lens element E7, an eighth lens element E8, a ninth lens element E9, a filter E10 and an image surface IMG. The optical imaging lens assembly includes nine lens elements (E1, E2, E3, E4, E5, E6, E7, E8 and E9) with no additional lens element disposed between each of the adjacent nine lens elements.

The first lens element E1 with negative refractive power has an object-side surface being convex in a paraxial region thereof and an image-side surface being concave in a paraxial region thereof. The first lens element E1 is made of glass material and has the object-side surface and the image-side surface being both aspheric.

The second lens element E2 with negative refractive power has an object-side surface being convex in a paraxial region thereof and an image-side surface being concave in a paraxial region thereof. The second lens element E2 is made of glass material and has the object-side surface and the image-side surface being both aspheric. The object-side surface of the second lens element E2 has one inflection point. The image-side surface of the second lens element E2 has one inflection point.

The third lens element E3 with positive refractive power has an object-side surface being concave in a paraxial region thereof and an image-side surface being convex in a paraxial region thereof. The third lens element E3 is made of plastic material and has the object-side surface and the image-side surface being both aspheric. The image-side surface of the third lens element E3 has one inflection point.

The fourth lens element E4 with negative refractive power has an object-side surface being concave in a paraxial region thereof and an image-side surface being convex in a paraxial region thereof. The fourth lens element E4 is made of plastic material and has the object-side surface and the image-side surface being both aspheric.

The fifth lens element E5 with positive refractive power has an object-side surface being convex in a paraxial region thereof and an image-side surface being convex in a paraxial region thereof. The fifth lens element E5 is made of glass material and has the object-side surface and the image-side surface being both aspheric.

The sixth lens element E6 with negative refractive power has an object-side surface being convex in a paraxial region thereof and an image-side surface being concave in a paraxial region thereof. The sixth lens element E6 is made of plastic material and has the object-side surface and the image-side surface being both aspheric.

The seventh lens element E7 with positive refractive power has an object-side surface being convex in a paraxial region thereof and an image-side surface being convex in a paraxial region thereof. The seventh lens element E7 is made of plastic material and has the object-side surface and the image-side surface being both aspheric. The object-side surface of the seventh lens element E7 has one inflection point.

The eighth lens element E8 with negative refractive power has an object-side surface being concave in a paraxial region thereof and an image-side surface being concave in a paraxial region thereof. The eighth lens element E8 is made of plastic material and has the object-side surface and the image-side surface being both aspheric. The object-side surface of the eighth lens element E8 has one inflection point. The image-side surface of the eighth lens element E8 has two inflection points.

The ninth lens element E9 with positive refractive power has an object-side surface being convex in a paraxial region thereof and an image-side surface being concave in a paraxial region thereof. The ninth lens element E9 is made of plastic material and has the object-side surface and the image-side surface being both aspheric. The object-side surface of the ninth lens element E9 has one inflection point. The image-side surface of the ninth lens element E9 has one inflection point. The object-side surface of the ninth lens element E9 has one critical point in an off-axis region thereof. The image-side surface of the ninth lens element E9 has one critical point in an off-axis region thereof.

The filter E10 is made of glass material and located between the ninth lens element E9 and the image surface IMG, and will not affect the focal length of the optical imaging lens assembly. The image sensor IS is disposed on or near the image surface IMG of the optical imaging lens assembly.

The detailed optical data of the 10th embodiment are shown in Table 10A and the aspheric surface data are shown in Table 10B below.

TABLE 10A
10th Embodiment
f = 1.58 mm, Fno = 2.02, HFOV = 93.0 deg.

| Surface # | | Curvature Radius | | Thickness | Material | Index | Abbe # | Focal Length |
|---|---|---|---|---|---|---|---|---|
| 0 | Object | Infinity | | Infinity | | | | |
| 1 | Lens 1 | 21.7778 | (ASP) | 1.050 | Glass | 1.767 | 49.2 | −5.86 |
| 2 | | 3.6482 | (ASP) | 2.543 | | | | |
| 3 | Lens 2 | 10.4942 | (ASP) | 0.700 | Glass | 1.729 | 54.7 | −6.47 |
| 4 | | 3.1627 | (ASP) | 1.230 | | | | |
| 5 | Stop | Plano | | 0.680 | | | | |
| 6 | Lens 3 | −8.7595 | (ASP) | 1.443 | Plastic | 1.614 | 25.6 | 11.74 |
| 7 | | −4.2008 | (ASP) | −0.480 | | | | |
| 8 | Stop | Plano | | 0.711 | | | | |
| 9 | Lens 4 | −3.4652 | (ASP) | 1.244 | Plastic | 1.544 | 56.0 | −58.57 |
| 10 | | −4.3798 | (ASP) | 0.050 | | | | |
| 11 | Lens 5 | 2.9903 | (ASP) | 1.623 | Glass | 1.589 | 61.2 | 4.18 |
| 12 | | −11.0732 | (ASP) | 0.431 | | | | |
| 13 | Ape. Stop | Plano | | −0.068 | | | | |
| 14 | Lens 6 | 6.0938 | (ASP) | 0.360 | Plastic | 1.639 | 23.5 | −6.39 |
| 15 | | 2.3876 | (ASP) | 0.233 | | | | |
| 16 | Stop | Plano | | −0.070 | | | | |
| 17 | Lens 7 | 3.2649 | (ASP) | 1.469 | Plastic | 1.544 | 56.0 | 2.46 |
| 18 | | −1.9075 | (ASP) | 0.035 | | | | |
| 19 | Lens 8 | −1.9178 | (ASP) | 0.544 | Plastic | 1.639 | 23.5 | −2.67 |
| 20 | | 17.2063 | (ASP) | 0.240 | | | | |
| 21 | Lens 9 | 4.6818 | (ASP) | 1.598 | Plastic | 1.544 | 56.0 | 10.88 |
| 22 | | 19.6793 | (ASP) | 0.500 | | | | |

| | | | | | | | |
|---|---|---|---|---|---|---|---|
| 23 | Filter | Plano | 0.300 | Glass | 1.517 | 64.2 | — |
| 24 | | Plano | 0.486 | | | | |
| 25 | Image | Plano | — | | | | |

Note:
Reference wavelength is 587.6 nm (d-line).
An effective radius of the stop S1 (Surface 5) is 2.333 mm.
An effective radius of the stop S2 (Surface 8) is 2.259 mm.
An effective radius of the stop S3 (Surface 16) is 0.946 mm.

TABLE 10B
Aspheric Coefficients

| Surface # | 1 | 2 | 3 | 4 | 6 |
|---|---|---|---|---|---|
| k= | 2.188650E+00 | −7.970930E−02 | −2.598570E−01 | −7.033130E−02 | 0.000000E+00 |
| A4= | 1.544019E−03 | −2.477963E−03 | −6.224935E−03 | 2.853652E−03 | −6.834607E−03 |
| A6= | −4.494196E−05 | 5.981553E−04 | 2.469971E−03 | 1.700879E−03 | −3.066385E−03 |
| A8= | 5.012319E−07 | −8.340440E−05 | −3.951875E−04 | −6.492069E−04 | −7.681270E−06 |
| A10= | 1.506116E−09 | 1.199633E−05 | 4.191658E−05 | 1.974045E−04 | 7.721959E−04 |
| A12= | −8.113144E−11 | −9.623844E−07 | −2.973307E−06 | −3.252836E−05 | −5.345039E−04 |
| A14= | 6.109012E−13 | 3.953687E−08 | 9.023807E−08 | 1.468785E−06 | 2.261955E−04 |
| A16= | — | — | — | — | −6.103887E−05 |
| A18= | — | — | — | — | 9.973180E−06 |
| A20= | — | — | — | — | −8.911227E−07 |
| A22= | — | — | — | — | 3.320575E−08 |
| Surface # | 7 | 9 | 10 | 11 | 12 |
| k= | −2.898430E+00 | −6.302000E−01 | −2.414180E−02 | −2.099430E+00 | 5.915400E+00 |
| A4= | 3.075444E−03 | 1.932256E−02 | −4.021129E−03 | 4.078382E−03 | 3.355841E−02 |
| A6= | −1.324795E−04 | −3.119123E−04 | −4.415653E−03 | −5.001251E−03 | −3.210603E−02 |
| A8= | −2.824589E−03 | −7.371330E−03 | 3.300629E−03 | 3.841011E−03 | 1.914986E−02 |
| A10= | 1.960867E−03 | 5.613044E−03 | −9.768957E−04 | −1.055317E−03 | −6.184990E−03 |
| A12= | −6.552265E−04 | −2.304604E−03 | 1.170734E−04 | 1.663660E−04 | 9.757300E−04 |
| A14= | 1.351458E−04 | 6.190974E−04 | 1.400517E−05 | −1.367067E−05 | −6.068849E−05 |
| A16= | −2.014612E−05 | −1.159219E−04 | −7.869677E−06 | — | — |
| A18= | 2.295856E−06 | 1.472195E−05 | 1.322573E−06 | — | — |
| A20= | −1.696240E−07 | −1.122337E−06 | −1.064629E−07 | — | — |
| A22= | 5.571909E−09 | 3.809529E−08 | 3.446940E−09 | — | — |
| Surface # | 14 | 15 | 17 | 18 | 19 |
| k= | 8.189800E+00 | 2.097860E+00 | −1.297640E+01 | −9.237700E−01 | 0.000000E+00 |
| A4= | 2.663030E−02 | −3.144117E−02 | 2.087747E−02 | 6.506316E−02 | 6.894465E−02 |
| A6= | −4.210398E−02 | −1.300372E−02 | 1.112199E−02 | −2.229352E−01 | −2.004519E−01 |
| A8= | 3.019050E−02 | 4.972572E−02 | −7.457777E−02 | 2.789360E−01 | 2.601329E−01 |
| A10= | −3.533741E−03 | −1.445005E−01 | 1.997902E−01 | −3.551513E−01 | −2.900561E−01 |
| A12= | −7.764198E−03 | 3.068272E−01 | −3.156508E−01 | 4.271666E−01 | 3.019565E−01 |
| A14= | 3.379250E−03 | −3.787983E−01 | 3.000765E−01 | −3.492118E−01 | −2.094207E−01 |
| A16= | −2.754027E−04 | 2.390076E−01 | −1.613300E−01 | 1.676036E−01 | 7.893825E−02 |
| A18= | — | −6.122683E−02 | 3.623482E−02 | −4.317186E−02 | −1.345878E−02 |
| A20= | — | — | — | 4.678821E−03 | 6.477716E−04 |

| Surface # | 20 | 21 | 22 | — | — |
|---|---|---|---|---|---|
| k= | 7.318630E+01 | 0.000000E+00 | 0.000000E+00 | — | — |
| A4= | −2.628097E−02 | −3.459029E−02 | 1.395075E−02 | — | — |
| A6= | −1.927923E−02 | −5.489946E−03 | −1.789056E−02 | — | — |
| A8= | 6.378783E−02 | 1.964413E−02 | 9.419805E−03 | — | — |
| A10= | −7.640317E−02 | −1.809673E−02 | −3.474108E−03 | — | — |
| A12= | 5.930296E−02 | 1.017921E−02 | 9.271644E−04 | — | — |
| A14= | −2.998260E−02 | −3.677742E−03 | −1.779071E−04 | — | — |
| A16= | 9.479963E−03 | 8.217653E−04 | 2.261805E−05 | — | — |
| A18= | −1.712458E−03 | −1.021247E−04 | −1.665599E−06 | — | — |
| A20= | 1.355187E−04 | 5.227666E−06 | 5.254019E−08 | — | — |

In the 10th embodiment, the equation of the aspheric surface profiles of the aforementioned lens elements is the same as the equation of the 1st embodiment. Also, the definitions of these parameters shown in Table 10C below are the same as those stated in the 1st embodiment with corresponding values for the 10th embodiment, so an explanation in this regard will not be provided again.

Moreover, these parameters can be calculated from Table 10A and Table 10B as the following values and satisfy the following conditions:

TABLE 10C
Values of Conditional Expressions

| | | | |
|---|---|---|---|
| f [mm] | 1.58 | (T12 + T23)/ΣAT | 0.80 |
| Fno | 2.02 | T23/(CT1 + CT2) | 1.09 |
| HFOV [deg.] | 93.0 | 10 × T34/CT3 | 1.60 |
| FOV [deg.] | 186.0 | (T34 + T45 + T78)/T23 | 0.17 |
| TL/f | 10.67 | T56/T12 | 0.14 |
| TL/ImgH | 6.02 | N4 | 1.544 |
| ImgH/BL | 2.18 | V3 + V6 + V8 | 72.6 |
| SD/BL | 3.38 | V1/N1 | 27.84 |
| \|f/f3\| | 0.13 | V2/N2 | 31.64 |
| \|f8/f4\| | 0.05 | V3/N3 | 15.86 |
| (\|f/f3\| + \|f/f9\|)/\|f/f7\| | 0.44 | V4/N4 | 36.27 |
| (\|f/f4\| + \|f/f9\|)/\|f/f8\| | 0.29 | V5/N5 | 38.51 |
| \|f/R8\| + \|f/R12\| | 1.02 | V6/N6 | 14.34 |
| (R3 + R4)/(R3 − R4) | 1.86 | V7/N7 | 36.27 |
| (R5 + R8)/(R5 − R8) | 3.00 | V8/N8 | 14.34 |
| \|R8/R7\| | 1.26 | V9/N9 | 36.27 |
| \|R12/R11\| | 0.39 | Sag3R1/CT2 | −0.84 |
| CT4/CT5 | 0.77 | ImgH/Y9R2 | 1.17 |
| CT6/CT5 | 0.22 | — | — |

### 11th Embodiment

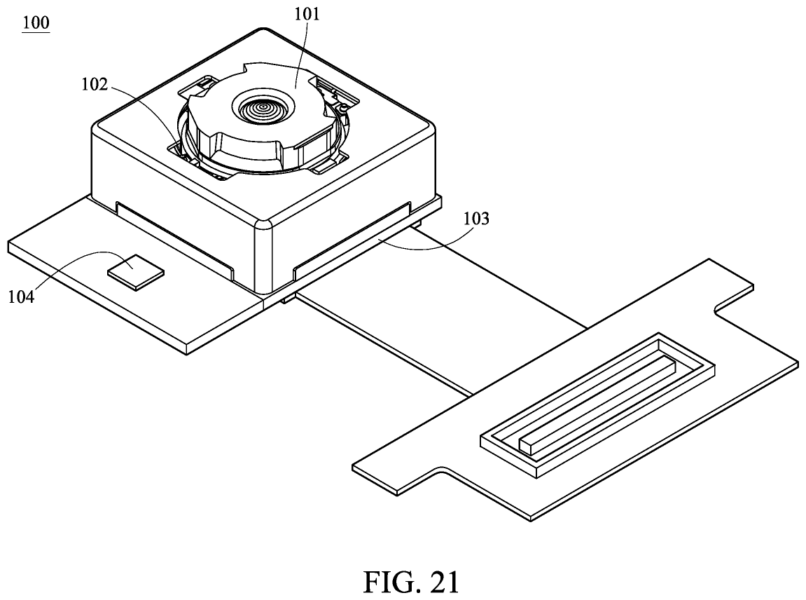

FIG. 21 is a perspective view of an image capturing unit according to the 11th embodiment of the present disclosure. In this embodiment, an image capturing unit 100 is a camera module including a lens unit 101, a driving device 102, an image sensor 103 and an image stabilizer 104. The lens unit 101 includes the optical imaging lens assembly as disclosed in the 1st embodiment, a barrel and a holder member (their reference numerals are omitted) for holding the optical imaging lens assembly. However, the lens unit 101 may alternatively be provided with the optical imaging lens assembly as disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have auto focusing functionality, and different driving configurations can be obtained through the usages of voice coil motors (VCM), micro electro-mechanical systems (MEMS), piezoelectric systems or shape memory alloy materials. The driving device 102 is favorable for obtaining a better imaging position of the lens unit 101, so that a clear image of the imaged object can be captured by the lens unit 101 with different object distances. The image sensor 103 (for example, CMOS or CCD), which can feature high photosensitivity and low noise, is disposed on the image surface of the optical imaging lens assembly to provide higher image quality.

The image stabilizer 104, such as an accelerometer, a gyro sensor and a Hall Effect sensor, is configured to work with the driving device 102 to provide optical image stabilization (OIS). The driving device 102 working with the image stabilizer 104 is favorable for compensating for pan and tilt of the lens unit 101 to reduce blurring associated with motion during exposure. In some cases, the compensation can be provided by electronic image stabilization (EIS) with image processing software, thereby improving image quality while in motion or low-light conditions.

### 12th Embodiment

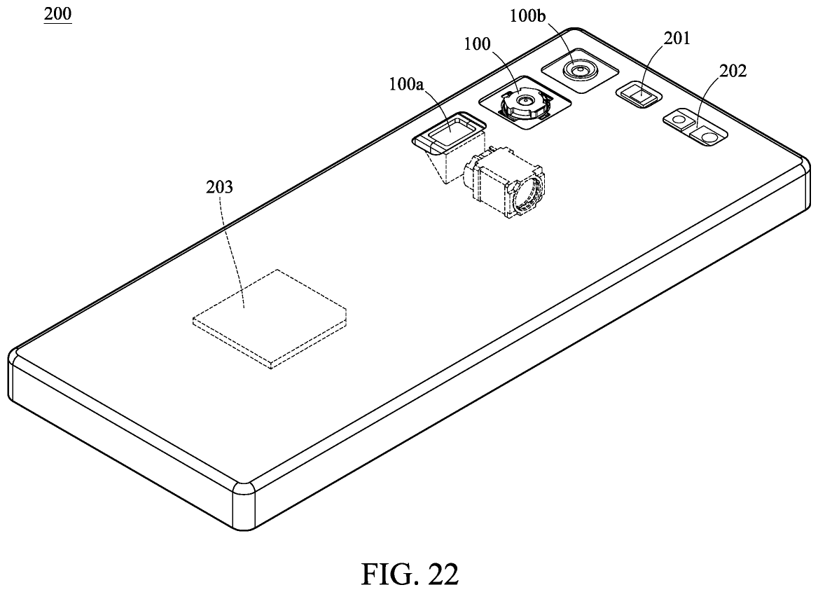

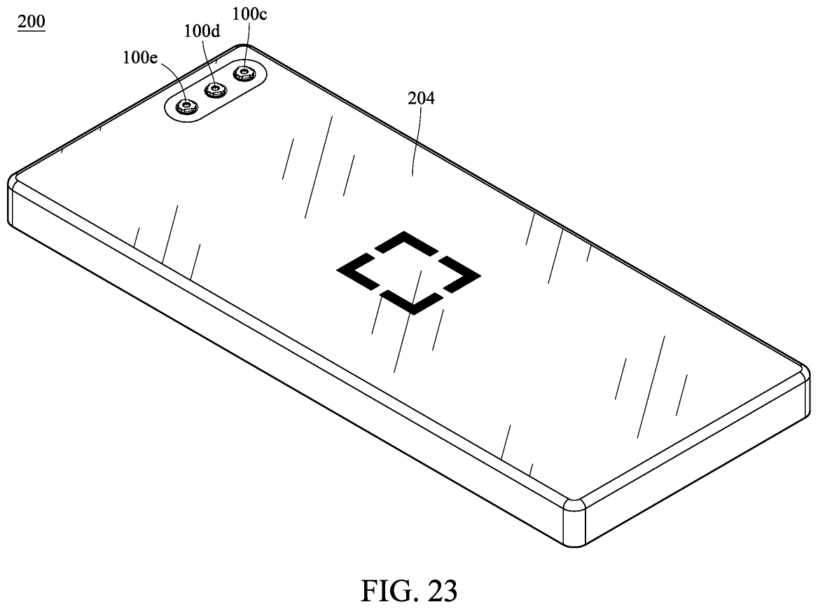

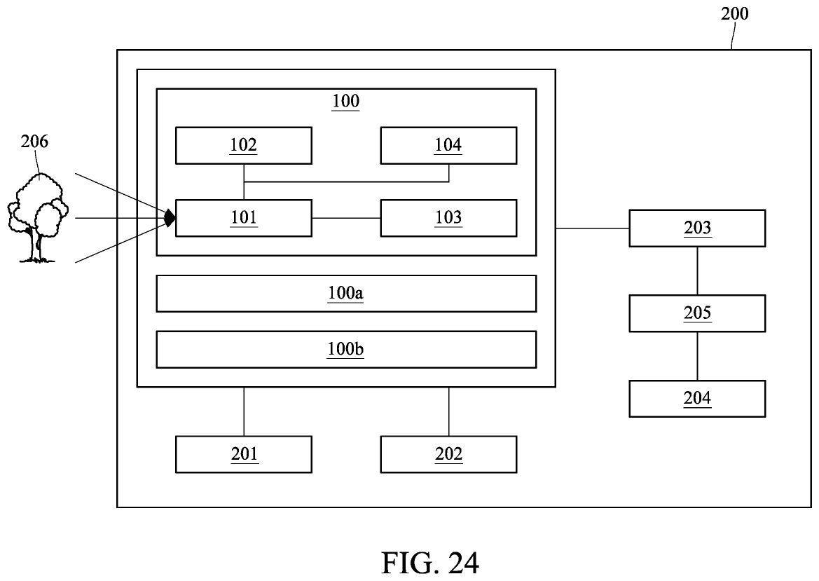

FIG. 22 is one perspective view of an electronic device according to the 12th embodiment of the present disclosure. FIG. 23 is another perspective view of the electronic device in FIG. 22. FIG. 24 is a block diagram of the electronic device in FIG. 22.

In this embodiment, an electronic device 200 is a smartphone including the image capturing unit 100 as disclosed in the 11th embodiment, an image capturing unit 100a, an image capturing unit 100b, an image capturing unit 100c, an image capturing unit 100d, an image capturing unit 100e, a flash module 201, a focus assist module 202, an image signal processor 203, a display module 204 and an image software processor 205. The image capturing unit 100, the image capturing unit 100a and the image capturing unit 100b are disposed on the same side of the electronic device 200 and each of the image capturing units 100, 100a and 100b has a single focal point. The focus assist module 202 can be a laser rangefinder or a ToF (time of flight) module, but the present disclosure is not limited thereto. The image capturing unit 100c, the image capturing unit 100d, the image capturing unit 100e and the display module 204 are disposed on the opposite side of the electronic device 200, and the display module 204 can be a user interface, such that the image capturing units 100c, 100d and 100e can be front-facing cameras of the electronic device 200 for taking selfies, but the present disclosure is not limited thereto. Furthermore, each of the image capturing units 100a, 100b, 100c, 100d and 100e can include the optical imaging lens assembly of the present disclosure and can have a configuration similar to that of the image capturing unit 100. In detail, each of the image capturing units 100a, 100b, 100c, 100d and 100e can include a lens unit, a driving device, an image sensor and an image stabilizer, and can also include a light-folding element for folding optical path. In addition, each lens unit of the image capturing units 100a, 100b, 100c, 100d and 100e can include the optical imaging lens assembly of the present disclosure, a barrel and a holder member for holding the optical imaging lens assembly.

The image capturing unit 100 is a wide-angle image capturing unit, the image capturing unit 100a is a telephoto image capturing unit with optical path folding function, the image capturing unit 100b is an ultra-wide-angle image capturing unit, the image capturing unit 100c is a wide-angle image capturing unit, the image capturing unit 100d is an ultra-wide-angle image capturing unit, and the image capturing unit 100e is a ToF image capturing unit. In this embodiment, the image capturing units 100, 100a and 100b have different fields of view, such that the electronic device 200 can have various magnification ratios so as to meet the requirement of optical zoom functionality. In addition, the image capturing unit 100e can determine depth information of the imaged object. Moreover, the light-folding configuration of the image capturing unit 100 can be similar to, for example, one of the configurations as shown in FIG. 35 to FIG. 37, which can be referred to foregoing descriptions corresponding to FIG. 35 to FIG. 37, and the details in this regard will not be provided again. In this embodiment, the electronic device 200 includes multiple image capturing units 100, 100a, 100b, 100c, 100d and 100e, but the present disclosure is not limited to the number and arrangement of image capturing units.

When a user captures images of an object 206, the light rays converge in the image capturing unit 100, the image capturing unit 100a or the image capturing unit 100b to generate images, and the flash module 201 is activated for light supplement. The focus assist module 202 detects the object distance of the imaged object 206 to achieve fast auto focusing. The image signal processor 203 is configured to optimize the captured image to improve image quality. The light beam emitted from the focus assist module 202 can be either conventional infrared or laser. In addition, the light rays may converge in the image capturing unit 100c, 100d or 100e to generate images. The display module 204 can include a touch screen, and the user is able to interact with the display module 204 and the image software processor 205 having multiple functions to capture images and complete image processing. Alternatively, the user may capture images via a physical button. The image processed by the image software processor 205 can be displayed on the display module 204.

### 13th Embodiment

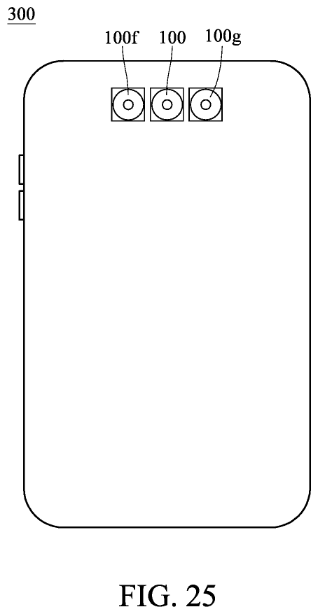

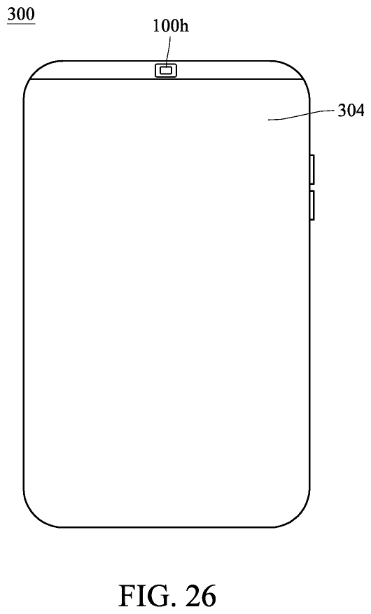

FIG. 25 is one perspective view of an electronic device according to the 13th embodiment of the present disclosure. FIG. 26 is another perspective view of the electronic device in FIG. 25.

In this embodiment, an electronic device 300 is a smartphone including the image capturing unit 100 as disclosed in the 11th embodiment, an image capturing unit 100f, an image capturing unit 100g, an image capturing unit 100h and a display module 304. As shown in FIG. 25, the image capturing unit 100, the image capturing unit 100f and the image capturing unit 100g are disposed on the same side of the electronic device 300 and each of the image capturing units 100, 100f and 100g has a single focal point. As shown in FIG. 26, the image capturing unit 100h and the display module 304 are disposed on the opposite side of the electronic device 300, such that the image capturing unit 100h can be a front-facing camera of the electronic device 300 for taking selfies, but the present disclosure is not limited thereto. Furthermore, each of the image capturing units 100f, 100g and 100h can include the optical imaging lens assembly of the present disclosure and can have a configuration similar to that of the image capturing unit 100. In detail, each of the image capturing units 100f, 100g and 100h can include a lens unit, a driving device, an image sensor and an image stabilizer. In addition, each lens unit of the image capturing units 100f, 100g and 100h can include the optical imaging lens assembly of the present disclosure, a barrel and a holder member for holding the optical imaging lens assembly.

The image capturing unit 100 is a wide-angle image capturing unit, the image capturing unit 100f is a telephoto image capturing unit, the image capturing unit 100g is an ultra-wide-angle image capturing unit, and the image capturing unit 100h is a wide-angle image capturing unit. In this embodiment, the image capturing units 100, 100f and 100g have different fields of view, such that the electronic device 300 can have various magnification ratios so as to meet the requirement of optical zoom functionality. In this embodiment, the electronic device 300 includes multiple image capturing units 100, 100f, 100g and 100h, but the present disclosure is not limited to the number and arrangement of image capturing units.

### 14th Embodiment

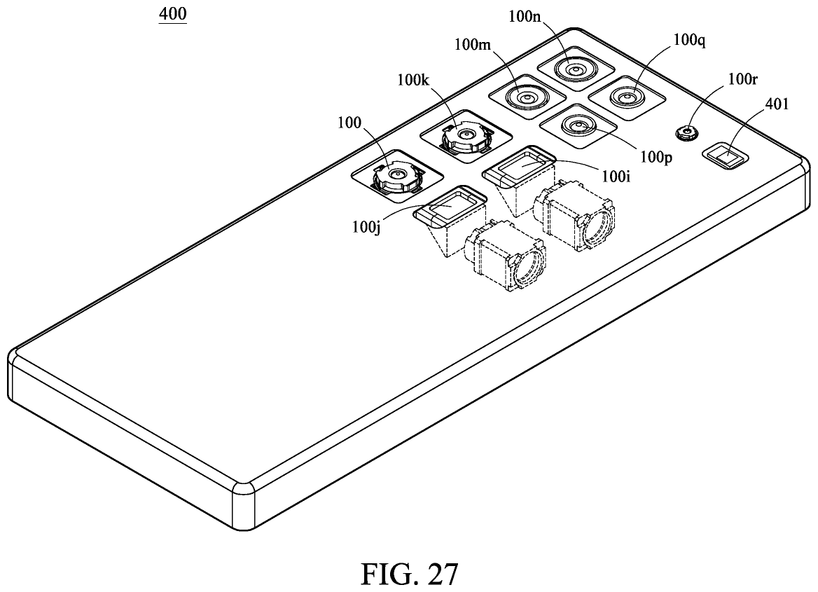

FIG. 27 is one perspective view of an electronic device according to the 14th embodiment of the present disclosure.

In this embodiment, an electronic device 400 is a smartphone including the image capturing unit 100 as disclosed in the 11th embodiment, an image capturing unit 100i, an image capturing unit 100j, an image capturing unit 100k, an image capturing unit 100m, an image capturing unit 100n, an image capturing unit 100p, an image capturing unit 100q, an image capturing unit 100r, a flash module 401, a focus assist module, an image signal processor, a display module and an image software processor (not shown). The image capturing units 100, 100i, 100j, 100k, 100m, 100n, 100p, 100q and 100r are disposed on the same side of the electronic device 400, while the display module is disposed on the opposite side of the electronic device 400. Furthermore, each of the image capturing units 100i, 100j, 100k, 100m, 100n, 100p, 100q and 100r can include the optical imaging lens assembly of the present disclosure and can have a configuration similar to that of the image capturing unit 100, and the details in this regard will not be provided again.

The image capturing unit 100 is a wide-angle image capturing unit, the image capturing unit 100i is a telephoto image capturing unit with optical path folding function, the image capturing unit 100j is a telephoto image capturing unit with optical path folding function, the image capturing unit 100k is a wide-angle image capturing unit, the image capturing unit 100m is an ultra-wide-angle image capturing unit, the image capturing unit 100n is an ultra-wide-angle telephoto image capturing unit, the image capturing unit 100p is a telephoto image capturing unit, the image capturing unit 100q is a telephoto image capturing unit, and the image capturing unit 100r is a ToF image capturing unit. In this embodiment, the image capturing units 100, 100i, 100j, 100k, 100m, 100n, 100p and 100q have different fields of view, such that the electronic device 400 can have various magnification ratios so as to meet the requirement of optical zoom functionality. In addition, the image capturing unit 100r can determine depth information of the imaged object. Moreover, the light-folding configuration of the image capturing units 100i and 100j can be similar to, for example, one of the structures shown in FIG. 35 to FIG. 37, which can be referred to foregoing descriptions corresponding to FIG. 35 to FIG. 37, and the details in this regard will not be provided again. In this embodiment, the electronic device 400 includes multiple image capturing units 100, 100i, 100j, 100k, 100m, 100n, 100p, 100q and 100r, but the present disclosure is not limited to the number and arrangement of image capturing units. When a user captures images of an object, the light rays converge in the image capturing unit 100, 100i, 100j, 100k, 100m, 100n, 100p, 100q or 100r to generate images, and the flash module 401 is activated for light supplement. Further, the subsequent processes are performed in a manner similar to the abovementioned embodiments, and the details in this regard will not be provided again.

### 15th Embodiment

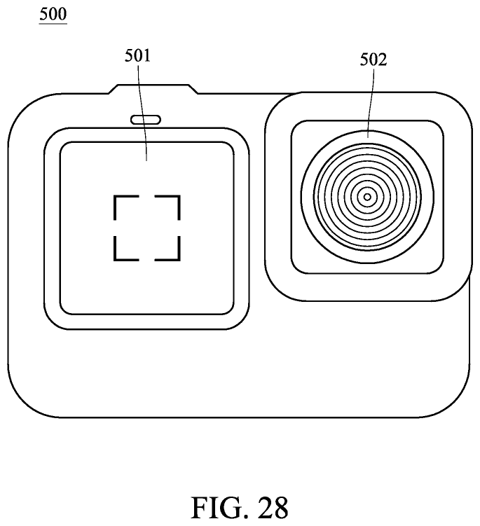

FIG. 28 is a schematic view of an electronic device according to the 15th embodiment of the present disclosure.

In this embodiment, an electronic device 500 may be a small-size camera, such as an action camera. The electronic device 500 includes a display unit 501 and an image capturing unit 502. The image capturing unit 502 is electrically connected to the display unit 501. The image capturing unit 502 includes the optical imaging lens assembly as disclosed in the 1st embodiment. The image capturing unit 502 can be a wide-angle image capturing unit. The image capturing unit 502, which is similar to the image capturing unit 100 as disclosed in the 11th embodiment, can further include a barrel, a holder member or a combination thereof. The electronic device 500 captures an image by the image capturing unit 502. Preferably, the electronic device 500 may further include a control unit, a display unit, a storage unit, a random access memory unit (RAM) or a combination thereof.

### 16th Embodiment

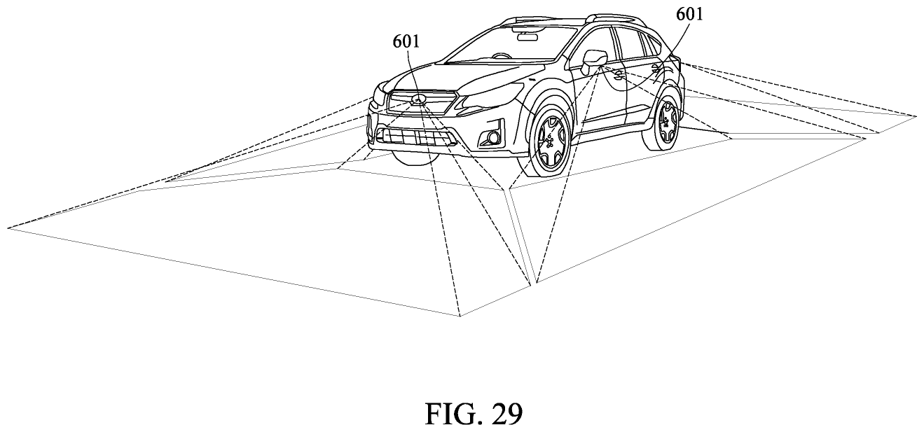

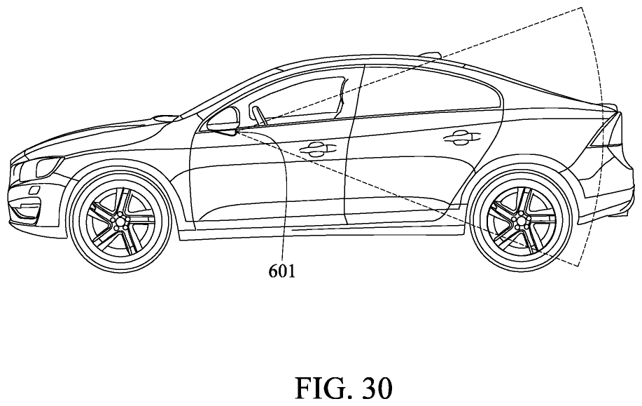

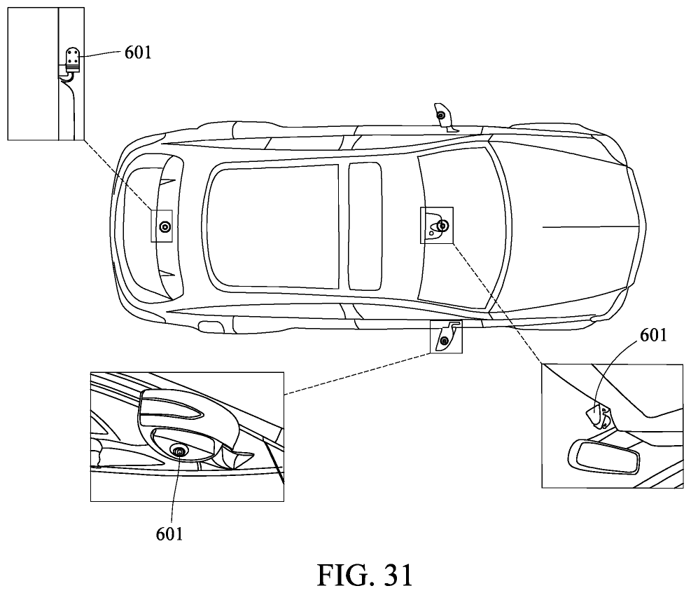

FIG. 29 is a perspective view of an electronic device according to the 16th embodiment of the present disclosure. FIG. 30 is a side view of the electronic device in FIG. 29. FIG. 31 is a top view of the electronic device in FIG. 29.

In this embodiment, the electronic device 600 is an automobile, such as a car. The electronic device 600 includes a plurality of image capturing units 601, and the image capturing units 601, for example, each includes the optical imaging lens assembly of the present disclosure. The image capturing units 601 can serve as, for example, panoramic view car cameras, dashboard cameras and vehicle backup cameras. Each of the image capturing units 601 can be a wide-angle image capturing unit.

As shown in FIG. 29 to FIG. 31, the image capturing units 601 are, for example, respectively disposed on the front, rear, side, side mirrors and interior of the automobile to capture images at the periphery of the automobile for recognizing road conditions outside the automobile, thereby achieving automated driver assistance. Moreover, the image software processor may blend the images into one panoramic view image for the driver's checking every corner surrounding the automobile, thereby favorable for parking and driving.

As shown in FIG. 30, the image capturing units 601 are, for example, respectively disposed on the lower portion of the left and right side mirrors to capture images in regions on left and right lanes. As shown in FIG. 31, the image capturing units 601 are, for example, respectively disposed inside the side mirrors and the front and rear windshields for providing external information to the driver, and also providing more viewing angles so as to reduce blind spots, thereby improving driving safety. The arrangement of the aforementioned image capturing units is only exemplary, and the number, positions or imaging direction of the image capturing units can be adjusted according to actual requirements.

### 17th Embodiment

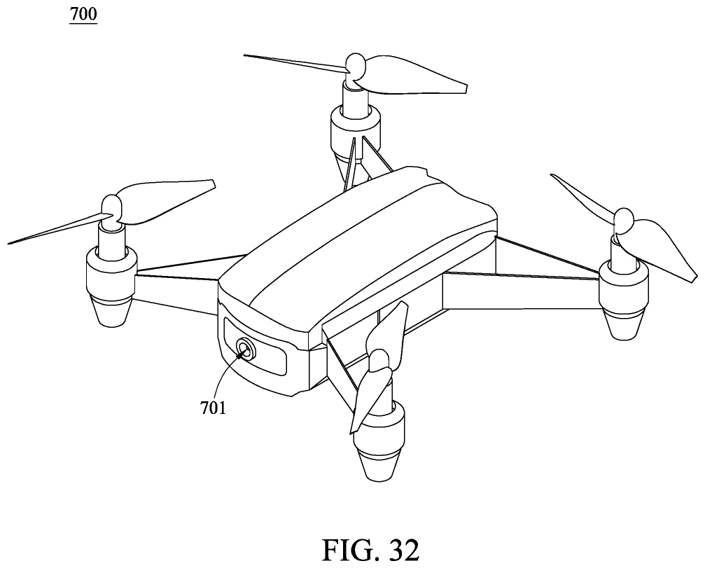

FIG. 32 is a schematic view of an electronic device according to the 17th embodiment of the present disclosure.

In this embodiment, an electronic device 700 may be a lightweight unmanned aerial vehicle, such as a drone. The electronic device 700 includes an image capturing unit 701. The image capturing unit 701 includes the optical imaging lens assembly as disclosed in the 1st embodiment. The image capturing unit 701 can be a wide-angle image capturing unit. The image capturing unit 701, which is similar to the image capturing unit 100 as disclosed in the 11th embodiment, can further include a barrel, a holder member or a combination thereof. The electronic device 700 captures an image by the image capturing unit 701. Preferably, the electronic device 700 may further include a control unit, a display unit, a storage unit, a random access memory unit (RAM) or a combination thereof. In this embodiment, the electronic device 700 includes a single image capturing unit 701, but the present disclosure is not limited to the number or arrangement of image capturing unit(s).

The smartphone, the camera, the mobile vehicle and the unmanned aerial vehicle in the embodiments are only exemplary for showing the image capturing unit of the present disclosure installed in an electronic device, and the present disclosure is not limited thereto. The image capturing unit can be optionally applied to optical systems with a movable focus. Furthermore, the optical imaging lens assembly of the image capturing unit features good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multi-camera devices, image recognition systems, motion sensing input devices, wearable devices, portable video recorders and other electronic imaging devices.

The foregoing description, for the purpose of explanation, has been described with reference to specific embodiments. It is to be noted that TABLES 1A-10C show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An optical imaging lens assembly comprising nine lens elements, the nine lens elements being, in order from an object side to an image side along an optical path, a first lens element, a second lens element, a third lens element, a fourth lens element, a fifth lens element, a sixth lens element, a seventh lens element, an eighth lens element and a ninth lens element, and each of the nine lens elements having an object-side surface facing toward the object side and an image-side surface facing toward the image side;
wherein the first lens element has negative refractive power, the second lens element has negative refractive power, the object-side surface of the second lens element is convex in a paraxial region thereof, the image-side surface of the second lens element is concave in a paraxial region thereof, the image-side surface of the fourth lens element is convex in a paraxial region thereof, the fifth lens element has positive refractive power, the image-side surface of the sixth lens element is concave in a paraxial region thereof, the eighth lens element has negative refractive power, and the object-side surface of the eighth lens element is concave in a paraxial region thereof;
wherein a curvature radius of the object-side surface of the second lens element is R3, a curvature radius of the image-side surface of the second lens element is R4, a curvature radius of the object-side surface of the third lens element is R5, a curvature radius of the image-side surface of the fourth lens element is R8, and the following conditions are satisfied:
$$0 < ( R 5 + R 8 ) / ( R 5 - R 8 ) < 10. ;$$
$$and$$
$$1. < ( R 3 + R 4 ) / ( R 3 - R 4 ) < 10.00 .$$

2. The optical imaging lens assembly of claim 1, wherein the curvature radius of the object-side surface of the third lens element is R5, the curvature radius of the image-side surface of the fourth lens element is R8, and the following condition is satisfied:
$$0.3 < ( R 5 + R 8 ) / ( R 5 - R 8 ) < 8.00 .$$

3. The optical imaging lens assembly of claim 1, wherein a focal length of the optical imaging lens assembly is f, a focal length of the third lens element is f3, a focal length of the seventh lens element is f7, a focal length of the ninth lens element is f9, a central thickness of the fourth lens element is CT4, a central thickness of the fifth lens element is CT5, and the following conditions are satisfied:
$$( \vert f / f 3 \vert + \vert f / f 9 \vert ) / \vert f / f 7 \vert < 0.8 ;$$
$$and$$
$$0.4 < CT 4 / CT 5 < 2.50 .$$

4. The optical imaging lens assembly of claim 1, wherein a focal length of the optical imaging lens assembly is f, a focal length of the third lens element is f3, and the following condition is satisfied:

|f/f3|<0.45.

5. The optical imaging lens assembly of claim 1, wherein an axial distance between the object-side surface of the first lens element and an image surface is TL, a maximum image height of the optical imaging lens assembly is ImgH, a maximum field of view of the optical imaging lens assembly is FOV, and the following conditions are satisfied:
$$3. < TL / ImgH < 8. ;$$
$$and$$
$$150. degrees < FOV < 230. degrees .$$

6. The optical imaging lens assembly of claim 1, wherein at least one surface of at least one lens element in the optical imaging lens assembly has at least one inflection point,
a curvature radius of the object-side surface of the sixth lens element is R11, a curvature radius of the image-side surface of the sixth lens element is R12, and the following condition is satisfied:
$$\vert R 12 / R 11 \vert < 1. .$$

7. The optical imaging lens assembly of claim 1, wherein an axial distance between the third lens element and the fourth lens element is T34, a central thickness of the third lens element is CT3, and the following condition is satisfied:
$$0.01 < 10 \times T 34 / CT 3 < 5.00 .$$

8. The optical imaging lens assembly of claim 1, wherein the object-side surface of the seventh lens element is convex in a paraxial region thereof,
an axial distance between the first lens element and the second lens element is T12, an axial distance between the second lens element and the third lens element is T23, a sum of axial distances between each of all adjacent lens elements of the optical imaging lens assembly is EAT, and the following condition is satisfied:
$$0.6 < ( T 12 + T 23 ) / \sum AT < 1. .$$

9. The optical imaging lens assembly of claim 1, further comprising an aperture stop, wherein an axial distance between the aperture stop and the image-side surface of the ninth lens element is SD, an axial distance between the image-side surface of the ninth lens element and an image surface is BL, and the following condition is satisfied:
$$2. < SD / BL < 5.20 .$$

10. The optical imaging lens assembly of claim 1, wherein a displacement in parallel with an optical axis from an axial vertex of the object-side surface of the third lens element to a maximum effective radius position of the object-side surface of the third lens element is Sag3R1, a central thickness of the second lens element is CT2, and the following condition is satisfied:
$$- 2.00 < Sag 3 R 1 / CT 2 < - 0.30 .$$

11. The optical imaging lens assembly of claim 1, wherein a maximum image height of the optical imaging lens assembly is ImgH, a maximum effective radius of the image-side surface of the ninth lens element is Y9R2, and the following condition is satisfied:
$$1.05 < ImgH / Y 9 R 2 < 1.5 .$$

12. An image capturing unit, comprising:
the optical imaging lens assembly of claim 1; and
an image sensor disposed on an image surface of the optical imaging lens assembly.

13. An electronic device, comprising:
the image capturing unit of claim 12.

14. An optical imaging lens assembly comprising nine lens elements, the nine lens elements being, in order from an object side to an image side along an optical path, a first lens element, a second lens element, a third lens element, a fourth lens element, a fifth lens element, a sixth lens element, a seventh lens element, an eighth lens element and a ninth lens element, and each of the nine lens elements having an object-side surface facing toward the object side and an image-side surface facing toward the image side;
wherein the first lens element has negative refractive power, the second lens element has negative refractive power, the image-side surface of the second lens element is concave in a paraxial region thereof, the image-side surface of the fourth lens element is convex in a paraxial region thereof, the object-side surface of the fifth lens element is convex in a paraxial region thereof, the image-side surface of the sixth lens element is concave in a paraxial region thereof, the eighth lens element has negative refractive power, and the object-side surface of the eighth lens element is concave in a paraxial region thereof;
wherein an axial distance between the object-side surface of the first lens element and an image surface is TL, a focal length of the optical imaging lens assembly is f, a central thickness of the fifth lens element is CT5, a central thickness of the sixth lens element is CT6, an axial distance between the second lens element and the third lens element is T23, an axial distance between the third lens element and the fourth lens element is T34, an axial distance between the fourth lens element and the fifth lens element is T45, an axial distance between the seventh lens element and the eighth lens element is T78, and the following conditions are satisfied:
$$6.5 < TL / f < 15. ;$$
$$0 < CT 6 / CT 5 < 0 \text{.45} ;$$
$$and$$
$$0 < ( T 34 + T 45 + T 78 ) / T 23 < 2.00 .$$

15. The optical imaging lens assembly of claim 14, wherein the axial distance between the object-side surface of the first lens element and the image surface is TL, the focal length of the optical imaging lens assembly is f, and the following condition is satisfied:
$$7. < TL / f < 14.00 .$$

16. The optical imaging lens assembly of claim 14, wherein the image-side surface of the eighth lens element has at least one inflection point,
the axial distance between the second lens element and the third lens element is T23, the axial distance between the third lens element and the fourth lens element is T34, the axial distance between the fourth lens element and the fifth lens element is T45, the axial distance between the seventh lens element and the eighth lens element is T78, and the following condition is satisfied:
$$0 < ( T 34 + T 45 + T 78 ) / T 23 < 1. .$$

17. The optical imaging lens assembly of claim 14, wherein the sixth lens element has negative refractive power,
the focal length of the optical imaging lens assembly is f, a focal length of the fourth lens element is f4, a focal length of the eighth lens element is f8, a focal length of the ninth lens element is f9, and the following condition is satisfied:
$$( \vert f / f 4 \vert + \vert f / f 9 \vert ) / \vert f / f 8 \vert < 1. .$$

18. The optical imaging lens assembly of claim 14, wherein the object-side surface of the seventh lens element is convex in a paraxial region thereof,
a focal length of the fourth lens element is f4, a focal length of the eighth lens element is f8, and the following condition is satisfied:
$$0 < \vert f 8 / f 4 \vert < 0.7 .$$

19. The optical imaging lens assembly of claim 14, wherein the object-side surface of the fourth lens element is concave in a paraxial region thereof,
a curvature radius of the object-side surface of the fourth lens element is R7, a curvature radius of the image-side surface of the fourth lens element is R8, and the following condition is satisfied:
$$0 < \vert R 8 / R 7 \vert < 2. .$$

20. The optical imaging lens assembly of claim 14, wherein a maximum image height of the optical imaging lens assembly is ImgH, an axial distance between the image-side surface of the ninth lens element and the image surface is BL, and the following condition is satisfied:
$$2. < Img H / BL < 5.00 .$$

21. The optical imaging lens assembly of claim 14, further comprising an aperture stop disposed between the fifth lens element and the sixth lens element,
wherein an axial distance between the first lens element and the second lens element is T12, an axial distance between the fifth lens element and the sixth lens element is T56, and the following condition is satisfied:
$$0 < T 56 / T 12 < 0.50 .$$

22. An optical imaging lens assembly comprising nine lens elements, the nine lens elements being, in order from an object side to an image side along an optical path, a first lens element, a second lens element, a third lens element, a fourth lens element, a fifth lens element, a sixth lens element, a seventh lens element, an eighth lens element and a ninth lens element, and each of the nine lens elements having an object-side surface facing toward the object side and an image-side surface facing toward the image side;
wherein the first lens element has negative refractive power, the second lens element has negative refractive power, the image-side surface of the second lens element is concave in a paraxial region thereof, the image-side surface of the fourth lens element is convex in a paraxial region thereof, the fifth lens element has positive refractive power, the image-side surface of the sixth lens element is concave in a paraxial region thereof, the eighth lens element has negative refractive power, and the object-side surface of the eighth lens element is concave in a paraxial region thereof;
wherein a curvature radius of the object-side surface of the third lens element is R5, a curvature radius of the image-side surface of the fourth lens element is R8, an axial distance between the second lens element and the third lens element is T23, a central thickness of the first lens element is CT1, a central thickness of the second lens element is CT2, and the following conditions are satisfied:
$$0 < ( R 5 + R 8 ) / ( R 5 - R 8 ) < 1 0. ; and$$
$$0.6 < T 23 / ( CT 1 + C T 2 ) < 3.00 .$$

23. The optical imaging lens assembly of claim 22, wherein the axial distance between the second lens element and the third lens element is T23, the central thickness of the first lens element is CT1, the central thickness of the second lens element is CT2, a refractive index of the fourth lens element is N4, and the following conditions are satisfied:
$$0.7 < T 23 / ( CT 1 + C T 2 ) < 2.5 ; and$$
$$1.4 < N 4 < 1.62 0 .$$

24. The optical imaging lens assembly of claim 22, wherein the image-side surface of the third lens element is convex in a paraxial region thereof, and at least one of the object-side surface and the image-side surface of the third lens element has at least one inflection point.

25. The optical imaging lens assembly of claim 22, wherein an Abbe number of the third lens element is V3, an Abbe number of the sixth lens element is V6, an Abbe number of the eighth lens element is V8, and the following condition is satisfied:
$$30. < V 3 + V 6 + V 8 < 85.0 .$$

26. The optical imaging lens assembly of claim 22, wherein a focal length of the optical imaging lens assembly is f, the curvature radius of the image-side surface of the fourth lens element is R8, a curvature radius of the image-side surface of the sixth lens element is R12, and the following condition is satisfied:
$$0.4 < \vert f / R 8 \vert + \vert f / R 12 \vert < 1.8 .$$

27. The optical imaging lens assembly of claim 22, wherein at least four lens elements of the optical imaging lens assembly are made of plastic material, an Abbe number of the first lens element is V1, an Abbe number of the second lens element is V2, an Abbe number of the third lens element is V3, an Abbe number of the fourth lens element is V4, an Abbe number of the fifth lens element is V5, an Abbe number of the sixth lens element is V6, an Abbe number of the seventh lens element is V7, an Abbe number of the eighth lens element is V8, an Abbe number of the ninth lens element is V9, an Abbe number of the i-th lens element is Vi, a refractive index of the first lens element is N1, a refractive index of the second lens element is N2, a refractive index of the third lens element is N3, a refractive index of the fourth lens element is N4, a refractive index of the fifth lens element is N5, a refractive index of the sixth lens element is N6, a refractive index of the seventh lens element is N7, a refractive index of the eighth lens element is N8, a refractive index of the ninth lens element is N9, a refractive index of the i-th lens element is Ni, and at least two lens elements of the optical imaging lens assembly satisfy the following condition:
$$8. < Vi / Ni < 16.0 ,$$
wherein i=1, 2, 3, 4, 5, 6, 7, 8 or 9.

28. The optical imaging lens assembly of claim 22, wherein a curvature radius of the object-side surface of the second lens element is R3, a curvature radius of the image-side surface of the second lens element is R4, the curvature radius of the object-side surface of the third lens element is R5, the curvature radius of the image-side surface of the fourth lens element is R8, an axial distance between the object-side surface of the first lens element and an image surface is TL, a focal length of the optical imaging lens assembly is f, the central thickness of the first lens element is CT1, the central thickness of the second lens element is CT2, a central thickness of the fifth lens element is CT5, a central thickness of the sixth lens element is CT6, the axial distance between the second lens element and the third lens element is T23, an axial distance between the third lens element and the fourth lens element is T34, an axial distance between the fourth lens element and the fifth lens element is T45, an axial distance between the seventh lens element and the eighth lens element is T78, and the following conditions are satisfied:
$$0.82 \leq ( R 5 + R 8 ) / ( R 5 - R 8 ) \leq 3. ;$$
$$0.8 \leq ( R 3 + R 4 ) / ( R 3 - R 4 ) \leq 2 \text{.00} ;$$
$$8.84 \leq TL / f \leq 12 \text{.24} ;$$
$$0.14 \leq CT 6 / CT 5 \leq 0 \text{.28} ;$$
$$0.05 \leq ( T 34 + T 45 + T 78 ) / T 23 \leq 0.45 ; and$$
$$0.92 \leq T 23 / ( CT 1 + C T 2 ) \leq 1.95 .$$
